(19) United States
(12) Patent Application Publication
(10) Pub. No.: US 2025/0293324 A1
(43) Pub. Date: Sep. 18, 2025

(54) POWER STORAGE SYSTEM

(71) Applicant: Semiconductor Energy Laboratory Co., Ltd., Atsugi-shi, Kanagawa-ken (JP)

(72) Inventors: Takeshi OSADA, Isehara (JP); Mayumi MIKAMI, Atsugi (JP)

(21) Appl. No.: 18/873,782

(22) PCT Filed: Jun. 30, 2023
(86) PCT No.: PCT/IB2023/056820

§ 371 Date: Dec. 11, 2024

(30) Foreign Application Priority Data
Jul. 8, 2022 (JP) 2022-110561

(51) Int. Cl. H01M 10/42; H01M 4/36; H01M 4/525; H01M 4/62

(52) U.S. Cl. CPC H01M 10/425; H01M 4/366; H01M 4/525; H01M 4/628

(57) ABSTRACT

A novel power storage system is provided. The power storage system includes a secondary battery and a subtractor. The subtractor includes a register. The subtractor has a function of converting a first voltage of the secondary battery into first voltage data by analog-digital conversion. The subtractor has a function of measuring time required for the first voltage to change only by a first voltage value. The register has a function of storing second voltage data that is higher than the first voltage data by a data value corresponding to the first voltage value. The subtractor has a function of stopping supply of power to the register until the first voltage changes by the first voltage value.

### TECHNICAL FIELD

One embodiment of the present invention relates to a power storage system, an operation method of the power storage system, a secondary battery, and an operation method of the secondary battery. One embodiment of the present invention relates to a charging method of a secondary battery. One embodiment of the present invention relates to a semiconductor device and an operation method of the semiconductor device. One embodiment of the present invention relates to a battery control circuit, a battery protection circuit, a power storage device, an electronic device, and operation methods thereof.

Note that one embodiment of the present invention is not limited to the above technical field. The technical field of one embodiment of the invention disclosed in this specification and the like relates to an object, a method, a driving method, or a manufacturing method. One embodiment of the present invention relates to a process, a machine, manufacture, or a composition of matter. Thus, specific examples of the technical field of one embodiment of the present invention disclosed in this specification and the like include a semiconductor device, a display apparatus, a light-emitting apparatus, a power storage device, an optical device, an imaging device, a lighting device, an arithmetic device, a control device, a memory device, an input device, an output device, an input/output device, a signal processing device, an electronic computer, an electronic device, driving methods thereof, and manufacturing methods thereof.

### BACKGROUND ART

In recent years, for example, a variety of power storage devices (also referred to as batteries or secondary batteries) such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

Power storage devices have been utilized in a wide range of areas from small electronic devices to automobiles. As the application range of batteries expands, there are more and more applications utilizing a multi-cell battery stack where a plurality of battery cells are connected in series.

The power storage device is provided with a circuit for detecting an abnormality in charge and discharge, such as overdischarge, overcharge, overcurrent, or a short circuit. In such a circuit, data of voltage, current, and the like is obtained, and stop of charge and discharge, cell balance, and the like are controlled on the basis of the obtained data. Thus, the battery can be protected and controlled.

Patent Document 1 discloses a protection IC that functions as a battery protection circuit. Specifically, Patent Document 1 discloses a protection IC that detects abnormality in charge and discharge by comparing, using a plurality of comparators provided inside, a reference voltage and a voltage of a terminal to which a battery is connected.

Patent Document 2 discloses a battery state detector that detects a micro short circuit (also referred to as internal short circuit) in a secondary battery and a battery pack incorporating the detector.

Patent Document 3 discloses a protection semiconductor device for protecting an assembled battery in which secondary battery cells are connected in series.

A variety of circuits for detecting an abnormality in charge and discharge of a secondary battery and protecting and controlling the battery, as described above, and a variety of integrated circuits (ICs) including the circuits are also semiconductor devices formed using transistors.

A silicon-based semiconductor is widely known as a semiconductor material applicable to a transistor and an oxide semiconductor has been attracting attention as another material. It is known that a transistor using an oxide semiconductor has an extremely low off-state current in a non-conduction state. For example, Patent Document 4 and Patent Document 5 disclose a central processing unit (CPU) that can reduce power consumption, a memory device that can retain stored data for a long time, and the like by utilizing a characteristic of a low off-state current of the transistor using an oxide semiconductor.

In particular, for example, secondary batteries and the like for mobile electronic devices are highly demanded to have high discharge capacity per weight and excellent cycle performance. In order to meet such demands, positive electrode active materials in positive electrodes of secondary batteries have been actively improved. In addition, a crystal structure of a positive electrode active material has also been studied (Non-Patent Document 1 and Non-Patent Document 2).

An XRD (X-ray diffraction) pattern is one of methods used for analysis of a crystal structure of a positive electrode active material. For example, with the use of ICSD (Inorganic Crystal Structure Database) described in Non-Patent Document 3, XRD data can be analyzed. For Rietveld analysis, the analysis program RIETAN-FP (Non-Patent Document 4) can be used, for example.

As image processing software, for example, ImageJ (Non-Patent Document 5 to Non-Patent Document 7) is known. Using this software makes it possible to analyze the shape of a positive electrode active material, for example.

### REFERENCE

### Patent Document

[Patent Document 1] Specification of United States Patent Application Publication No. 2011-267726
[Patent Document 2] Japanese Published Patent Application No. 2010-66161.
[Patent Document 3] Japanese Published Patent Application No. 2010-220389.
[Patent Document 4] Japanese Published Patent Application No. 2012-257187.
[Patent Document 5] Japanese Published Patent Application No. 2011-151383.

### Non-Patent Document

[Non-Patent Document 1] Motohashi, T. et al., “Electronic phase diagram of the layered cobalt oxide system LiₓCoO₂ (0.0≤x≤1.0)”, Physical Review B, 80 (16); 165114.
[Non-Patent Document 2] Zhaohui Chen et al., “Staging Phase Transitions in LiₓCoO₂”, Journal of The Electrochemical Society, 2002, 149 (12), A1604-A1609.
[Non-Patent Document 3] Belsky, A. et al., “New developments in the Inorganic Crystal Structure Database (ICSD): accessibility in support of materials research and design”, Acta Cryst., (2002) B58, pp. 364-369.
[Non-Patent Document 4]F. Izumi and K. Momma, Solid State Phenom., 130, 15-20 (2007).
[Non-Patent Document 5] Rasband, W. S., Image J, U. S. National Institutes of Health, Bethesda, Maryland, USA, http://rsb.info.nih.gov/ij/, 1997-2012.
[Non-Patent Document 6] Schneider, C. A, Rasband, W. S., Eliceiri K. W., “NIH Image to ImageJ: 25 years of image analysis”, Nature Methods, 9, 671-675, 2012.
[Non-Patent Document 7] Abramoff, M. D., Magelhaes, P. J., Ram, S. J., “Image Processing with ImageJ”, Biophotonics International, volume 11, issue 7, pp. 36-42, 2004.

### SUMMARY OF THE INVENTION

### Problems to be Solved by the Invention

One object of one embodiment of the present invention is to provide a power storage system with a high energy density. Another object of one embodiment of the present invention is to provide a power storage system with a high degree of safety. Another object of one embodiment of the present invention is to provide a charging method of a power storage system with a high energy density. Another object of one embodiment of the present invention is to provide a charging method of a power storage system with a high degree of safety. Another object of one embodiment of the present invention is to provide a secondary battery with a high energy density. Another object of one embodiment of the present invention is to provide a secondary battery with a high degree of safety. Another object of one embodiment of the present invention is to provide a novel charging method of a secondary battery. Another object of one embodiment of the present invention is to provide a power storage system using a highly reliable positive electrode active material. Another object of one embodiment of the present invention is to provide a highly reliable positive electrode active material. Another object of one embodiment of the present invention is to provide an excellent power storage system by applying a positive electrode active material of one embodiment of the present invention to the power storage system of one embodiment of the present invention. Another object of one embodiment of the present invention is to estimate a state of a secondary battery. Another object of one embodiment of the present invention is to estimate a charge depth of a secondary battery. Another object of one embodiment of the present invention is to estimate a full chargeable capacity of a secondary battery, and a deterioration state of the secondary battery. Another object of one embodiment of the present invention is to estimate a dischargeable capacity of a secondary battery.

Another object of one embodiment of the present invention is to provide a novel charging unit, a novel charge control circuit, a novel battery control circuit, a novel battery protection circuit, a novel power storage device, a novel semiconductor device, a novel vehicle, a novel electronic device, or the like. Another object of one embodiment of the present invention is to provide a charging unit, a charge control circuit, a battery control circuit, a battery protection circuit, a power storage device, a semiconductor device, a vehicle, an electronic device, or the like with low power consumption. Another object of one embodiment of the present invention is to provide a charging unit, a charge control circuit, a battery control circuit, a battery protection circuit, a power storage device, a semiconductor device, a vehicle, an electronic device, or the like with a high degree of integration.

Note that the objects of one embodiment of the present invention are not limited to the objects listed above. The objects listed above do not preclude the existence of other objects. Note that the other objects are objects that are not described in this section and will be described below. The objects that are not described in this section are derived from the description of this specification, the drawings, and the like and can be extracted as appropriate from the description by those skilled in the art. Note that one embodiment of the present invention is to solve at least one of the objects listed above and the other objects.

### Means for Solving the Problems

A charging unit of one embodiment of the present invention can be preferably used in combination with a secondary battery using a positive electrode active material of one embodiment of the present invention, in particular. The charging unit of one embodiment of the present invention has a function of detecting a change in a charge process of a crystal structure of the positive electrode active material of one embodiment of the present invention by measuring a charge voltage and a charge current of the secondary battery and analyzing the measured charge voltage and the measured charge current.

In the secondary battery, the charge voltage in repeated charge and discharge is increased to the utmost limit, which can increase the discharge capacity. To provide a secondary battery with a long lifetime, it is preferable that a change of a crystal structure of a positive electrode active material be substantially reversible even at an increased charge voltage. In the charging method of one embodiment of the present invention, a change of the crystal structure of the positive electrode active material is substantially reversible, and thereby collapse of the crystal structure of the positive electrode active material in charge is inhibited; therefore, a high-discharge-capacity and long-life secondary battery can be provided.

In the positive electrode active material of one embodiment of the present invention, a change of the crystal structure of the positive electrode active material can be substantially reversible even at an increased charge voltage. The charging unit of one embodiment of the present invention preferably employs the positive electrode active material of one embodiment of the present invention in a secondary battery, and thereby has a function of detecting a change of a crystal structure of the positive electrode active material and controlling charge at a high charge voltage and in a range where the crystal structure is substantially reversible.

The positive electrode active material of one embodiment of the present invention changes from an O3 type crystal structure into an O3′ type crystal structure described later. In addition, the change of the crystal structure is caused in the state of the deep charge depth of the secondary battery. The charging unit of one embodiment of the present invention has a function detecting a change from the O3 type crystal structure into the O3′ type crystal structure and controlling charge.

(1) One embodiment of the present invention is a power storage system including a secondary battery and a subtractor. The subtractor includes a register. The subtractor has a function of converting a first voltage of the secondary battery into first voltage data by analog-digital conversion. The subtractor has a function of measuring time required for the first voltage to change only by a first voltage value. The register has a function of storing second voltage data that is higher than the first voltage data by a data value corresponding to the first voltage value. The subtractor has a function of stopping supply of power to the register until the first voltage changes by the first voltage value.

(2) In (1) described above, the subtractor may include a digital-analog converter circuit, the digital-analog converter circuit may have a function of outputting a second voltage on the basis of the second voltage data, and the subtractor may have a function of stopping supply of power to the digital-analog converter circuit until the first voltage changes only by the first voltage value.

(3) In (1) described above, the subtractor may include a transistor containing an oxide semiconductor in a channel formation region.

(4) In (2) described above, the subtractor may include a transistor containing an oxide semiconductor in a channel formation region.

(5) In any one of (1) to (4) described above, the secondary battery may include a positive electrode, the positive electrode may include a lithium cobalt oxide, and a crystal structure identified by X-ray diffraction may be a crystal structure represented by the space group R-3m.

(6) In (5) described above, the lithium cobalt oxide may contain magnesium in a surface portion.

### Effect of the Invention

According to one embodiment of the present invention, a power storage system with a high energy density can be provided. According to another embodiment of the present invention, a power storage system with a high degree of safety can be provided. According to another embodiment of the present invention, a secondary battery with a high energy density can be provided. According to another embodiment of the present invention, a secondary battery with a high degree of safety can be provided. According to another embodiment of the present invention, a novel charging method of a secondary battery can be provided. According to another embodiment of the present invention, a power storage system using a highly reliable positive electrode active material can be provided. According to another embodiment of the present invention, a highly reliable positive electrode active material can be provided. According to another embodiment of the present invention, an excellent power storage system by applying a positive electrode active material of one embodiment of the present invention to the power storage system of one embodiment of the present invention can be provided. According to another embodiment of the present invention, a state of a secondary battery can be estimated. According to another embodiment of the present invention, a charge depth of a secondary battery can be estimated. According to another embodiment of the present invention, a full chargeable capacity of a secondary battery can be estimated, and a deterioration state of the secondary battery can be estimated. According to another embodiment of the present invention, a dischargeable capacity of a secondary battery can be estimated.

According to another embodiment of the present invention, a novel charging unit, a novel charge control circuit, a novel battery control circuit, a novel battery protection circuit, a novel power storage device, a novel semiconductor device, a novel vehicle, a novel electronic device, or the like can be provided. According to another embodiment of the present invention, a charging unit, a charge control circuit, a battery control circuit, a battery protection circuit, a power storage device, a semiconductor device, a vehicle, an electronic device, or the like with low power consumption can be provided. According to another embodiment of the present invention, a charging unit, a charge control circuit, a battery control circuit, a battery protection circuit, a power storage device, a semiconductor device, a vehicle, an electronic device, or the like with a high degree of integration can be provided.

Note that the effects of one embodiment of the present invention are not limited to the effects listed above. The effects listed above do not preclude the existence of other effects. The other effects are effects that are not described in this section and will be described below. The effects that are not described in this section are derived from the description of this specification, the drawings, or the like and can be extracted as appropriate from the description by those skilled in the art. Note that one embodiment of the present invention has at least one of the effects listed above and the other effects. Accordingly, one embodiment of the present invention does not have the effects listed above in some cases.

### BRIEF DESCRIPTION OF THE DRAWINGS

FIG. 1A and FIG. 1B are block diagrams illustrating examples of a power storage system.

FIG. 2A and FIG. 2B are block diagrams illustrating examples of a power storage system.

FIG. 3A and FIG. 3B are block diagrams illustrating examples of a power storage system.

FIG. 4A and FIG. 4B are block diagrams illustrating examples of a power storage system.

FIG. 5 is a flowchart showing a method of charging a secondary battery.

FIG. 6 is a flowchart showing a method of charging a secondary battery.

FIG. 7 is a flowchart showing a method of charging a secondary battery.

FIG. 8 is a block diagram illustrating a structure example of a power storage system.

FIG. 9 is a flowchart showing an operation example of a power storage system.

FIG. 10 is a block diagram illustrating a structure example of a power storage system.

FIG. 11 is a schematic view illustrating an operation example of a power storage system.

FIG. 12 is a flowchart showing an operation example of a power storage system.

FIG. 13A to FIG. 13C are block diagrams illustrating examples of a power storage system.

FIG. 14A and FIG. 14B are cross-sectional views of a positive electrode active material. FIG. 14C to FIG. 14F each illustrate part of the cross-sectional view of the positive electrode active material.

FIG. 15 shows an example of a TEM image showing crystal orientations substantially aligned with each other.

FIG. 16A shows an example of a STEM image showing crystal orientations substantially aligned with each other. FIG. 16B shows an FFT pattern of a region of a rock-salt crystal structure RS.

FIG. 16C shows an FFT pattern of a region of a layered rock-salt crystal structure LRS.

FIG. 17 is a diagram illustrating crystal structures of a positive electrode active material.

FIG. 18 is a diagram illustrating crystal structures of a conventional positive electrode active material.

FIG. 19A and FIG. 19B are cross-sectional views of a positive electrode active material. FIG. 19C and FIG. 19D each illustrate part of the cross-sectional view of the positive electrode active material.

FIG. 20 is a diagram showing XRD patterns calculated from crystal structures.

FIG. 21 is a diagram showing XRD patterns calculated from crystal structures.

FIG. 22 is a cross-sectional view of a positive electrode active material.

FIG. 23A to FIG. 23C are diagrams showing methods of forming a positive electrode active material.

FIG. 24A to FIG. 24H are diagrams illustrating examples of electronic devices.

FIG. 25A to FIG. 25D are diagrams illustrating examples of electronic devices.

FIG. 26A to FIG. 26C are diagrams illustrating examples of electronic devices.

FIG. 27A to FIG. 27C are diagrams illustrating examples of vehicles.

FIG. 28A and FIG. 28B each show a dQ/dV-V curve.

FIG. 29A and FIG. 29B each show a dQ/dV-V curve.

FIG. 30A shows a V-C curve. FIG. 30B shows a ΔV−t curve.

FIG. 31 shows evaluation results of cycle performance of secondary batteries.

FIG. 32 is a graph showing the relation between the number of charge and discharge cycles and a charge termination voltage.

FIG. 33A to FIG. 33C each show a dQ/dV-V curve of a secondary battery.

FIG. 34A and FIG. 34B each show a dQ/dV-V curve of a secondary battery.

### MODE FOR CARRYING OUT THE INVENTION

In this specification and the like, a semiconductor device refers to a device that utilizes semiconductor characteristics, and means a circuit including a semiconductor element (e.g., a transistor or a diode) or a device including the circuit, for example. The semiconductor device also means all devices that can function by utilizing semiconductor characteristics. For example, an integrated circuit including a semiconductor element, a chip provided with an integrated circuit, an electronic component including a packaged chip, and an electronic device provided with an electronic component are examples of a semiconductor device. For example, a display apparatus, a light-emitting apparatus, a power storage device, an optical device, an imaging device, a lighting device, an arithmetic device, a control device, a memory device, a signal processing device, an electronic computer, an electronic device, and the like themselves might be semiconductor devices, or might include semiconductor devices.

Embodiments will be described below with reference to the drawings. Note that the embodiments can be implemented in many different modes. Thus, it will be readily understood by those skilled in the art that the modes and details can be changed in various ways without departing from the spirit and scope thereof. Therefore, the present invention should not be interpreted as being limited to the description in the embodiments.

In this specification and the like, one embodiment of the present invention can be constituted by appropriately combining a structure described in an embodiment with any of the structures described in the other embodiments. In addition, in the case where a plurality of structure examples are described in one embodiment, the structure examples can be combined with each other as appropriate to constitute one embodiment of the present invention.

As for the drawings illustrating the embodiments, in the structures of the invention, the same reference numerals are used in common for the same portions or portions having similar functions in different drawings, and repeated description thereof is omitted in some cases. Furthermore, for example, the same hatching pattern is used for the portions having similar functions throughout the drawings, and the portions are not especially denoted by reference numerals in some cases. Moreover, some components are omitted in a perspective view or a top view (also referred to as a “plan view”), for example for easy understanding of the drawings in some cases. The description of, for example, some hidden lines might also be omitted in the drawings. In the drawings, for example, a hatching pattern or the like may be omitted.

In the drawings, the size, the layer thickness, or the region is sometimes exaggerated for clarity. Thus, the drawings are not necessarily limited to the drawings with the illustrated size, aspect ratio, and the like, for example. Note that the drawings schematically illustrate ideal examples, and embodiments of the present invention are not limited to shapes, values, and the like illustrated in the drawings, for example. For example, in the actual manufacturing process, a layer, a resist mask, or the like might be unintentionally reduced in size by treatment such as etching, which might not be reflected in the drawings for easy understanding. For example, in the actual circuit operation, a fluctuation in voltage, current, or the like might be caused by noise, difference in timing, or the like, which is not illustrated in some cases for easy understanding.

In this specification, the drawings, and the like, components of the present invention are classified on the basis of the functions, and shown as elements independent of one another in some cases. However, such components are sometimes hard to classify functionally, and there is a case where one component is associated with a plurality of functions and a case where a plurality of components are associated with one function. Accordingly, the component is not limited to that described in this specification, drawings, and the like and can be explained with another term as appropriate depending on the situation.

In this specification, the drawings, and the like, when a plurality of components are denoted by the same reference numerals, and in particular need to be distinguished from each other, an identification sign such as “A”, “b”, “_1”, “[n]”, or “[m, n]” is sometimes added to the reference numerals, for example.

Note that in this specification and the like, a “conduction state” or “on state” of a transistor refers to a state where a source and a drain of the transistor can be regarded as being electrically short-circuited or a state where current can be made to flow between the source and the drain. For example, the “conduction state” or the “on state” refers to a state where the voltage between the gate and the source is higher than the threshold voltage in an n-channel transistor, a state where the voltage between the gate and the source is lower than the threshold voltage in a p-channel transistor, or the like in some cases. Furthermore, a “non-conduction state”, a “cutoff state”, or an “off state” of the transistor refers to a state where the source and the drain of the transistor can be regarded as being electrically disconnected. For example, the “non-conduction state”, the “cutoff state”, or the “off state” refers to a state where the voltage between the gate and the source is lower than the threshold voltage in an n-channel transistor, a state where the voltage between the gate and the source is higher than the threshold voltage in a p-channel transistor, or the like in some cases.

In this specification and the like, “on-state current” of a transistor refers to current flowing between a source and a drain of the transistor in an on state (also referred to as drain current) unless otherwise specified. In this specification and the like, “off-state current” of a transistor refers to current flowing between a source and a drain of the transistor in an off state unless otherwise specified. Note that in this specification and the like, when the transistor is in an off state, drain current and current flowing between the gate and the source or the drain (also referred to as gate leakage current) are sometimes referred to as leakage current.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “-” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure. In this specification and the like, the space group R-3m is represented by a composite hexagonal lattice, unless otherwise specified. In some cases, not only (hkl) but also (hkil) is used as the Miller index. Here, i is −(h+k).

In this specification and the like, a particle is not limited to referring to only a spherical shape (a circular cross-sectional shape). The cross-sectional shape of each of particles may be an ellipse, a rectangle, a trapezoid, a pyramid, a quadrilateral with rounded corners, an asymmetrical shape, or the like, for example. Note that each of the particles may have an irregular shape.

In this specification and the like, uniformity refers to a phenomenon in which, in a solid made of a plurality of elements (e.g., A, B, and C), a certain element (e.g., A) is distributed with similar features in specific regions. Note that the concentrations of the element in the specific regions are substantially the same. For example, the difference in concentration of the element between the specific regions is less than or equal to 10%. Examples of the specific regions include a surface portion, a surface, a projection, a depression, and a bulk.

In this specification and the like, segregation refers to a phenomenon in which, in a solid made of a plurality of elements (e.g., A, B, and C), a certain element (e.g., B) is spatially non-uniformly distributed.

A secondary battery of one embodiment of the present invention in this specification and the like includes a positive electrode and a negative electrode, for example. A positive electrode active material is a material included in the positive electrode. The positive electrode active material is a substance that performs a reaction contributing to charge and discharge of the secondary battery, for example. Note that the positive electrode active material may partly contain a substance that does not contribute to the charge and discharge of the secondary battery.

In this specification and the like, a positive electrode active material refers to a compound containing oxygen and a transition metal into and from which lithium can be inserted and extracted. The positive electrode active material does not include, for example, a carbonic acid, a hydroxy group, and the like which are adsorbed after formation of the positive electrode active material. Furthermore, The positive electrode active material does not include an electrolyte, an organic solvent, a binder, a conductive material, and a compound originating from any of these that are attached to the positive electrode active material after the formation.

In this specification and the like, a positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite. The positive electrode active material refers to a group of particles of lithium cobalt nickel oxide, for example.

A theoretical capacity of a positive electrode active material refers to the quantity of electricity obtained when all lithium that can be inserted and extracted and is contained in the positive electrode active material is extracted. For example, the theoretical capacity of lithium cobalt oxide (LiCoO₂) is 274 mAh/g, the theoretical capacity of lithium nickel oxide (LiNiO₂) is 274 mAh/g, and the theoretical capacity of lithium manganese oxide (LiMn₂O₄) is 148 mAh/g.

The charge depth (SOC: State of Charge) is a value showing the degree of charge with reference to the theoretical capacity of a positive electrode active material, i.e., the amount of lithium released from the positive electrode. For example, in the case of a positive electrode active material having a layered rock-salt crystal structure such as lithium cobalt oxide (LiCoO₂) or lithium nickel cobalt manganese oxide (LiNiₓCo_{y}Mn_{z}O₂ (x+y+z=1)), a charge depth of 0 indicates a state where no lithium has been extracted from the positive electrode active material; a charge depth of 0.5 indicates a state where lithium corresponding to 137 mAh/g has been extracted from the positive electrode active material; and a charge depth of 0.8 indicates a state where lithium corresponding to 219.2 mAh/g has been extracted from the positive electrode active material, relative to the theoretical capacity of 274 mAh/g.

The remaining amount of lithium in a positive electrode active material, which is compared to the theoretical capacity, is represented by x in a compositional formula, e.g., LiₓCoO₂ or LiₓMO₂. Here, M means a transition metal that is oxidized or reduced due to insertion and extraction of lithium. In this specification and the like, LiₓCoO₂ can be replaced with LiₓMO₂ as appropriate. In the case of a positive electrode active material in a secondary battery, x=(theoretical capacity−charge capacity (the quantity of electricity charged))/theoretical capacity can be satisfied. For example, in the case where a secondary battery using LiCoO₂ as a positive electrode active material is charged to 219.2 mAh/g, it can be said that the positive electrode active material is represented by Li_{0.2}CoO₂ or x=0.2. Small x in LiₓCoO₂ means, for example, 0.1<x≤0.24.

In the case where lithium cobalt oxide almost satisfies the stoichiometric proportion, lithium cobalt oxide is LiCoO₂ and the occupancy rate of lithium in the lithium sites is x=1. In a secondary battery after its discharge ends, it can be said that contained lithium cobalt oxide is LiCoO₂ and x=1. Here, “discharge ends” means that a voltage becomes lower than or equal to 2.5 V (lithium counter electrode) at a current of 100 mA/g, for example. In a lithium ion secondary battery, the voltage rapidly decreases when the occupancy rate of lithium in the lithium sites becomes x=1 and no more lithium can enter the lithium ion secondary battery. At this time, it can be said that discharge ends. In general, in a lithium ion secondary battery using LiCoO₂, the discharge voltage rapidly decreases before discharge voltage reaches 2.5 V; thus, discharge ends under the above-described conditions. When the positive electrode after discharge ends is analyzed by, for example, an XRD pattern or the like, a general crystal structure of LiCoO₂ can be observed.

The charge capacity (the quantity of electricity charged) and discharge capacity used for calculation of x in LiₓCoO₂ are preferably measured under conditions of no short circuits and no or less influence of decomposition of an electrolyte. For example, data of a secondary battery, suffering from a sudden change of capacity that seems to result from a short circuit, should not be used for calculation of x.

The space group of a crystal structure is identified by, for example, an XRD pattern, an electron diffraction pattern, a neutron diffraction pattern, or the like. Thus, in this specification and the like, belonging to a space group, being attributed to a space group, or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned right above voids between anions packed in a first layer, and anions in a third layer are placed at the positions that are positioned right above voids between the anions in the second layer and are not positioned right above the anions in the first layer. Accordingly, anions do not necessarily form a cubic lattice structure. In addition, actual crystals always have a defect and thus, analysis results are not necessarily consistent with the theory. For example, in an electron diffraction pattern or a FFT (Fast Fourier Transform) pattern of a TEM (Transmission Electron Microscope) image or the like, a spot may appear in a position different from a theoretical position. For example, anions may be regarded as forming a cubic close-packed structure when a difference in orientation from a theoretical position is less than or equal to 5° or less than or equal to 2.5°.

The potential of a positive electrode generally increases with increasing charge voltage of a secondary battery. The positive electrode active material of one embodiment of the present invention has a stable crystal structure even at a high charge voltage. The stable crystal structure of the positive electrode active material in a charged state can inhibit a decrease in capacity capable of being fully charged due to repeated charge and discharge.

A short circuit of a secondary battery might not only cause t least one of a malfunction in charging operation and discharging operation of the secondary battery but also heat generation and ignition. In order to obtain a safe secondary battery, short-circuit current is preferably inhibited even at a high charge voltage. With the positive electrode active material of one embodiment of the present invention, short-circuit current is inhibited even at a high charge voltage. Thus, a secondary battery with both high discharge capacity and high safety can be obtained.

The description is made on the assumption that materials (such as a positive electrode active material, a negative electrode active material, and an electrolyte) of a secondary battery have not deteriorated unless otherwise specified. For example, a state where a secondary battery has a full chargeable capacity that is higher than or equal to 97% of the rated capacity can be regarded as a non-degraded state. The rated capacity conforms to JIS C 8711:2019. Note that in this specification and the like, in some cases, materials included in a secondary battery that have not deteriorated are referred to as initial products or materials in an initial state, and materials that have deteriorated (have full chargeable capacity lower than 97% of the rated capacity of the secondary battery) are referred to as products in use, materials in a used state, products that are already used, or materials in an already-used state.

### Embodiment 1

In this embodiment, a charging unit of one embodiment of the present invention and a power storage system that includes the charging unit of one embodiment of the present invention are described.

### Example 1 of Power Storage System

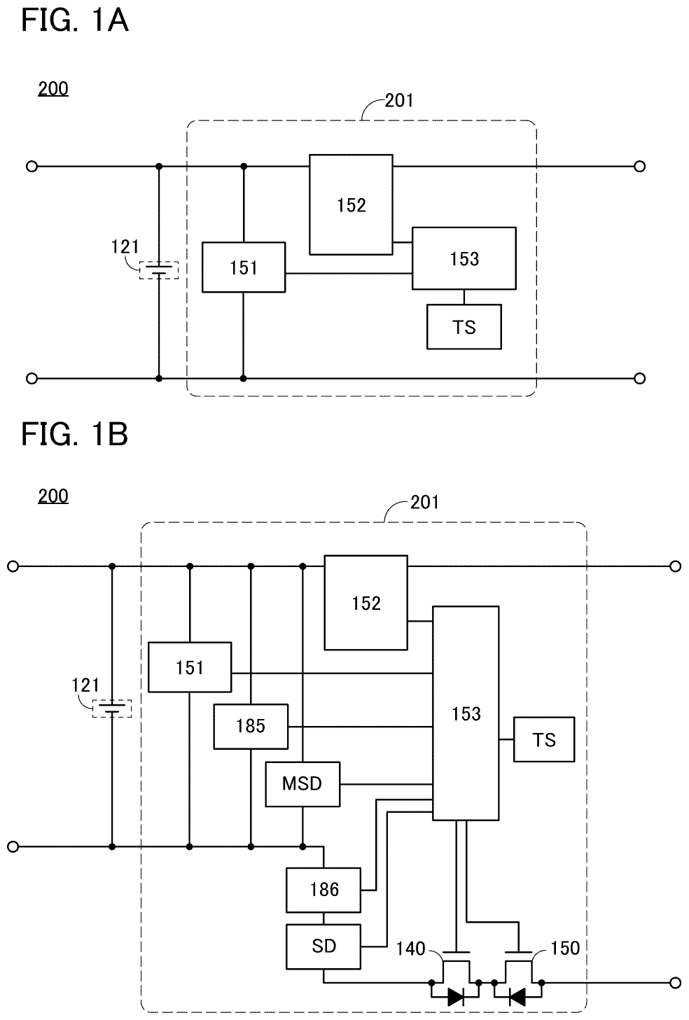

FIG. 1A is a block diagram illustrating an example of a power storage system 200. The power storage system 200 includes a charging unit 201 and a secondary battery 121. The charging unit 201 is electrically connected to a positive electrode and a negative electrode of the secondary battery 121.

The charging unit 201 includes a control circuit 153, a current measuring circuit 152, and a voltage measuring circuit 151. The charging unit 201 preferably includes a temperature sensor TS. The ambient temperature of the secondary battery can be measured by the temperature sensor TS. The temperature sensor TS is set to be in contact with an exterior body or a housing of the secondary battery, for example. Charge control using the temperature sensor TS is described later.

The current measuring circuit 152 has a function of measuring a current of the secondary battery 121 (a current flowing through the secondary battery 121). In particular, the current measuring circuit 152 preferably has a function of measuring a charge current of the secondary battery 121 (a current flowing at the time of charging the secondary battery 121). The current measuring circuit 152 can supply a measured current value to the control circuit 153.

The voltage measuring circuit 151 has a function of measuring a voltage of the secondary battery 121 (a potential difference generated between the positive electrode and the negative electrode of the secondary battery 121). In particular, the voltage measuring circuit 151 preferably has a function of measuring a charge voltage of the secondary battery 121 (a potential difference generated between the positive electrode and the negative electrode at the time of charging the secondary battery 121). The voltage measuring circuit 151 can supply a measured voltage value to the control circuit 153.

The control circuit 153 has a function of controlling the start and stop of charge of the secondary battery 121. The control circuit 153 also has a function of controlling charge conditions of the secondary battery 121. Specifically, the control circuit 153 has a function of controlling a charge current of the secondary battery 121, for example.

As the control circuit 153, a CPU (Central Processing Unit), an MCU (Micro Controller Unit), or the like can be used, for example.

The control circuit 153 has a function of calculating a change over time of a voltage of the secondary battery 121 supplied from the voltage measuring circuit 151 or a function of calculating a time derivative of the voltage. For example, calculating a change over time of a voltage or calculating a time derivative of a voltage refers to obtaining a plurality of sets of data on a voltage value and time and performing calculation using the obtained plurality of sets of data. Note that the control circuit 153 preferably includes an analog-digital conversion circuit. The control circuit 153 can convert the obtained analog voltage value of the secondary battery 121 into a digital value with the use of the analog-digital conversion circuit. In the case where an MCU is used as the control circuit 153, the control circuit 153 may include the voltage measuring circuit 151 and an analog-digital conversion circuit unit. The analog-digital conversion circuit may be prepared separately from the control circuit 153.

The control circuit 153 has a function of calculating a time integral of a current of the secondary battery 121 supplied from the current measuring circuit 152, i.e., a function of calculating the quantity of electricity of the secondary battery 121. Calculating a time integral of a current, i.e., calculating the quantity of electricity, refers to, for example, obtaining a plurality of sets of data on a current value and time and performing calculation using the obtained plurality of sets of data. The control circuit 153 has a function of calculating a differential (dQ/dV) of quantity of electricity with respect to voltage of the secondary battery 121. Calculating a differential of quantity of electricity with respect to voltage refers to obtaining a plurality of sets of data on a voltage value, a current value, and time and performing calculation using the obtained plurality of sets of data.

The control circuit 153 includes a memory circuit. The memory circuit has a function of a register or a cache memory of a CPU or an MCU, for example. The memory circuit has a function of storing, for example, various programs used in the power storage system 200, various kinds of data necessary for operation of the power storage system 200, and the like.

FIG. 1B is a block diagram illustrating another example of the power storage system 200. The charging unit 201 included in the power storage system 200 illustrated in FIG. 1B includes, in addition to the components illustrated in FIG. 1A, a detection circuit 185, a detection circuit 186, a short-circuit detection circuit SD, a micro short-circuit detection circuit MSD, a transistor 140, and a transistor 150. The detection circuit 185, the detection circuit 186, the short-circuit detection circuit SD, the micro short-circuit detection circuit MSD, the transistor 140, and the transistor 150 will be described later in detail.

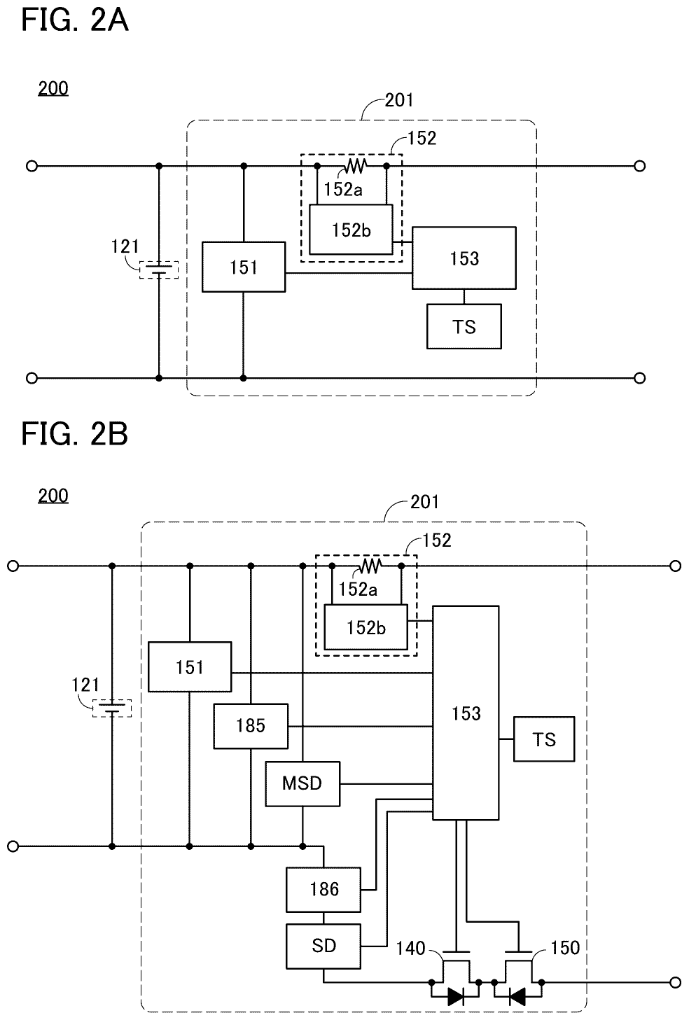

FIG. 2A and FIG. 2B are block diagrams illustrating specific structure examples of the current measuring circuit 152 in the charging unit 201 included in the power storage system 200 illustrated in FIG. 1A and FIG. 1B. As illustrated in FIG. 2A and FIG. 2B, the current measuring circuit 152 includes a resistor 152a and a circuit 152b.

The resistor 152a has a function of a shunt resistor. The circuit 152b has a function of measuring voltages at both ends of the resistor 152a.

Note that the current measuring circuit 152 is not limited to having a resistance detection structure using a shunt resistor (the resistor 152a) as illustrated in FIG. 2A and FIG. 2B. The current measuring circuit 152 may have a magnetic field detection structure using a coil, a hall element, a magnetoresistive element, a magnetic impedance element, a flux gate, or the like, for example.

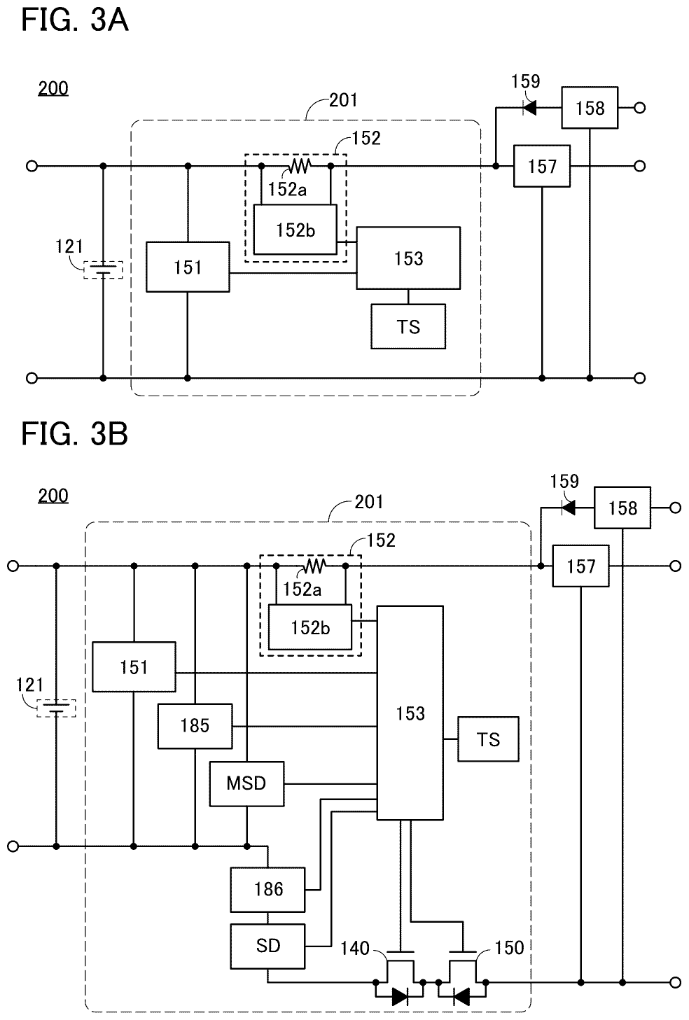

FIG. 3A and FIG. 3B are block diagrams illustrating other examples of the power storage system 200. The power storage system 200 illustrated in FIG. 3A and FIG. 3B includes a DC-DC converter 157, a circuit 158, and a diode 159 in addition to the components illustrated in FIG. 2A and FIG. 2B.

As illustrated in FIG. 3A and FIG. 3B, the power storage system 200 may include the DC-DC converter 157. The DC-DC converter 157 includes a voltage conversion circuit (not illustrated) and a control circuit (not illustrated). The DC-DC converter 157 has a function of converting a voltage of the secondary battery 121 and outputting the converted voltage.

As illustrated in FIG. 3A and FIG. 3B, the power storage system 200 may include the circuit 158. The circuit 158 preferably has a function of an AC adapter. That is, the circuit 158 has a function of converting AC power into DC power, for example. The circuit 158 has a function of converting a voltage, for example. The circuit 158 has a function of supplying electric power that has been converted into DC to the secondary battery 121. The circuit 158 may have a function of controlling a current value and a voltage value that are to be supplied when supplying electric power to the secondary battery 121. Alternatively, the circuit 158 may have a function of controlling a current value and a voltage value that are to be supplied to the secondary battery 121, on the basis of a signal supplied from the control circuit 153.

In the power storage system 200 illustrated in FIG. 3A and FIG. 3B, the diode 159 may be provided between the circuit 158 and the charging unit 201. The diode 159 has a function of inhibiting a reverse current from the charging unit 201 to the circuit 158.

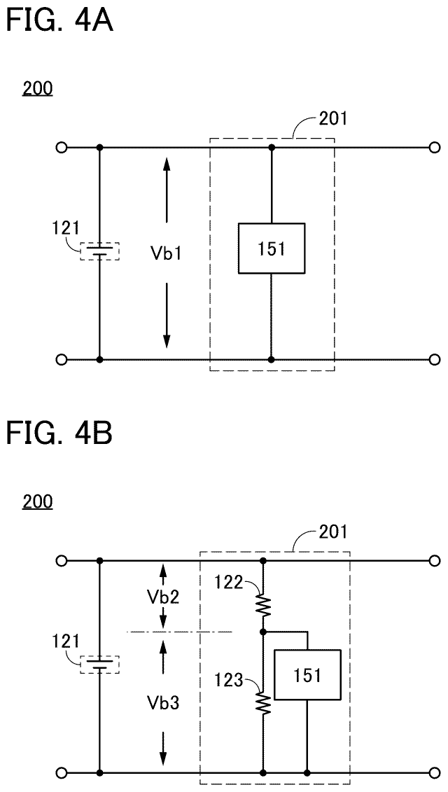

FIG. 4A and FIG. 4B are block diagrams illustrating the measurement of the voltage of the secondary battery 121 by the voltage measuring circuit 151 in the power storage system 200. The voltage measuring circuit 151 may measure a voltage Vb1 between the positive electrode and the negative electrode of the secondary battery 121 as illustrated in FIG. 4A or may measure a voltage obtained by dividing the voltage Vb1 by resistors as illustrated in FIG. 4B.

In FIG. 4B, the voltage Vb1 is divided into a voltage Vb2 and a voltage Vb3 by a resistor 122 and a resistor 123. The voltage measuring circuit 151 measures the voltage Vb3 obtained by voltage division by the resistors.

Note that in the case where the voltage Vb1 between the positive electrode and the negative electrode of the secondary battery 121 is divided by the resistors and the voltage Vb3 obtained by voltage division by the resistors is measured as illustrated in FIG. 4B, the voltage measuring circuit 151 or the control circuit 153 may estimate the voltage Vb1 between the positive electrode and the negative electrode of the secondary battery 121 from the voltage Vb3 obtained by voltage division by the resistors.

The charging unit 201 preferably has a function of a coulomb counter. For example, the charging unit 201 has a function of calculating a charge capacity (the quantity of electricity charged) and a discharge capacity of the secondary battery 121 by calculating the quantity of accumulated electricity of the secondary battery 121 using the current measuring circuit 152 and the control circuit 153. The charging unit 201 may have a function of analyzing charge depth with the use of the calculated charge capacity (quantity of electricity charged) and discharge capacity.

### {Charge}

Next, charge of a secondary battery using the charging unit of one embodiment of the present invention is described.

In the secondary battery, the crystal structure of a positive electrode active material changes as the charge depth is deeper (as the charge capacity (quantity of electricity charged) is increased). If the change of the crystal structure is irreversible, the full chargeable capacity of the secondary battery might be decreased by repeated charge in some cases.

Therefore, for achievement of a secondary battery with a high discharge capacity and a long lifetime, for example, the charge depth of the secondary battery is required to be increased and be controlled to be in a range where the change of the crystal structure can be substantially reversible.

For example, when a certain voltage is set as an upper limit voltage of charge of the secondary battery, the charge depth of the secondary battery can be controlled to be in the range where the change of the crystal structure can be substantially reversible. However, the state of the secondary battery is changed by repeated charge and discharge; thus, it is difficult to keep the same charge depth of the secondary battery as the number of charge-discharge cycles is increased, even when charge is performed with the same voltage set as the upper limit voltage. Accordingly, a monitoring system for a charge process is needed to control the charge depth of the secondary battery to be in the range where a change in the crystal structure can be substantially reversible.

The use of the charging unit of one embodiment of the present invention can monitor a charge process, and control the charge depth of the secondary battery to be deep and be in the range where a change in the crystal structure can be substantially reversible. The positive electrode active material of one embodiment of the present invention is preferably used for the secondary battery.

The charging unit of one embodiment of the present invention controls the charge conditions of the secondary battery, thereby inhibiting the collapse of the crystal structure of a positive electrode active material of the secondary battery. Specifically, for example, the charging unit of one embodiment of the present invention can increase the charge voltage of the secondary battery to the utmost limit in the range where the collapse of the crystal structure can be inhibited, increase the reliability of the secondary battery, and achieve the high energy density by efficiently utilizing the secondary battery to the fullest extent.

In addition, the charging unit of one embodiment of the present invention can inhibit the collapse of the crystal structure of a positive electrode active material having a layered crystal structure, in particular. The positive electrode active material having a layered crystal structure has, for example, a layered arrangement of metal serving as carrier ions. For example, in lithium cobalt oxide, lithium is present in a layered manner between CoO₂ layers. In the positive electrode active material having a layered crystal structure, crystal distortion by extraction of carrier ions in charge, a change of the crystal structure due to the extraction of carrier ions, or the like might occur. For example, in lithium cobalt oxide, a shift between the CoO₂ layers, shortening of the interlayer distance between the CoO₂ layers, or the like might occur at the time of extraction of lithium ions in charge. In the case where such a change in the crystal structure of the positive electrode active material is reversible, decreases in a capacity capable of fully charged and a discharge capacity due to repeated charge and discharge can be reduced. On the other hand, when the charge voltage is too high, the charge depth is increased and the amount of extracted carrier ions is increased. With the increased charge depth, the change of the crystal structure due to charge become irreversible, which might lower the capacity capable of fully charged and the discharge capacity.

In addition, too high a charge voltage may cause dissolution of a component of the positive electrode active material into an electrolyte solution and collapse of the positive electrode active material. Charge at a high voltage may cause a decomposition reaction or the like of a component of an electrolyte.

The charging unit of one embodiment of the present invention can, with a simple method, detect a change of a crystal structure, increase a charge voltage to the utmost limit in a range where a high reliability can be secured, and efficiently utilize a secondary battery to the fullest extent.

The secondary battery including the charging unit of one embodiment of the present invention is preferably a secondary battery of which an upper limit voltage of charge can be determined on the basis of a waveform obtained in charge. Here, the waveform can have a variety of shapes, for example, a curve, a straight line, and a combined shape of a curve and a straight line. In addition, the waveform is not limited to a periodic wave. As an example of the waveform obtained in charge, a dQ/dV-V curve, a ΔV−t curve, or the like obtained from data of a voltage, a time, and a current in charge can be given, for example. That is, in the secondary battery for which the charging unit of one embodiment of the present invention is used, an extremum due to a change of the crystal structure of the positive electrode active material is preferably detected in a waveform obtained in charge. Furthermore, in the secondary battery for which the charging unit of one embodiment of the present invention is used, the charge voltage in repeated charge and discharge is preferably increased to the utmost limit, and also in the increased charge voltage, the change of the crystal structure of the positive electrode active material is preferably substantially reversible. Here, the term substantially reversible means that the change is reversible or that a deterioration due to repeated changes of a crystal structure is extremely small even in the case where the change is irreversible. The positive electrode active material of one embodiment of the present invention changes from an O3 type crystal structure into an O3′ type crystal structure described later when the charge depth of the secondary battery is approximately 80% or in the vicinity thereof. In addition, in the case where this change is generated, an extremum is observed in a dQ/dV curve or the like. The charging unit of one embodiment of the present invention has a function of detecting the extremum and controlling charge.

In order to efficiently use the secondary battery including the charging unit of one embodiment of the present invention to the utmost limit within a range where a change of the crystal structure is substantially reversible, the above-described extremum due to the change of the crystal structure is preferably close to the upper limit voltage of charge. For example, the extremum due to the change of the crystal structure is preferably lower than the upper limit voltage of charge, and the difference between the voltage at which the extremum is detected and the upper limit voltage of charge is preferably less than or equal to 0.15 V.

Moreover, preferably, in the secondary battery for which the charging unit of one embodiment of the present invention is used, the crystal structure of the positive electrode active material can change substantially reversibly in charge and discharge, even when charge is performed at a voltage higher than a voltage at which the extremum is detected for a predetermined time. With the secondary battery for which the charging unit of one embodiment of the present invention is used and which has such characteristics, the charging unit of one embodiment of the present invention can control the upper limit voltage of charge simply using the extremum, in order to efficiently utilize the secondary battery to the fullest extent.

The extremum due to the change of the crystal structure is detected, for example, in a voltage change curve over time of a secondary battery. Alternatively, the extremum is detected in a differential curve of voltage with respect to time (dV/dt curve) of the secondary battery.

In addition, the extremum due to the change of the crystal structure is detected, for example, in a differential curve of quantity of electricity with respect to voltage (dQ/dV curve) of the secondary battery.

Constant-current constant-voltage (CCCV) charge is used in some cases to charge a secondary battery. In CCCV charge, constant current charge is performed up to the upper limit voltage of charge and then constant voltage charge is performed. When constant voltage charge is performed at the upper limit voltage of the constant current charge in CCCV charge, for example, the charge can be performed at the upper limit voltage over an adequate time and the charge capacity (quantity of electricity charged) is less likely to be influenced by a change of impedance or the like due to deterioration of the secondary battery, so that the charge capacity (quantity of electricity charged) can have fewer variations.

Increasing the charge voltage can increase the charge capacity (quantity of electricity charged). However, charge at a high voltage may cause collapse of the crystal structure of the positive electrode active material, a decomposition reaction of a component of an electrolyte, or the like, depending on the performance of the positive electrode active material. Thus, the constant voltage charge at the upper limit voltage might promote the deterioration of the secondary battery. The use of the constant current charge is preferable because the charge time at the upper limit voltage can be reduced and the lifetime of the secondary battery can be longer. In particular, if the ambient temperature of the secondary battery is a high temperature exceeding 40° C., the secondary battery might be remarkably degraded in the constant voltage charge at the upper limit voltage. Therefore, in the case where the ambient temperature of the secondary battery is high, constant current charge is further preferably performed. In the case where the ambient temperature of the secondary battery is high, it is also preferable that constant voltage charge at a high voltage not be employed or the time of the constant voltage charge at a high voltage be as short as possible.

Here is a description of charge in the case of using a positive electrode active material represented by a chemical formula AM_{y}O_{z} (y>0, z>0), specifically, a positive electrode active material represented by a chemical formula AMO₂, for example. Details of the positive electrode active material that is represented by the chemical formula AM_{y}O_{z} (y>0, z>0), the element A, and the metal Mare described later. Although the positive electrode active material is represented by the chemical formula AMO₂, the composition of A:M:O is not limited to 1:1:2. In addition, lithium cobalt oxide is represented by LiCoO₂ in some cases. Moreover, lithium nickel oxide is represented by LiNiO₂ in some cases.

With the use of the charging unit of one embodiment of the present invention, for example, the secondary battery is charged so that the charge depth is 85% or lower, 80% or lower, or 77% or lower at a temperature of higher than or equal to 35° C. and lower than or equal to 55° C.

The degree of charge, that is, the remaining amount of lithium that can be inserted into and extracted from a positive electrode active material is represented by x in a compositional formula, e.g., LiₓCoO₂. In the case of a positive electrode active material in a secondary battery, x can be represented by (theoretical capacity−charge capacity (quantity of electricity charged))/theoretical capacity. For example, when a secondary battery using LiCoO₂ as a positive electrode active material is charged to 219.2 mAh/g, the positive electrode active material can be represented by Li_{0.2}CoO₂, i.e., x=0.2. Note that “x in LiₓCoO₂ is small” means, for example, 0.1<x≤0.24.

In the power storage system of one embodiment of the present invention, charge is performed so that x can be less than or equal to 0.2, less than or equal to 0.24, or less than or equal to 0.3.

In such a case, for example, charge is performed such that the upper limit voltage of charge, that is, the potential of the positive electrode, is preferably 4.8 V or lower, further preferably 4.75 V or lower, further preferably 4.7 V or lower, further preferably 4.65 V or lower with reference to the lithium potential (Li/Li⁺) at higher than or equal to 35° C. and lower than or equal to 55° C.

In such a case, charge is performed such that a charge rate (also referred to as C rate or capacity rate) is preferably 0.35 C or more, further preferably 0.45 C or more, further preferably 0.7 C or more, further preferably 0.9 C or more at higher than or equal to 40° C. and lower than or equal to 55° C., for example. Here, “C” represents a unit of a rate. In particular, charge is performed at the charge rate at a voltage at which the potential of the positive electrode can be 4.2 V or higher, 4.3 V or higher, or 4.4 V or higher with reference to the lithium potential (Li/Li⁺). Here, on the assumption that the quantity of electricity obtained when the total amount of the element A (the element A is lithium in the case of lithium cobalt oxide) included in the positive electrode active material is used in a charge reaction is 1, a charge rate of 1 C is a current density at which approximately 0.7 times the quantity of electricity is stored in one hour, for example.

Note that by setting the charge depth shallow, the lifetime of the secondary battery can be increased; however, when the charge depth is too shallow, the discharge capacity of the secondary battery becomes small. Therefore, the charge depth is preferably for example, higher than or equal to 50%, further preferably higher than or equal to 60%, still further preferably higher than or equal to 70%, still further preferably higher than or equal to 73%. The charge depth may be higher than 75%.

Here, the charge depth refers to a value normalized with the charge capacity (quantity of electricity charged) per weight of the positive electrode active material, and a state where all of lithium contained in the positive electrode active material is extracted is regarded as charge depth=100%.

Note that the calculation method of charge depth in the secondary battery is not limited to the above example. For example, charge corresponding to a rated capacity of the secondary battery may be regarded as charge depth=100%. The normalization of the charge capacity (quantity of electricity charged) used for the charge depth is not limited to the above example. The volume of the secondary battery, the internal volume of the secondary battery, the volume of part of the secondary battery, the weight of the secondary battery, the weight of a content of the secondary battery, the weight of part of the secondary battery, or the like may be used for normalization.

In the charging unit of one embodiment of the present invention, an extremum resulting from a change of the crystal structure of the positive electrode active material can be detected in a dQ/dV curve or the like, and constant current charge can be performed. In addition, constant current charge using the detection of the extremum is easy and good in controllability. Thus, with the use of the charging unit of one embodiment of the present invention, a secondary battery in which variation in charge capacity (quantity of electricity charged) is small and deterioration due to charge at a high voltage is suppressed can be achieved.

Details of the secondary battery that can be used as the secondary battery 121 are described later.

### Example 1 of Charging Method

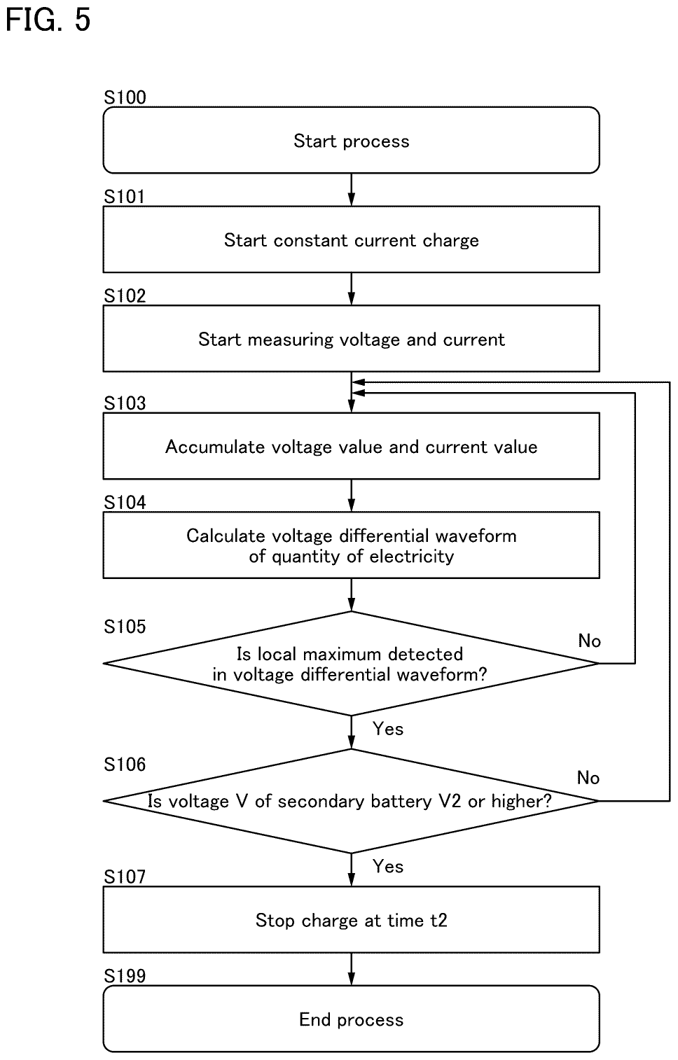

Next, an example of a charging method using the charging unit of one embodiment of the present invention is described with reference to a flowchart of FIG. 5.

First, a process starts in Step S100.

Next, in Step S101, constant current charge of a secondary battery is started at the time t1. Note that the constant current charge is continued until charge is stopped in Step S107.

Next, in Step S102, the voltage measurement circuit 151 starts measurement of a voltage of the secondary battery. In addition, the current measurement circuit 152 starts measurement of a current of the secondary battery. The voltage measurement circuit 151 supplies the measured voltage value to the control circuit 153. The current measurement circuit 152 supplies the measured current value to the control circuit 153.

Next, in Step S103, the control circuit 153 accumulates, as a set of data with time, the voltage value measured by the voltage measurement circuit 151 and the current value measured by the current measurement circuit 152 after Step S102. In the data accumulation, the memory circuit or the like included in the control circuit 153 can be used. As the time linked to the voltage value and the current value, an elapsed time from the start of charge may be used, for example.

Next, in Step S104, the control circuit 153 calculates a differential curve of quantity of electricity with respect to voltage (dQ/dV curve) of the secondary battery with use of the sets of data containing the voltage value, the current value, and time, which are accumulated at any time. Here, in Step S103, after a certain period during which the sets of data containing the voltage value, the current value, and time are accumulated, the differential curve of quantity of electricity with respect to voltage of the secondary battery may be calculated. For example, the sets of data may be accumulated in a period which is sufficient for detection of the extremum.

Next, in Step S105, the control circuit 153 analyzes a curve with the horizontal axis of a voltage V and the vertical axis of a derivative of quantity of electricity Q with respect to voltage, dQ/dV (hereinafter, the curve is referred to as a dQ/dV-V curve) and performs determination whether an extremum (also referred to as a peak) is detected. When an extremum, for example, a local maximum (a peak with an upward projection) in this case, is detected in the dQ/dV-V curve, the process proceeds to Step S106. When it is not detected, the process returns to Step S103. Note that a plurality of extrema may be detected in the dQ/dV-V curve. In such a case, the highest extremum of the plurality of extrema is detected. Alternatively, r (r is an integer of 2 or more) higher extrema of the plurality of extrema are detected and any of the r extrema may be selected.

Here, the “higher extrema” refer to ones that are high in a rank determined under predetermined conditions. For example, the rank may be a descending order of the extrema.

The control circuit 153 preferably continue to accumulate the set of data containing the voltage value, the current value, and time, while the steps from Step S103 to Step S105 are repeated. In other words, when steps from Step S103 to Step S105 are repeated n times, the dQ/dV-V curve can be calculated with use of all the pieces of data of n repetitions. Alternatively, data of the latest time or data of the latest several times of the n times may be used.

Next, in Step S106, the control circuit 153 determines whether the voltage of the secondary battery is higher than or equal to a predetermined voltage. When the voltage V of the secondary battery is higher than or equal to the voltage V2, the process proceeds to Step S107. When the voltage V is lower than the voltage V2, the process returns to Step S103. Here, the voltage V2 is, for example, higher than or equal to 4.25 V, or higher than or equal to 4.25 and lower than 4.8 V.

Alternatively, determination of the magnitude of the voltage V and the voltage V2 in Step S106 may be performed on the basis of the charge depth of the secondary battery. For example, if the charge depth of the secondary battery is greater than or equal to S1%, the process proceeds to Step S107, and if it is less than S1%, the process returns to Step S103. Here, S1 is higher than or equal to 60 [%], or higher than or equal to 60 [%] and lower than or equal to 95 [%].

The control circuit 153 can accumulate the sets of data containing the voltage value, the current value, and time continually, until the process proceeds to Step S107 from the initial Step S103 of the repeated Steps S103.

Next, in Step S107, a time tp showing an extremum is detected by analysis in the dQ/dV-V curve, and charge is stopped at time t2, at which a predetermined time is elapsed from the time tp. Here, the predetermined time is, for example, the time required for stopping the charge by the control circuit 153. Alternatively, the time t2 may be set in the following manner: in the dQ/dV-V curve, a region having a desired voltage width with a voltage giving the extremum as a center is determined and a time corresponding to the voltage at the top edge in the region is set as the time t2, for example. When the extremum is not detected in Step S107, the charge may be stopped when the charge voltage reaches a predetermined charge voltage.

Furthermore, as the conditions of stopping the charge in Step S107, the detection of the extremum is given here; alternatively, stopping the charge may be controlled on the basis of an elapsed time or the like from a detected inflection point, for example.

Smoothing of a curve to be analyzed may be performed. As the smoothing method, for example, a moving average may be used.

Here, the inflection point detected at the time tp is, for example, an inflection point that is ascribable to a change of a crystal structure in the positive electrode active material of the positive electrode of the secondary battery.

By using the positive electrode active material of one embodiment of the present invention as the positive electrode active material, the collapse of the crystal structure of the positive electrode active material due to the repeated charge and discharge can be inhibited when charge of the secondary battery is stopped at a time close to the time tp.

A specific example of the inflection points detected at the time tp can be an inflection point corresponding to a change of the crystal structure of the positive electrode active material from the O3 type crystal structure to the O3′ type crystal structure, with use of the positive electrode active material of one embodiment of the present invention. The positive electrode active material here is, for example, lithium cobalt oxide. The charge voltage or the charge depth at the time t2 is preferably lower than the charge voltage or shallower than the charge depth at which the crystal structure of the positive electrode active material changes to the H1-3 type crystal structure. The O3 type crystal structure, the O3′ type crystal structure, and the H1-3 type crystal structure will be described in detail later. Note that the change from the O3 type crystal structure to the O3′ type crystal structure is expressed as a phase change in some cases.

In the power storage system of one embodiment of the present invention, the crystal structure in the positive electrode active material of the secondary battery can be controlled to be the O3′ type crystal structure at the time t2, for example. Accordingly, the collapse of the crystal structure of the positive electrode active material in the secondary battery due to repeated charge and discharge can be inhibited.

Note that when the positive electrode in the charge state corresponding to the time t2 is analyzed by XRD pattern, the crystal structure to be determined is preferably expressed by the space group R-3m. Further preferably, the crystal structure to be determined is expressed by the space group R-3m and is indicated to be the O3′ type crystal structure.

For example, in the charge state corresponding to the time t2, in the case where the positive electrode that is obtained by disassembling the secondary battery charged by the power storage system of one embodiment of the present invention is evaluated by the XRD pattern, a spectrum corresponding to the space group R-3m is observed. For measurement conditions, a measurement method, and the like, description below can be referred to.

Furthermore, in the case where the positive electrode in the state before the charge of the secondary battery is also analyzed by the XRD pattern, the crystal structure to be determined is preferably expressed by the space group R-3m.

In the power storage system of one embodiment of the present invention, the crystal structure to be determined is expressed by the space group R-3m when the positive electrode is analyzed by the XRD pattern at the time t2 and before the charge, in which case a decrease in the discharge capacity of the secondary battery due to charge-discharge cycles can be little.

Here, a case is considered where the steps of Step S101 to Step S107 are performed s times. Note that s is an integer of 2 or more. In such a case, the time tp and the time t2 that are obtained on the basis of the extrema detected in Step S102 to Step S106 may be used in the next charge cycle. Specifically, the time tp and the time t2 obtained in a (s−1)th charge may be used as conditions of stopping charge in Step S107 of an s-th charge.

Next, in Step S199, the process ends.

The above description is an example in which the constant current charge is performed continuously in a period from the start of charge in Step S101 to the stop of the charge in Step S107. In this case, the current value in the constant current charge is set to be, for example, a constant current value in the period from the start of charge in Step S101 to the stop of the charge in Step S107. Alternatively, the current value in the constant current charge may be changed stepwisely in the period from the start of charge in Step S101 to the stop of the charge in Step S107. Specifically, for example, in the case where Step S103 to Step S105 are repeated n times, the current value may be changed after a certain number of times.

The charging unit of one embodiment of the present invention can analyze charge characteristics of the secondary battery in Step S103 to Step S106 and change the charge conditions of the secondary battery in Step S107 on the basis of the analysis result. Specifically, the charge of the secondary battery can be stopped, for example. The charge characteristics analyzed in Step S103 to Step S106 vary in accordance with the ambient temperature in charge and discharge of the secondary battery, deterioration of the secondary battery due to charge-discharge cycles, and the like. The charging unit of one embodiment of the present invention can inhibit the deterioration of the secondary battery by changing the charge conditions of the secondary battery, for example, a charge voltage or the like of the secondary battery, in accordance with the variation in charge characteristics.

Furthermore, the charging unit of one embodiment of the present invention enables the secondary battery to be charged to the utmost limit in a range where the deterioration of the secondary battery is inhibited, by analyzing the charge characteristics.

Alternatively, in Step S107, constant voltage charge may be performed after the time t2 at a voltage lower than the upper limit voltage of the constant current charge at the time t2.

### Example 2 of Charging Method

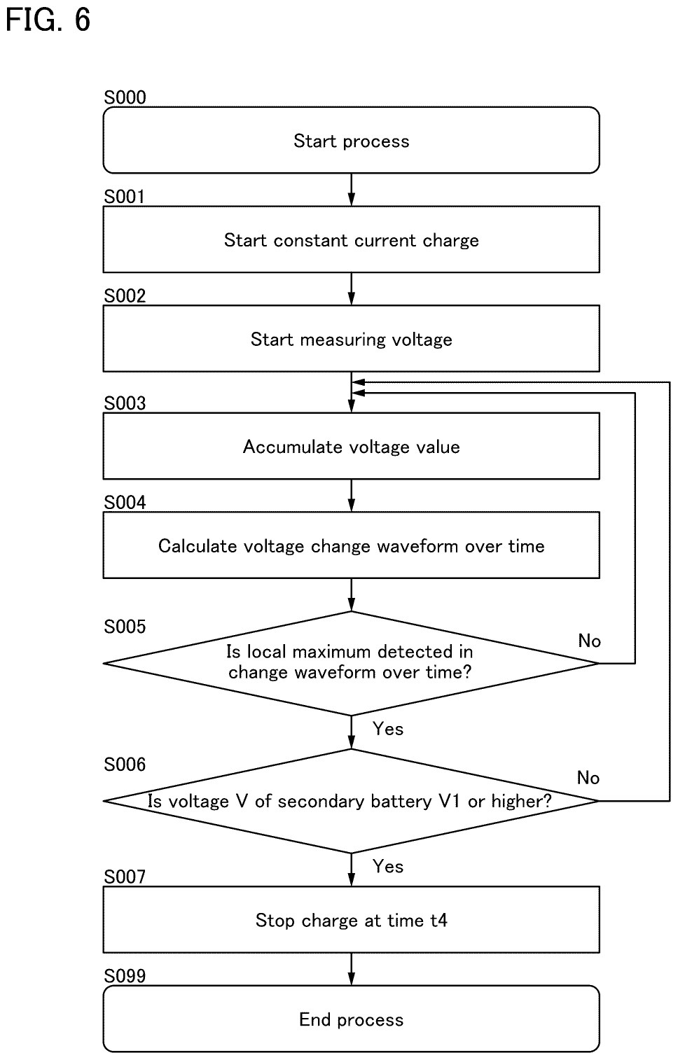

An example of a charging method using the charging unit of one embodiment of the present invention is described with reference to a flowchart of FIG. 6. In the charging method illustrated in FIG. 6, simple calculation by the control circuit 153 in a small circuit scale can be performed, as compared with in the charging method illustrated in FIG. 5, in some cases.

The dQ/dV can be expressed by the following formula.

$$dQ / d V = ( dQ / dt ) \times ( dt / d V )$$

In the constant current charge, dQ/dt is constant; thus, the dQ/dV is proportional to dt/dV. Thus, by evaluating the dt/dV characteristics in the constant current charge, information similar to the dQ/dV characteristics can be obtained.

An example of evaluating the dt/dV characteristics in the region where constant current charge is performed will be described below. In acquisition of the dt/dV characteristics, the current value of the secondary battery is not needed to be acquired every time, and the acquisition of the dt/dV characteristics can be performed more easily than that of dQ/dV in some cases. In addition, only two parameters of voltage and time are to be acquired, and thus calculation is simple and easy and the circuit scale can be reduced in some cases. The quantity of data to be acquired is small; thus, the memory circuit scale can be reduced in some cases.

Furthermore, a change in the dQ/dV in the constant current charge is gentler than a change in the dQ/dV in the constant voltage charge in some cases.

In view of the above, even if the voltage resolution of a circuit that acquires dt/dV characteristics in the constant current charge or the like is 12 bits or lower, for example, in the power storage system of one embodiment of the present invention, adequate evaluation can be performed. In particular, in the secondary battery using the positive electrode active material of one embodiment of the present invention, an extremum can be observed stably in the dQ/dV curve in the constant current charge. Accordingly, charge can be controlled with high accuracy even in a simpler measurement system.

First, the process starts in Step S000.

Next, in Step S001, the constant current charge of the secondary battery is started at the time t3. Note that the constant current charge is continuously performed until the charge is stopped in Step S007.

Next, in Step S002, the voltage measurement circuit 151 starts measurement of a voltage of the secondary battery. The voltage measurement circuit 151 supplies the measured voltage value to the control circuit 153.

Next, in Step S003, the control circuit 153 accumulates, as a set of data with time, the voltage value measured by the voltage measurement circuit 151 after Step S002. In the data accumulation, the memory circuit or the like included in the control circuit 153 can be used. As the time linked to the voltage value, an elapsed time from the start of charge may be used, for example.

The obtained voltage value is converted from an analog value into a digital value in the control circuit 153. Alternatively, the control circuit 153 may use the obtained analog value in calculation without converting it into a digital value. Here is described an example in which an MCU is used as the control circuit 153, and an analog-digital conversion circuit incorporated in the MCU is used to convert the voltage value.

Here, an MCU incorporating an analog-digital conversion circuit having a 12-bit voltage resolution is used as an example.

When a change of a voltage value or an absolute value of the change of the voltage value becomes greater than or equal to a predetermined value, a set of data containing the voltage value and time is acquired and accumulated. The predetermined value can be, for example, the minimum value of the voltage resolution of the analog-digital conversion circuit or may be a value higher than or equal to the minimum value.

In the case where a change of a voltage value or an absolute value of the change of the voltage value is less than the predetermined value, a set of data containing the voltage value and time is acquired and accumulated when a predetermined time has passed since the previous acquisition of the set of data.

Next, in Step S004, the control circuit 153 calculates a voltage change over time of the secondary battery by using the sets of data containing the voltage value and time accumulated at any time. The voltage change over time can be expressed as a voltage [V(t)−V(t−Δt1)] using a voltage V(t) at the time t and a voltage V(t−Δt1) at the time (t−Δt1). The curve of a voltage change over time is referred to as a ΔV−t curve in some cases. In addition, for example, it is acceptable to use a derivative of voltage with respect to time (dV/dt) as the voltage change over time. Note that the calculation of the change over time is performed after the time t satisfies t=Δt1. Here, in Step S003, calculation of the change over time may be performed after the sets of data containing a voltage value and time are accumulated for a predetermined time. For example, the sets of data may be accumulated in a period that is sufficient for detection of an extremum.

Next, in Step S005, the control circuit 153 analyzes a curve of a voltage change over time of the secondary battery (e.g., ΔV−t curve) and performs determination whether the extremum is detected. When the extremum, for example, the local minimum (a peak with a downward projection) in this case, is detected in the curve of a change over time, the process proceeds to Step S006. When it is not detected, the process returns to Step S003. Note that a plurality of extrema may be detected in the ΔV−t curve. In such a case, the highest extremum of the plurality of extrema is detected. Alternatively, r (r is an integer of 2 or more) higher extrema of the plurality of extrema are detected and any of the r values may be selected.

The control circuit 153 preferably continue to accumulate the sets of data containing the voltage value, the current value, and time, while the steps from Step S003 to Step S005 are repeated. In other words, when the steps from Step S003 to Step S005 are repeated n times, the curve of a change over time can be calculated with use of all the pieces of data of n repetitions. Alternatively, only data of the latest time or data of the latest several times of the n times may be used. Here, n is an integer of 1 or more.

Next, in Step S006, the control circuit 153 performs determination whether the voltage of the secondary battery is higher than or equal to a predetermined voltage. If the voltage V of the secondary battery is higher than or equal to the voltage V1, the process proceeds to Step S007. When V is lower than the voltage V1, the process returns to Step S003. Here, the voltage V1 is, for example, higher than or equal to 4.25 V, or higher than or equal to 4.25 V and less than 4.8 V. Here, when the voltage measurement circuit 151 measures voltages obtained by dividing the voltage between the positive electrode and the negative electrode of the secondary battery with resistors, an estimated value of the voltage between the positive electrode and the negative electrode of the secondary battery, which is estimated from the voltages obtained by resistor division, is preferably used as the voltage V1.

Alternatively, determination of the magnitude of the voltage V and the voltage V1 in Step S006 may be performed on the basis of the charge depth of the secondary battery. For example, if the charge depth of the secondary battery is greater than or equal to S1%, the process proceeds to Step S007, and if it is less than S1%, the process returns to Step S003. Here, S1 is higher than or equal to 60 [%], or higher than or equal to 60 [%] and lower than or equal to 95 [%].

The control circuit 153 can accumulate the set of data containing the voltage value and time continually, until the process proceeds to Step S007 from the initial Step S003 of the repeated Steps S003.

Next, in Step S007, a time tq showing an extremum is detected by analysis in the ΔV−t curve, and charge is stopped at time t4, at which a predetermined time is elapsed from the time tq. Alternatively, the time t4 may be set in the following manner: in the ΔV−t curve, a region having a desired time width with the time showing the extremum as a center is determined and a time corresponding to the time at the top edge in the region is set as the time t4, for example. Here, the predetermined time is the time required for stopping of the charge by the control circuit 153. When the extremum is not detected in Step S007, the charge may be stopped when the charge voltage reaches a predetermined charge voltage.

Furthermore, as the conditions of stopping the charge in Step S007, the detection of the extremum is given here; alternatively, an inflection point is detected and stopping the charge may be controlled on the basis of an elapsed time or the like from the detected inflection point, for example.

Here, a case is considered where the steps from Step S001 to Step S007 are repeated w times. Note that w is an integer of 2 or more. In such a case, the time tq and the time t4 that are obtained on the basis of the extrema detected in Step S002 to Step S006 may be used in the next charge cycle. Specifically, the time tq and the time t4 obtained in a (w−1)th charge may be used as conditions of stopping charge in Step S007 of a w-th charge.

In Step S099, the process ends.

The above description is an example in which the constant current charge is performed continuously in a period from the start of charge in Step S001 to the stop of the charge is stopped in Step S007. In this case, the current value in the constant current charge is set to, for example, a constant current value in the period from the start of charge in Step S001 to the stop of the charge in Step S007. Alternatively, the current value in the constant current charge may be changed stepwisely in the period from the start of charge in Step S001 to the stop of the charge in Step S007. Specifically, for example, in the case where Step S003 to Step S005 are repeated n times, the current value may be changed after a certain number of times.

### Example 3 of Charging Method

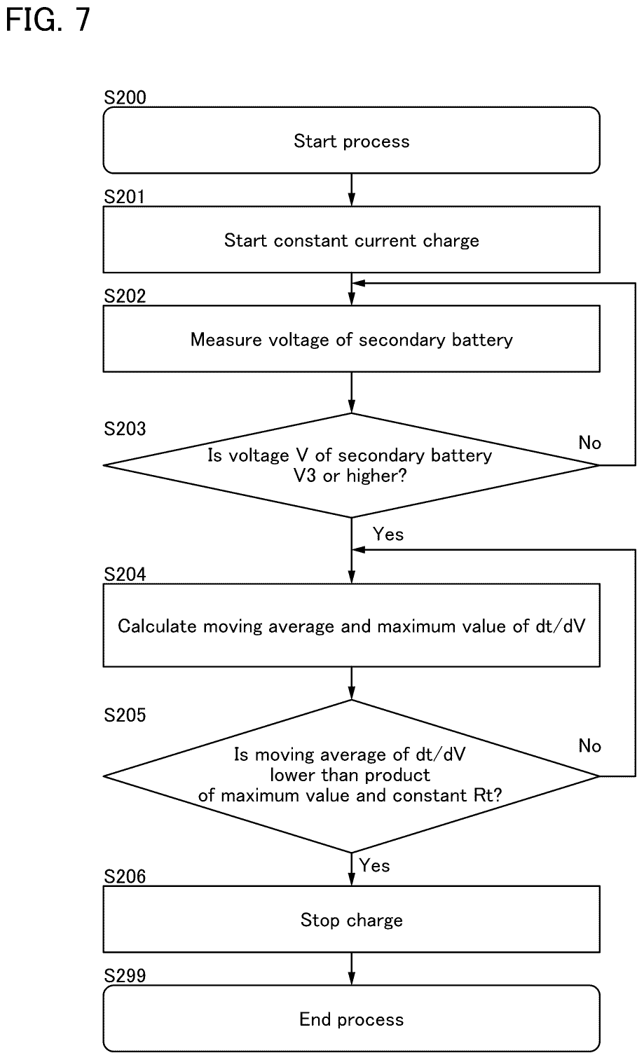

An example of a charging method using the charging unit of one embodiment of the present invention is described with reference to a flowchart of FIG. 7.

First, the process starts in Step S200.

Next, in Step S201, the constant current charge of the secondary battery is started. Note that the constant current charge is continuously performed until the charge is stopped in Step S206.

Next, in Step S202, the voltage measurement circuit 151 starts measurement of a voltage of the secondary battery. The measured voltage V is supplied from the voltage measurement circuit 151 to the control circuit 153.

Next, in Step S203, the control circuit 153 compares the measured voltage V and the predetermined voltage V3. If the voltage V is higher than or equal to the voltage V3, the process proceeds to Step S204, or when the voltage V is lower than the voltage V3, the process returns to Step S202.

In Step S204, the control circuit 153 conducts evaluation of dQ/dV. Here, since charge current is constant, a value dt/dV is measured. The value of dt/dV can be accumulated at any time in a charge process. With use of the accumulated sets of data containing the voltage V and the time t, the moving average of dt/dV, [dt/dV] mean, and the maximum value of dt/dV, [dt/dV] max, are calculated.

Note that as a value corresponding to the dt/dV, for example, a time required for a change of a voltage by a predetermined value may be calculated. The predetermined value may be, for example, greater than or equal to 0.5 mV and less than or equal to 10 mV.

Next, in Step S205, the moving average [dt/dV] mean is compared with a value obtained by multiplying the maximum value [dt/dV] max by a constant Rt. When the moving average [dt/dV] mean is less than the value obtained by multiplying the maximum value [dt/dV] max by the constant Rt, the process proceeds to Step S206. When the moving average [dt/dV] mean is greater than or equal to the value obtained by multiplying the maximum value [dt/dV] max by the constant Rt, the process returns to Step S204.

The time at which the moving average [dt/dV] mean is less than the value obtained by multiplying the maximum value [dt/dV] max by the constant Rt corresponds to, for example, a time at which dt/dV decreases from the local maximum value in the vicinity of the voltage V3 to (Rt×100) [%] of the local maximum value in the dt/dV curve.

In Step S206, the charge of the secondary battery is stopped.

In Step S299, the process ends.

The example of the constant current charge is illustrated in the flowchart of FIG. 7. However, in the case where the charge current is not constant, for example, the average value in the measurement time of the quantity of electricity Q and the time in the vicinity thereof may be compared with a value obtained by multiplying the maximum value of the quantity of electricity Q by a constant, instead of the comparison between the moving average of dt/dV, [dt/dV] mean and the value obtained by multiplying the maximum value [dt/dV] max by the constant Rt.

### Example 1 of Voltage Measuring Circuit

A voltage measuring circuit 151A is described as an example of the voltage measuring circuit 151 included in the charging unit 201.

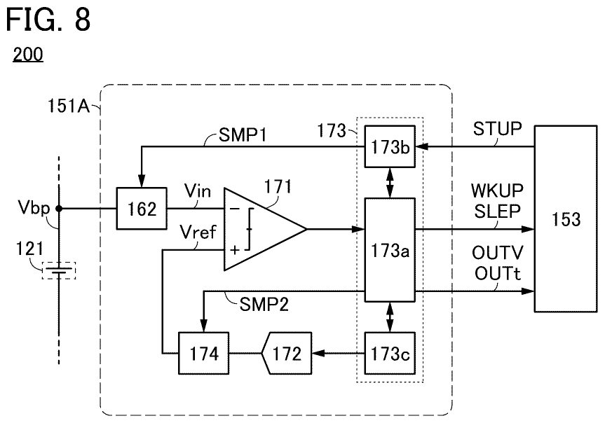

{Structure example}FIG. 8 is a block diagram illustrating a structure example of the voltage measuring circuit 151A.

As illustrated in FIG. 8, the voltage measuring circuit 151A includes a sample-and-hold circuit (S/H) 162, an S/H 174, a digital-analog converter circuit (DAC) 172, a comparator 171, and a control portion 173. The control portion 173 includes a signal processing circuit 173a, a timing circuit 173b, and a register 173c. FIG. 8 illustrates the secondary battery 121 and the control circuit 153 that are electrically connected to the voltage measuring circuit 151A in the power storage system 200.

Note that in the following description of the voltage measuring circuit 151A, a voltage refers to a voltage with reference to the potential of the negative electrode of the secondary battery 121 unless otherwise specified.

The voltage measuring circuit 151A has a function of a successive approximation analog-digital converter circuit (ADC). The voltage measuring circuit 151A has a function of calculating the time required for the input voltage to change by a predetermined voltage value (e.g., 1 mV) (also referred to as a difference time or a time difference) and outputting the time. Thus, the voltage measuring circuit 151A may be referred to as a subtractor, a time measuring circuit, or the like, for example.

The S/H 162 has a function of obtaining (sampling) and holding a voltage Vbp of the positive electrode of the secondary battery 121 in response to a signal SMP1. Furthermore, the S/H 162 has a function of supplying a held voltage Vin to an inverting input terminal of the comparator 171.

The S/H 174 has a function of obtaining and retaining a voltage output from the DAC 172 in accordance with a signal SMP2. Furthermore, the S/H 174 has a function of supplying a held voltage Vref to the non-inverting input terminal of the comparator 171.

The DAC 172 has a function of outputting an analog voltage on the basis of digital voltage data stored in the register 173c.

The comparator 171 has a function of comparing the magnitudes of the voltage Vin and the voltage Vref and outputting a voltage (H level) corresponding to digital data “1” or a voltage (L level) corresponding to digital data “0” on the basis of the comparison result.

The signal processing circuit 173a has a function of performing various kinds of processing in accordance with the output of the comparator 171, a signal from the timing circuit 173b, and the like, for example. As for various kinds of processing, the signal processing circuit 173a has a function of updating the voltage data stored in the register 173c, for example. The signal processing circuit 173a has a function of outputting, to the control circuit 153, voltage data (data OUTV) stored in the register 173c and time data (data OUTt) from the timing circuit 173b, for example. The signal processing circuit 173a has a function of outputting the signal SMP2 for controlling the operation of the S/H 174, for example. The signal processing circuit 173a has a function of outputting a signal WKUP and a signal SLEP for transmitting the operation state of the voltage measuring circuit 151A to the control circuit 153, for example.

The timing circuit 173b has a function of performing various kinds of processing in accordance with a signal from the signal processing circuit 173a, a signal STUP supplied from the control circuit 153, and the like, for example. As various kinds of processing, the timing circuit 173b has a function of outputting the signal SMP1 for controlling the operation of the S/H 162, for example. The timing circuit 173b has a function of measuring time, for example. For the measurement of time in the timing circuit 173b, a counter (not illustrated), an oscillator (not illustrated), or the like can be used, for example. The count value of the counter can be time data, for example.

The register 173c has a function of storing voltage data.

Each of the circuits included in the voltage measuring circuit 151A (e.g., the S/H 162, the S/H 174, the DAC 172, the comparator 171, the signal processing circuit 173a, the timing circuit 173b, and the register 173c) includes a transistor containing silicon in its channel formation region (a Si transistor) or a circuit including a Si transistor. That is, the voltage measuring circuit 151A can be regarded as a semiconductor device. Some or all of the circuits may include a transistor containing an oxide semiconductor in its channel formation region (an OS transistor) or a circuit including an OS transistor.

An OS transistor has a feature in that the off-state current (current flowing between a source and a drain when the transistor is in an off state) is extremely low because the band gap of an oxide semiconductor where a channel is formed is greater than or equal to 2 eV. The off-state current value per micrometer of channel width of the OS transistor at room temperature can be lower than or equal to 1 aA (1×10⁻¹⁸ A), lower than or equal to 1 zA (1×10⁻²¹ A), or lower than or equal to 1 yA (1×10⁻²⁴ A). Note that the off-state current value per micrometer of channel width of a Si transistor at room temperature is higher than or equal to 1 fA (1×10⁻¹⁵ A) and lower than or equal to 1 pA (1×10⁻¹² A). In other words, the off-state current of an OS transistor is lower than that of a Si transistor by approximately ten orders of magnitude.

The off-state current of an OS transistor hardly increases even in a high-temperature environment. Specifically, the off-state current hardly increases even at an environment temperature higher than or equal to room temperature and lower than or equal to 200° C. Furthermore, the on-state current of an OS transistor is unlikely to decrease even in a high-temperature environment. Meanwhile, the on-state current of a Si transistor decreases in a high-temperature environment. That is, an OS transistor has a higher on-state current than a Si transistor in a high-temperature environment. In an OS transistor, the ratio between on-state current and off-state current is large even at an environmental temperature higher than or equal to 125° C. and lower than or equal to 150° C.; thus, a favorable switching operation can be performed. Therefore, the semiconductor device including an OS transistor can operate stably and have high reliability even in a high-temperature environment.

The semiconductor layer of an OS transistor preferably contains at least one of indium and zinc. The semiconductor layer of an OS transistor preferably contains indium, M (M is one or more kinds selected from gallium, aluminum, yttrium, tin, silicon, boron, copper, vanadium, beryllium, titanium, iron, nickel, germanium, zirconium, molybdenum, lanthanum, cerium, neodymium, hafnium, tantalum, tungsten, magnesium, and cobalt), and zinc, for example. In particular, the M is preferably one or more kinds selected from gallium, aluminum, yttrium, and tin.

It is particularly preferable to use an oxide containing indium (In), gallium (Ga), and zinc (Zn) (also referred to as “IGZO”) for the semiconductor layer. Alternatively, an oxide containing indium (In), aluminum (Al), and zinc (Zn) (also referred to as “IAZO”) may be used for the semiconductor layer. Further alternatively, an oxide containing indium (In), aluminum (Al), gallium (Ga), and zinc (Zn) (also referred to as “IAGZO”) may be used for the semiconductor layer.

When the semiconductor layer is In-M-Zn oxide, the atomic ratio of In is preferably greater than or equal to the atomic ratio of M in the In-M-Zn oxide. Examples of the atomic ratio of the metal elements in such In-M-Zn oxide include In:M:Zn=1:1:1 or a composition in the neighborhood thereof, In:M:Zn=1:1:1.2 or a composition in the neighborhood thereof, In:M:Zn=2:1:3 or a composition in the neighborhood thereof, In:M:Zn=3:1:2 or a composition in the neighborhood thereof, In:M:Zn=4:2:3 or a composition in the neighborhood thereof, In:M:Zn=4:2:4.1 or a composition in the neighborhood thereof, In:M:Zn=5:1:3 or a composition in the neighborhood thereof, In:M:Zn=5:1:6 or a composition in the neighborhood thereof, In:M:Zn=5:1:7 or a composition in the neighborhood thereof, In:M:Zn=5:1:8 or a composition in the neighborhood thereof, In:M:Zn=6:1:6 or a composition in the neighborhood thereof, and In:M:Zn=5:2:5 or a composition in the neighborhood thereof. The atomic ratio of In may be smaller than the atomic ratio of M in the In-M-Zn oxide. Examples of the atomic ratio of the metal elements in such In-M-Zn oxide include In:M:Zn=1:3:2 or a composition in the neighborhood thereof or In:M:Zn=1:3:4 or a composition in the neighborhood thereof. Note that a composition in the neighborhood includes the range of ±30% of an intended atomic ratio.

For example, in a memory circuit (or a memory device) including an OS transistor and a capacitor, the off-state current of the OS transistor is extremely low; thus, electric charge accumulated in the capacitor can be held for a long time. Thus, in the memory circuit, when a potential level corresponding to the amount of electric charge held in the capacitor corresponds to digital data “1” or “0”, the data can be retained for a long time. Thus, a nonvolatile memory can be formed, for example.

In some or all of the circuits included in the voltage measuring circuit 151A, an OS transistor or a memory circuit including an OS transistor can be provided. For example, with use of an OS transistor as a transistor included in the S/H 174, the voltage Vref held in the S/H 174 can be maintained for a long time even when power supply to the DAC 172 is stopped. For example, when a memory circuit including an OS transistor is provided in the register 173c, the voltage data stored in the register 173c can be retained for a long time even when power supply to the register 173c is stopped.

The voltage measuring circuit 151A can be in a sleep mode until the input voltage changes by a predetermined voltage value, in other words, while a change in the input voltage is smaller than the predetermined voltage value. In the sleep mode, for example, power supply to the DAC 172 and the register 173c can be stopped. Part of the operation of the signal processing circuit 173a may be stopped by, for example, power gating, clock gating, or the like. When the voltage measuring circuit 151A transitions to the sleep mode, the signal processing circuit 173a can output the signal SLEP.

The voltage measuring circuit 151A can maintain the voltage Vref held in the S/H 174 and retain the voltage data stored in the register 173c even in the sleep mode. Thus, also in the sleep mode, the voltage Vbp can be obtained by the S/H 162 and the voltage Vin and the voltage Vref can be compared by the comparator 171.

In the case where the input voltage changes only by a predetermined voltage value in the sleep mode, the output of the comparator 171 changes and thus the voltage measuring circuit 151A can wake up from the sleep mode. When the voltage measuring circuit 151A wakes up, power supply to the DAC 172 and the register 173c can be restarted, for example. In addition, the operation of the signal processing circuit 173a can be restarted. At the time of wake-up, the signal processing circuit 173a can output the signal WKUP.

Note that for example, an OS transistor or a memory circuit including an OS transistor may be provided in part of the control circuit 153. For another example, in the control circuit 153, part of the operation may be stopped by power gating, clock gating, or the like when the signal SLEP is supplied, and the operation may be restarted when the signal WKUP is supplied.

### Operation Example

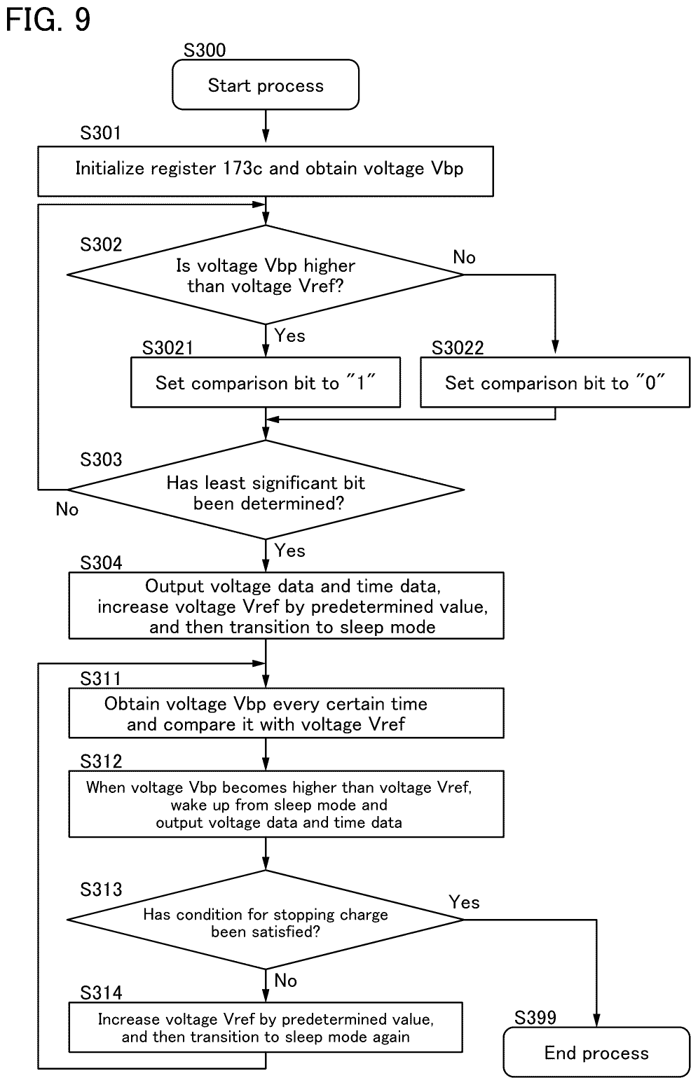

FIG. 9 is a flowchart showing an operation example of the voltage measuring circuit 151A.

First, in Step S300, the signal STUP is supplied from the control circuit 153, whereby a process starts. Note that the secondary battery 121 is assumed to be charged with a constant current.

Next, in Step S301 to Step S303, an analog input voltage is converted into digital voltage data to be stored in the register 173c. In Step S301 to Step S303, “1” or “0” is determined while successive approximation is performed bit by bit from the most significant bit to the least significant bit.

In Step S301, the register 173c is initialized. That is, only the most significant bit of the register 173c is set to “1”, and the others are all set to “0”. For example, in the case where the register 173c has 16-bit data, the data of the register 173c becomes “1000000000000000”. Data of the register 173c is converted into an analog voltage by the DAC 172, and the voltage is held as the voltage Vref by the S/H 174. In addition, the voltage Vbp of the positive electrode of the secondary battery 121 is obtained by the S/H 162 and held as the voltage Vin. After Step S301, the process proceeds to Step S302.

In Step S302, whether the voltage Vbp (the voltage Vin obtained and held by the S/H 162 in Step S301) is higher than the voltage Vref is determined. That is, in the case where the voltage Vin is higher than the voltage Vref, the comparison bit is determined to be “1” in Step S3021. Alternatively, in the case where the voltage Vin is lower than or equal to the voltage Vref, the comparison bit is determined to be “0” in Step S3022. After Step S3021 or Step S3022, the process proceeds to Step S303.

In Step S303, it is determined whether the data of the register 173c down to the least significant bit has been determined. In the case where determination does not reach the least significant bit, the bit immediately below the lowest bit that has been currently determined of the register 173c is set to “1” and the process returns to Step S302. Alternatively, in the case where the data of the register 173c down to the least significant bit has been determined, the process proceeds to Step S304. For example, in the case where the register 173c has 16-bit data, bits down to the least significant bit can be determined by repeating Step S302 to Step S303 16 times.

Next, in Step S304, the voltage data of the register 173c and the time data of the timing circuit 173b (the count value of the counter) are output and the voltage measuring circuit 151A transitions to the sleep mode. At this time, the signal SLEP is output. Here, before the transition to the sleep mode, the data of the register 173c is updated to data that is higher by a predetermined data value (e.g., a data value corresponding to 1 mV). This increases the voltage output from the DAC 172 by a predetermined voltage value (e.g., 1 mV), and the voltage is held in the S/H 174. That is, the voltage Vref held in the S/H 174 is increased by a predetermined voltage value, and then the voltage measuring circuit 151A transitions to the sleep mode. After Step S304, the process proceeds to Step S311.

Next, in Step S311 to Step S314, the time required for the input voltage to change by a predetermined voltage value is calculated and the time is output.

In Step S311, the voltage Vbp is obtained by the S/H 162 every certain time (e.g., 100 ms) and held as the voltage Vin. The comparator 171 compares the voltage Vin with the voltage Vref. After Step S311, the process proceeds to Step S312.

In Step S312, the voltage Vbp (the voltage Vin obtained and held by the S/H 162 in Step S311) becomes higher than the voltage Vref, so that the output of the comparator 171 changes (e.g., from the H level to the L level). Thus, the voltage measuring circuit 151A wakes up from the sleep mode. At this time, the signal WKUP is output. After the wake-up from the sleep mode, voltage data of the register 173c and time data of the timing circuit 173b are output. After Step S312, the process proceeds to Step S313.

Note that in Step S312, as the time data, a difference between the count value of the counter at the time of the previous output and the count value of the counter at the time of the present output may be calculated to output the data of the difference time. That is, the data of the difference time is data of the time required for the input voltage to change by a predetermined voltage value.

In Step S313, whether a condition for stopping charge has been satisfied is determined. As the condition for stopping charge, for example, the conditions described above in Example 1 of charging method to Example 3 of charging method can be used as appropriate. In the case where the condition for stopping charge has been satisfied, the process ends in Step S399. Alternatively, in the case where the condition for stopping charge has not been satisfied, the process proceeds to Step S314.

Note that in Step S399, in the power storage system 200, a signal for transmitting satisfaction of the condition for stopping charge is preferably transmitted to the control circuit 153 so that the constant current charge of the secondary battery 121 by the charging unit 201 is stopped.

In Step S314, the data of the register 173c is updated to data that is higher by a predetermined data value. This increases the voltage output from the DAC 172 by a predetermined voltage value, and the voltage is held in the S/H 174. That is, the voltage Vref held in the S/H 174 is increased by a predetermined voltage value. After that, the signal SLEP is output and the voltage measuring circuit 151A transitions to the sleep mode again. After Step S314, the process returns to Step S311.

As described above, the voltage measuring circuit 151A can calculate the time required for the voltage Vbp of the secondary battery 121 to change by a predetermined voltage value (e.g., 1 mV) and output the time. The voltage measuring circuit 151A can be in the sleep mode until the voltage Vbp changes by a predetermined voltage value, in other words, while a change in the voltage Vbp is smaller than the predetermined voltage value. When the voltage measuring circuit 151A is in the sleep mode, power supply to the DAC 172 and the register 173c can be stopped and part of the operation of the signal processing circuit 173a can be stopped, for example. Thus, the power consumption of the voltage measuring circuit 151A can be reduced.

Note that in the above description, for example, the time required for the voltage Vbp to increase by a predetermined voltage value at the time of charge of the secondary battery 121 can be calculated. In contrast, for example, the time required for the voltage Vbp to decrease by a predetermined voltage value at the time of discharge of the secondary battery 121 may be calculated. In that case, for example, in Step S304 and Step S314, data of the register 173c is updated to data that is lower by a predetermined data value. That is, the voltage Vref held in the S/H 174 is reduced by a predetermined voltage value.

The charging unit that can be used for the power storage system of one embodiment of the present invention includes the voltage measuring circuit 151A, whereby power consumption can be reduced.

### Example 2 of Voltage Measuring Circuit

A voltage measuring circuit 151B is described as another example of the voltage measuring circuit 151 included in the charging unit 201. The voltage measuring circuit 151B is a modification example of the above-described voltage measuring circuit 151A. Therefore, points of the voltage measuring circuit 151B which are different from the voltage measuring circuit 151A are mainly described to reduce repeated description. Note that the above description of the voltage measuring circuit 151A can be referred to as appropriate.

### Structure Example

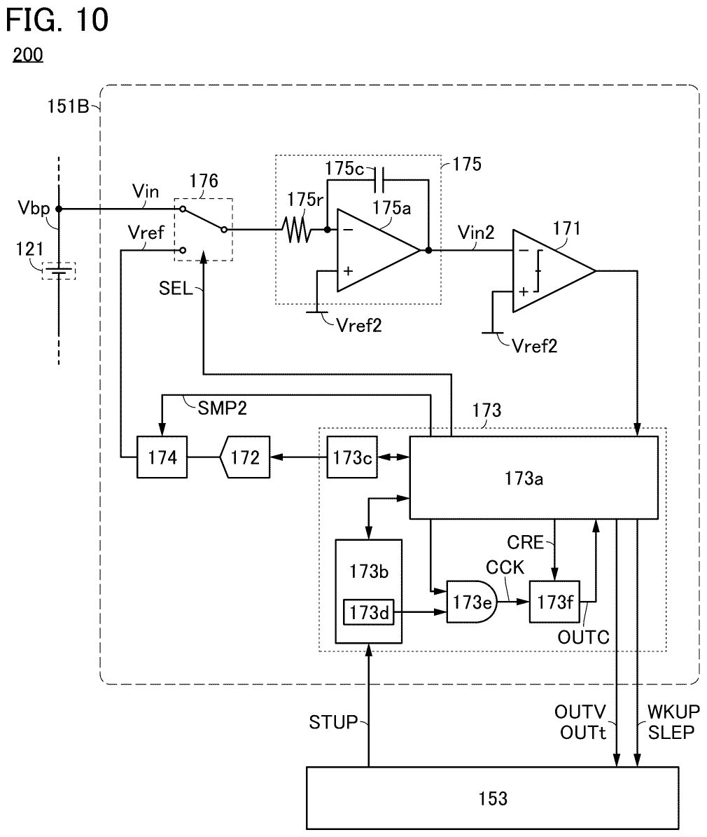

FIG. 10 is a block diagram illustrating a structure example of the voltage measuring circuit 151B.

As illustrated in FIG. 10, the voltage measuring circuit 151B includes an integrator circuit 175 and a selection circuit 176 in addition to the above-described components of the voltage measuring circuit 151A. The voltage measuring circuit 151B is different from the voltage measuring circuit 151A in that the S/H 162 is not necessarily included. The voltage measuring circuit 151B includes, in the control portion 173, an oscillator 173d in the timing circuit 173b, an AND circuit 173e, and a counter 173f in addition to the above-described components of the voltage measuring circuit 151A.

The voltage measuring circuit 151B has a function of a double integrating type analog-digital converter circuit (ADC). The voltage measuring circuit 151B has a function of calculating the time required for the input voltage to change by a predetermined voltage value (e.g., 1 mV) (also referred to as a difference time or a time difference) and outputting the time. Thus, the voltage measuring circuit 151B may be referred to as a subtractor, a time measuring circuit, or the like, for example.

The selection circuit 176 has a function of supplying any one of the voltage Vin (the voltage Vbp) and the voltage Vref to an input terminal of the integrator circuit 175 in accordance with the signal SEL.

The integrator circuit 175 has a function of integrating a voltage supplied to the input terminal (any one of the voltage Vin and the voltage Vref) and supplying an integrated voltage Vin2 to an output terminal.

The integrator circuit 175 includes an operational amplifier 175a, a resistor 175r, and a capacitor 175c. In the integrator circuit 175, an inverting input terminal of the operational amplifier 175a is electrically connected to one terminal of the resistor 175r and one terminal of the capacitor 175c. A non-inverting input terminal of the operational amplifier 175a is electrically connected to a wiring to which a voltage Vref2 is supplied. An output terminal of the operational amplifier 175a is electrically connected to the other terminal of the capacitor 175c and the output terminal of the integrator circuit 175. The other terminal of the resistor 175r is electrically connected to the input terminal of the integrator circuit 175. Note that in the integrator circuit 175, a switch (not illustrated) having a function of establishing or breaking electrical continuity between one terminal and the other terminal of the capacitor 175c is preferably provided.

The output terminal of the integrator circuit 175 is electrically connected to the inverting input terminal of the comparator 171. That is, the voltage Vin2 supplied to the output terminal of the integrator circuit 175 is supplied to the inverting input terminal of the comparator.

The comparator 171 has a function of comparing the magnitude of the voltage Vin2 supplied to the inverting input terminal and the voltage Vref2 supplied to the non-inverting input terminal and outputting the H level or the L level in accordance with the comparison result.

The oscillator 173d has a function of outputting a clock pulse.

The AND circuit 173e has a function of calculating a logical product of a clock pulse supplied from the oscillator 173d and a signal supplied from the signal processing circuit 173a and outputting a signal CCK.

The counter 173f has a function of counting the number of clock pulses supplied as the signal CCK. The counter 173f has a function of resetting the count value in accordance with a signal CRE. The counter 173f has a function of outputting a count value (data OUTC).

The signal processing circuit 173a has a function of outputting the signal SEL for controlling the operation of the selection circuit 176, for example. The signal processing circuit 173a has a function of controlling whether a clock pulse output from the oscillator 173d is supplied to the counter 173f or not with the use of the AND circuit 173e, for example. The signal processing circuit 173a has a function of outputting the signal CRE for controlling the operation of the counter 173f, for example. The signal processing circuit 173a has a function of outputting, to the control circuit 153, voltage data (data OUTV) based on the data OUTC output from the counter 173f, for example.

The register 173c may have a function of storing the data OUTC output from the counter 173f. In the register 173c, a memory circuit (not illustrated) may be provided to store the data OUTC, for example.

As in the above-described voltage measuring circuit 151A, in some or all of the circuits included in the voltage measuring circuit 151B, an OS transistor or a memory circuit including an OS transistor can be provided.

Like the above-described voltage measuring circuit 151A, the voltage measuring circuit 151B can be in the sleep mode until the input voltage changes by a predetermined voltage value, in other words, while a change in the input voltage is smaller than the predetermined voltage value.

The voltage measuring circuit 151B can perform analog-digital conversion (A/D conversion), which will be described later, also in the sleep mode.

### Operation Example

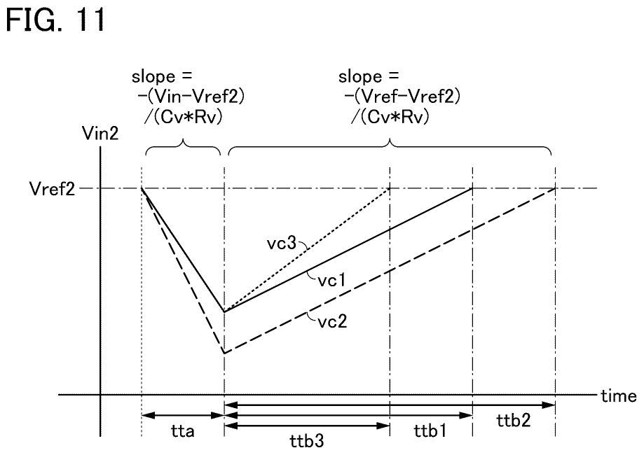

FIG. 11 is a schematic diagram illustrating analog-digital conversion (A/D conversion) in the voltage measuring circuit 151B.

FIG. 11 shows a time-dependent change in voltage Vin2 output from the integrator circuit 175 at the time of A/D conversion. In FIG. 11, the case where the voltage Vin is increased with respect to a solid line (vc1) is denoted by a dashed line (vc2). The case where the voltage Vref is increased with respect to the solid line (vc1) is denoted by a dotted line (vc3).

In the voltage measuring circuit 151B, in order to perform A/D conversion, the voltage Vref and the voltage Vref2 are set to satisfy the voltage Vin>the voltage Vref2>the voltage Vref. In the initial state, the voltage Vin2=the voltage Vref2. In addition, the count value of the counter 173f is reset to 0. The electric resistance value of the resistor 175r is Rv and the electrostatic capacitance value of the capacitor 175c is Cv.

Note that in the description of this operation example, changing the voltage Vin such that the potential difference between the voltage Vin and the voltage Vref2 is large (or small) is referred to as setting the voltage Vin high (or low) in some cases. Changing the voltage Vref such that the potential difference between the voltage Vref and the voltage Vref2 is large (or small) is referred to as setting the voltage Vref high (or low) in some cases.

First, the selection circuit 176 is controlled to input the voltage Vin to the integrator circuit 175. Then, the voltage Vin2 decreases at the slope of “−(voltage Vin−voltage Vref2)/(Cv×Rv)”.

Next, after a certain period (a period tta) elapses, the selection circuit 176 is controlled to input the voltage Vref to the integrator circuit 175. Then, the voltage Vin2 increases at the slope of “−(voltage Vref−voltage Vref2)/(Cv×Rv). At this time, the clock pulse output from the oscillator 173d is controlled so as to be supplied to the counter 173f. Then, the count of the counter 173f starts.

Next, the voltage Vin2 increases to reach the voltage Vref2, so that the output of the comparator 171 changes (e.g., from the H level to the L level). At this time, the count value of the counter 173f is output.

The count value output from the counter 173f is a value counted in the period ttb (a period ttb1, a period ttb2, or a period ttb3) from when the voltage Vref is input to the integrator circuit 175 until the voltage Vin2 reaches the voltage Vref2, and has a positive correlation with the voltage Vin input to the integrator circuit 175.

For example, by setting the voltage Vin higher than that in the case of the solid line (vc1), the slope of the decrease in voltage Vin2 during the period tta becomes steeper as shown by the dashed line (vc2). As a result, the period ttb2>the period ttb1, and the count value of the counter 173f increases. In this manner, the count value of the counter 173f is a value based on the voltage Vin.

Here, for example, when the voltage Vref is set higher than that in the case of the solid line (vc1), the slope of the increase in voltage Vin2 during the period ttb becomes steeper as shown by the dotted line (vc3). As a result, the period ttb3<the period ttb1, and the count value of the counter 173f decreases. With the use of this, the time required for the input voltage Vin to change by a predetermined voltage value can be calculated as described later.

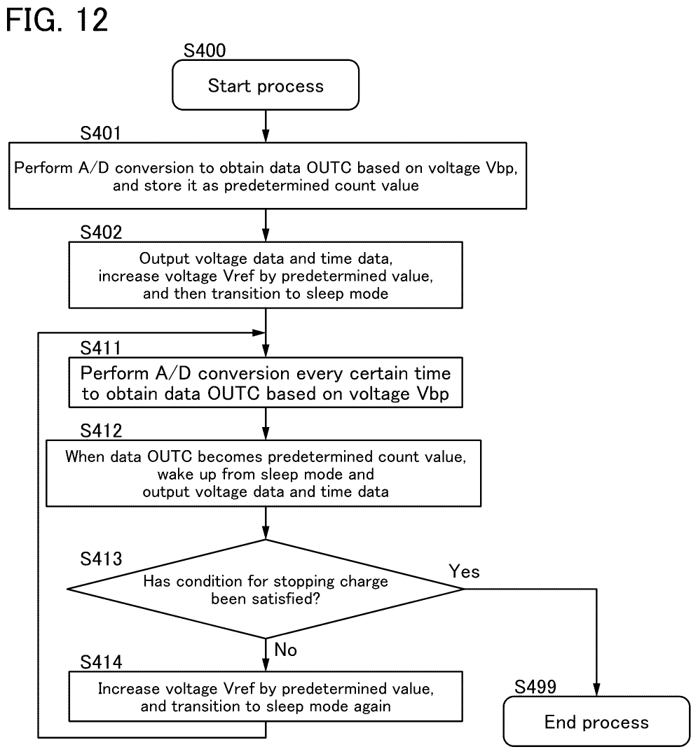

FIG. 12 is a flowchart showing an operation example of the voltage measuring circuit 151B.

First, in Step S400, the signal STUP is supplied from the control circuit 153, whereby a process starts. Note that the secondary battery 121 is assumed to be charged with a constant current.

In the initial state, the voltage Vin2=the voltage Vref2. For example, a switch provided between one terminal and the other terminal of the capacitor 175c is controlled to be in a conduction state.

Next, in Step S401, an analog input voltage is converted into digital voltage data. In Step S401, the above-described A/D conversion is performed to obtain the data OUTC based on the voltage Vbp (voltage Vin). At this time, for example, a switch provided between the one terminal and the other terminal of the capacitor 175c is controlled to be in a non-conduction state. The obtained data OUTC is stored as a predetermined count value. For example, the predetermined count value may be stored in a memory circuit provided in the register 173c for storing the data OUTC. After Step S401, the process proceeds to Step S402.

Next, in Step S402, the voltage data based on the data OUTC and the time data of the timing circuit 173b are output and the voltage measuring circuit 151A transitions to the sleep mode. At this time, the signal SLEP is output. Here, before the transition to the sleep mode, the data of the register 173c is updated to data that is higher by a predetermined data value (e.g., a data value corresponding to 1 mV). This increases the voltage output from the DAC 172 by a predetermined voltage value (e.g., 1 mV), and the voltage is held in the S/H 174. That is, the voltage Vref held in the S/H 174 is increased by a predetermined voltage value, and then the voltage measuring circuit 151A transitions to the sleep mode. After Step S402, the process proceeds to Step S411.

Next, in Step S411 to Step S414, the time required for the input voltage to change by a predetermined voltage value is calculated and the time is output.

In Step S411, the above-described A/D conversion is performed every certain time (e.g., 100 ms), whereby the data OUTC based on the voltage Vbp is obtained. At this time, since the voltage Vref is increased by a predetermined voltage value in the previous step, the data OUTC becomes a value lower than the predetermined count value even when the voltage Vbp has the same value. After Step S411, the process proceeds to Step S412.

In Step S412, the voltage Vbp increases by a predetermined voltage value, so that the data OUTC becomes a predetermined count value. Thus, the voltage measuring circuit 151A wakes up from the sleep mode. At this time, the signal WKUP is output. After the wake-up from the sleep mode, voltage data based on the data OUTC and time data of the timing circuit 173b are output. After Step S412, the process proceeds to Step S413.

Note that in Step S412, like the above-described voltage measuring circuit 151A, data on the difference time between the previous output and the present output may be output as time data. That is, the data of the difference time is data of the time required for the input voltage to change by a predetermined voltage value.

In Step S413, whether a condition for stopping charge has been satisfied is determined. As the condition for stopping charge, for example, the conditions described above in Example 1 of charging method to Example 3 of charging method can be used as appropriate. In the case where the condition for stopping charge has been satisfied, the process ends in Step S499. Alternatively, in the case where the condition for stopping charge has not been satisfied, the process proceeds to Step S414.

In Step S414, the data of the register 173c is updated to data that is higher by a predetermined data value. This increases the voltage output from the DAC 172 by a predetermined voltage value, and the voltage is held in the S/H 174. That is, the voltage Vref held in the S/H 174 is increased by a predetermined voltage value. After that, the signal SLEP is output and the voltage measuring circuit 151A transitions to the sleep mode again. After Step S414, the process returns to Step S411.

As described above, the voltage measuring circuit 151B can calculate the time required for the voltage Vbp of the secondary battery 121 to change by a predetermined voltage value (e.g., 1 mV) and output the time. The voltage measuring circuit 151B can be in the sleep mode until the voltage Vbp changes by a predetermined voltage value, in other words, while a change in the voltage Vbp is smaller than the predetermined voltage value. When the voltage measuring circuit 151B is in the sleep mode, power supply to the DAC 172 and the register 173c can be stopped and part of the operation of the signal processing circuit 173a can be stopped, for example. Thus, the power consumption of the voltage measuring circuit 151B can be reduced.

Note that in the above description, for example, the time required for the voltage Vbp to increase by a predetermined voltage value at the time of charge of the secondary battery 121 can be calculated. In contrast, for example, the time required for the voltage Vbp to decrease by a predetermined voltage value at the time of discharge of the secondary battery 121 may be calculated. In that case, for example, in Step S402 and Step S414, data of the register 173c is updated to data that is lower by a predetermined data value. That is, the voltage Vref held in the S/H 174 is reduced by a predetermined voltage value.

The charging unit that can be used for the power storage system of one embodiment of the present invention includes the voltage measuring circuit 151B, whereby power consumption can be reduced.

### <Estimation of SOH>

The charging unit of one embodiment of the present invention preferably has a function of estimating SOH (State Of Health) of a secondary battery. SOH is an index to express a full chargeable capacity at a certain point in time with reference to a full chargeable capacity of a new product. SOH is a numerical value that becomes less than 100 as a secondary battery deteriorates, when the full chargeable capacity of a new secondary battery is 100, and the unit is “%”.

As for the extremum of the dQ/dV-V curve analyzed in the above example, the intensity (e.g., the height of a peak with an upward projection) of the extremum may decrease in some cases. The intensity may decrease because a phase change corresponding to the extremum is unlikely to occur in the positive electrode active material, and the decrease of the intensity may have a correlation with SOH, for example.

The charging unit of one embodiment of the present invention preferably has a function of observing the intensity of the extremum included in the dQ/dV-V curve and estimating SOH.

As for the extremum of the dQ/dV-V curve analyzed in the above example, the voltage serving as the extremum may sometimes have a correlation with a fully-discharged capacity (a dischargeable capacity of a secondary battery) after the charge is performed. The charging unit of one embodiment of the present invention preferably has a function of observing the intensity of the extremum included in the dQ/dV-V curve and estimating the dischargeable capacity of the secondary battery.

<Charge Control with Temperature>

The charging unit 201 preferably controls charge with use of temperature.

The control circuit 153 preferably changes charge conditions in accordance with the ambient temperature of the secondary battery measured by the temperature sensor TS.

The memory circuit included in the control circuit 153 preferably has a table in which the ambient temperature and charge conditions of the secondary battery are linked, for example.

In the memory circuit included in the control circuit 153, charge characteristics linked to the ambient temperature of the secondary battery are preferably stored. The charge characteristics may be a past measured value of the secondary battery 121, a measured value of another secondary battery with similar characteristics, or a waveform obtained by calculation. In the flowcharts of FIG. 5 and FIG. 6, the extremum (peak) may be estimated by using such measurement values. Machine learning or the like can be used for the estimation, for example.

The control circuit 153 may use the charge characteristics of the secondary battery, which are stored in the memory circuit, for the analysis of the extrema in the differential curves of voltage and quantity of electricity. Here, for example, a capacity-voltage curve, a voltage-dQ/dV curve, a ΔV−t curve, impedance characteristics, or the like can be used as the charge characteristics.

As the temperature sensor TS, a temperature measuring resistor (e.g., platinum, nickel, or copper), a thermistor (a PTC (Positive Temperature Coefficient) thermistor or an NTC (Negative Temperature Coefficient) thermistor), a thermocouple, an IC temperature sensor, or the like can be used, for example. Alternatively, the temperature sensor TS may have a structure using a semiconductor temperature sensor (e.g., a silicon diode temperature sensor) or a structure using a bandgap circuit, for example.

The NTC thermistor (NTC element) has a property that its resistance value decreases gradually with respect to an increase in temperature. Thus, the NTC thermistor can be used for minute temperature detection, simple inrush current suppression, or the like, for example. A PTC thermistor (PTC element) has a property in that its resistance value increases rapidly when the temperature exceeds a certain temperature. Thus, the PTC thermistor can be used for, for example, overheat detection, overcurrent protection, inrush current suppression, or the like.

### Example 2 of Power Storage System

FIG. 1B illustrates an example in which the charging unit 201 includes the detection circuit 185 having a function of detecting overcharge and overdischarge, the detection circuit 186 having a function of detecting charge overcurrent or discharge overcurrent, the short-circuit detection circuit SD, the micro-short-circuit detection circuit MSD, the transistor 140, and the transistor 150 in addition to the structure illustrated in FIG. 1A.

The charging unit 201 in FIG. 1B has a function of inhibiting overcharge, overdischarge, charge overcurrent, discharge overcurrent, a short circuit, a micro-short circuit, and the like and can function as a protection circuit of the secondary battery. A micro-short circuit here refers to a minute short circuit caused in a secondary battery. A micro-short circuit refers to not a state where the positive electrode and the negative electrode of a secondary battery are short-circuited so that charge and discharge are impossible, but a phenomenon in which a slight short-circuit current flows through a minute short-circuit portion. A large voltage change may occur in a relatively short time and a small area in some cases.

Transistors called power MOSFETs can be used as the transistor 140 and the transistor 150, for example.

The control circuit 153 has a function of blocking current flowing to the secondary battery 121 by supplying signals to gates of the transistor 140 and the transistor 150.

The detection circuit 185 monitors the voltage of the secondary battery, and when the detection circuit 185 detects overcharge or overdischarge, the detection circuit 185 can supply a signal of detection to the control circuit 153. The control circuit receives the signal and can supply a signal to at least one of the gates of the transistor 140 and the transistor 150, so that current flowing to the secondary battery 121 can be blocked.

The detection circuit 186 monitors the current of the secondary battery 121, and when detecting an overcurrent in charge or discharge, the detection circuit 186 can supply a signal of detection to the control circuit 153. The control circuit receives the signal and can supply a signal to at least one of the gates of the transistor 140 and the transistor 150, so that current flowing to the secondary battery 121 can be blocked.

The overcharge detected in the detection circuit 185 may be detected by using an extremum of the charge voltage change curve over time (e.g., ΔV−t curve) or using an extremum of the differential curve of quantity of stored electricity with respect to voltage (dQ/dV curve) described above. Alternatively, the overcharge detected in the detection circuit 185 may be detected by comparison with a predetermined voltage value with use of a comparison circuit. The predetermined voltage value may be different depending on the ambient temperature of the secondary battery. The voltage value depending on the ambient temperature of the secondary battery is stored in the memory circuit included in the control circuit 153, for example.

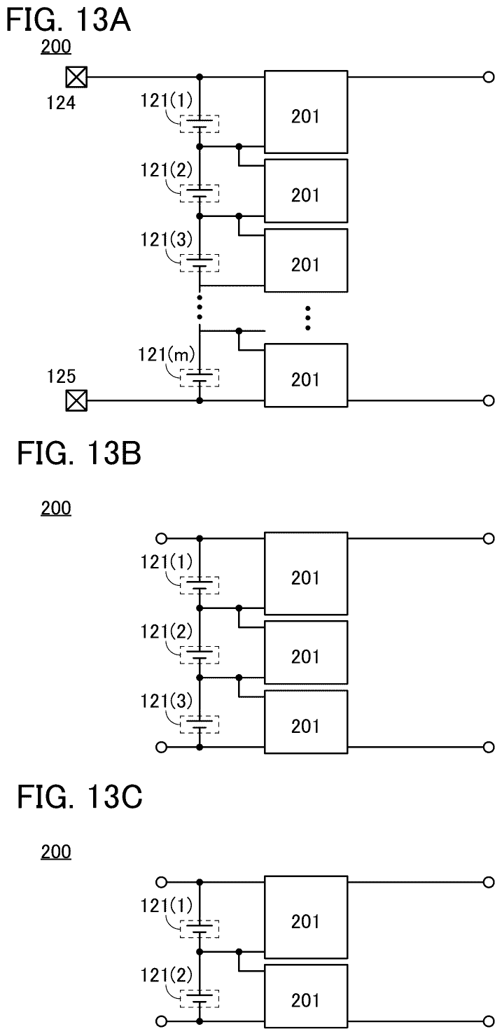

In examples of the power storage systems 200 in FIG. 13A to FIG. 13C, m secondary batteries 121 that are connected in series are connected to the respective charging units 201. FIG. 13A illustrates an example of the power storage system 200 in the case where m is an integer of 4 or more, and a secondary battery 121(1), a secondary battery 121(2), a secondary battery 121(3), and a secondary battery 121(m) are illustrated as the first, the second, the third, and the m-th secondary batteries 121, respectively, of the m secondary batteries 121, and the other secondary batteries are not illustrated. FIG. 13B illustrates an example of the power storage system 200 in which m is 3, and FIG. 13C illustrates an example of the power storage system 200 in which m is 2.

The m charging units 201 may share a function. For example, the detection circuit 185 included in the charging unit 201 may detect overcharge at a voltage between a terminal 124 electrically connected to a positive electrode of the secondary battery 121(1) and a terminal 125 electrically connected to a negative electrode of the secondary battery 121(m). Moreover, for example, the detection circuit 186 and the short-circuit detection circuit SD included in the charging unit 201 may detect overcharge or a short circuit on the basis of a current between the terminal 124 and the terminal 125.

In addition, the power storage system 200 can independently control the m secondary batteries 121 with the charging units 201 connected to the respective secondary batteries. At this time, in the secondary battery 121 where charge is completed earlier, a current is made to flow through a path that is connected in parallel to the secondary battery 121, for example, a transistor, a resistor, a diode, or the like connected in parallel to the secondary battery 121 after charge is completed, for example. Thus, the charging unit 201 preferably has a switch for switching of a current path between the secondary battery 121 and the path.

In addition, the power storage system 200 may control charge with use of the total of voltages of the m secondary batteries 121 that are connected in series (for example, in FIG. 13A, a voltage between the positive electrode of the secondary battery 121(1) and the negative electrode of the secondary battery 121(m). In such a case, it is possible to use an m-fold voltage value as the voltage used for the control of charge.

This embodiment can be combined with the description in any of the other embodiments or the like as appropriate

### Embodiment 2

In this embodiment, an example of a secondary battery of one embodiment of the present invention will be described.

A secondary battery of one embodiment of the present invention preferably includes a positive electrode, a negative electrode, and an electrolyte.

### <Positive Electrode>

The positive electrode of one embodiment of the present invention contains a positive electrode active material.

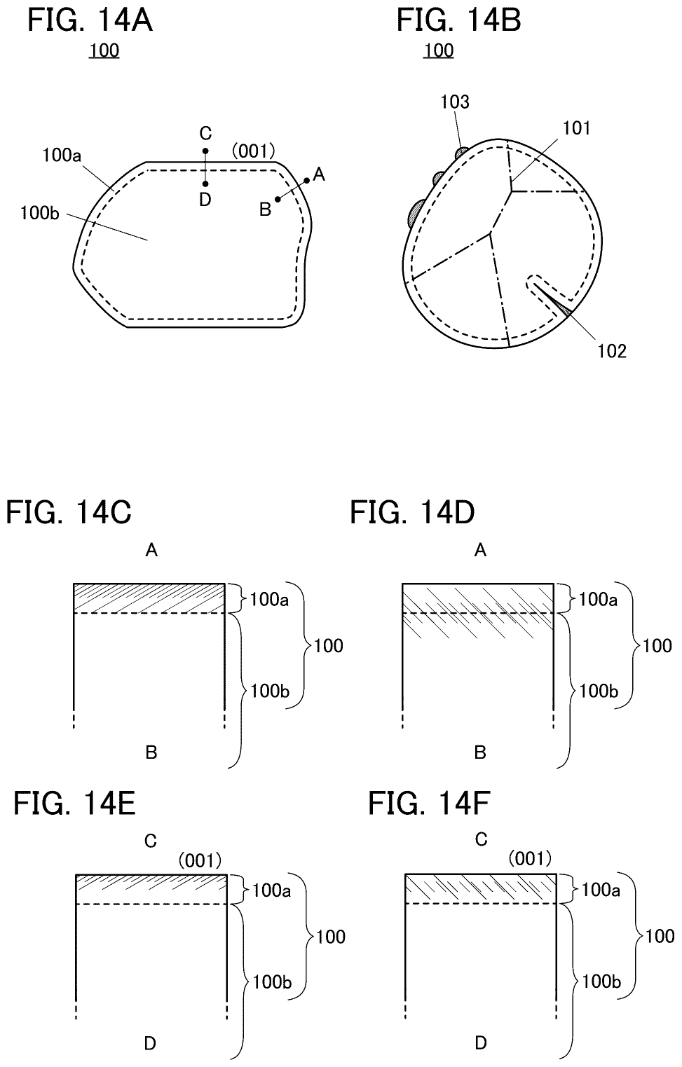

A positive electrode active material that can be used for a secondary battery of one embodiment of the present invention and a manufacturing method thereof are described with reference to FIG. 14A to FIG. 23C.

### [Positive Electrode Active Material]

FIG. 14A and FIG. 14B are each a cross-sectional view of a positive electrode active material 100 that can be used for a secondary battery of one embodiment of the present invention. FIG. 14C and FIG. 14D show enlarged views of a portion near the line A-B in FIG. 14A. FIG. 14E and FIG. 14F show enlarged views of a portion near the line C-D in FIG. 14A.

As illustrated in FIG. 14A to FIG. 14F, the positive electrode active material 100 includes a surface portion 100a and a bulk 100b. In each drawing, the dashed line denotes a boundary between the surface portion 100a and the bulk 100b. In FIG. 14B, the dashed-dotted line denotes part of a crystal grain boundary 101.

Note that in this specification and the like, the positive electrode active material 100 is a compound containing oxygen and a transition metal into and from which lithium can be inserted and extracted. Thus, an interface between a region where oxygen or the transition metal M(e.g., Co, Ni, Mn, or Fe) that is oxidized and reduced due to insertion and extraction of lithium is present and a region where oxygen or the transition metal M is not present is referred to as a surface of the positive electrode active material. A plane generated by at least one of slipping, a split, and a crack also can be considered as the surface of the positive electrode active material.

In this specification and the like, the surface of the positive electrode active material in line analysis by EDX (Energy Dispersive X-ray Spectroscopy) or the like is defined as a measurement point showing a measured value closest to the value of 50% of the average detected amount of the transition metal or oxygen in the bulk. Alternatively, the surface is defined as an intersecting point between a tangent drawn by a tangent method to an intensity profile of the transition metal or oxygen obtained by EDX line analysis and an axis in the depth direction. Note that in the case where the measurement value closest to the value of 50% of the average detected amount in the bulk is different between the transition metal and oxygen, the measurement value on the outer side can be employed. The surface of the positive electrode active material in, for example, a STEM (Scanning Transmission Electron Microscope) image is defined as a boundary between a region where an image derived from the crystal structure of the positive electrode active material is observed and a region where the image is not observed, and is defined as the outermost surface of a region where an atomic column derived from an atomic nucleus of a metal element that has a larger atomic number than lithium. Alternatively, the surface is defined as an intersecting point between a tangent drawn at a luminance profile from the surface toward the bulk and an axis in the depth direction in a STEM image. The surface in a STEM image or the like may be determined in combination with analysis with higher spatial resolution.

In this specification and the like, the surface portion 100a of the positive electrode active material 100 refers to a region ranging from the surface toward the inner portion to a depth of 10 nm or less in a direction perpendicular or substantially perpendicular to the surface. The surface portion 100a refers to a region within 50 nm from the surface. Alternatively, the surface portion 100a refers to a region within 5 nm from the surface. The surface portion 100a can be rephrased as the vicinity of a surface, a region in the vicinity of a surface, or a shell. Note that “substantially perpendicular” refers to a state where an angle is greater than or equal to 800 and less than or equal to 1000.

The bulk 100b refers to a region deeper than the surface portion 100a of the positive electrode active material. The bulk 100b is rephrased as an inner portion or a core.

A surface of the positive electrode active material 100 refers to a surface of a composite oxide including the surface portion 100a, the bulk 100b, a projection 103, and the like. Note that the positive electrode active material 100 does not include a carbonic acid, a hydroxy group, and the like which are adsorbed after formation of the positive electrode active material 100. Furthermore, the positive electrode active material 100 does not include an electrolyte, an organic solvent, a binder, a conductive material, and a compound originating from any of these which are attached after formation of the positive electrode active material 100. The surface of the positive electrode active material 100 in, for example, a cross-sectional STEM image is a boundary between a region where a bonding image of an electron beam is observed and a region where the image is not observed, and is determined as the outermost surface of a region where a bright spot derived from an atomic nucleus of a metal element that has a larger atomic number than lithium is observed. The surface in a cross-sectional STEM image or the like may be determined also on the basis of higher spatial-resolution analysis results, e.g., EELS (Electron Energy Loss Spectroscopy) analysis results.

The crystal grain boundary 101 refers to, for example, a portion where the positive electrode active materials 100 adhere to each other, a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM image, a cross-sectional STEM image, or the like, i.e., a structure including another atom between lattices, a cavity, or the like. The crystal grain boundary 101 can be regarded as one of plane defects. The vicinity of the crystal grain boundary 101 refers to a region positioned within 10 nm from the crystal grain boundary 101.

### {Contained Element}

The positive electrode active material 100 contains lithium, a transition metal M, oxygen, and an additive element A. Alternatively, the positive electrode active material 100 can contain a composite oxide containing lithium and the transition metal M (LiMO₂) into which the additive element A is added. Note that the composition of the composite oxide is not strictly limited to Li:M:O=1:1:2. In some cases, a positive electrode active material to which the additive element A is added is referred to as a composite oxide.

In order to maintain a neutrally charged state even when lithium ions are inserted and extracted, a positive electrode active material of a lithium-ion secondary battery needs to contain a transition metal which can take part in an oxidation-reduction reaction. It is preferable that the positive electrode active material 100 of one embodiment of the present invention mainly contain cobalt as the transition metal M taking part in an oxidation-reduction reaction. In addition to cobalt, at least one or two or more selected from nickel and manganese may be contained. When cobalt is used as the transition metal M contained in the positive electrode active material 100 at greater than or equal to 75 atomic %, preferably greater than or equal to 90 atomic %, further preferably greater than or equal to 95 atomic %, many advantages such as relatively easy synthesis, easy handling, and excellent cycle performance are gained, which is preferable.

When cobalt is used as the transition metal M contained in the positive electrode active material 100 at greater than or equal to 75 atomic %, preferably greater than or equal to 90 atomic %, further preferably greater than or equal to 95 atomic %, LiₓCoO₂ with small x is more stable than a composite oxide in which nickel accounts for the majority of the transition metal M, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a layered rock-salt composite oxide, such as lithium nickel oxide, in which octahedral coordinated low-spin nickel(III) accounts for the majority of the transition metal M, and a layer having an octahedral structure formed of nickel and oxygen is likely to be distorted. Thus, a concern that the crystal structure might break in charge and discharge cycles grows. A nickel ion is larger than a cobalt ion and has a size close to that of a lithium ion. Thus, there is a problem in that cation mixing between nickel and lithium is likely to occur in a layered rock-salt composite oxide in which nickel accounts for the majority of the transition metal M, such as lithium nickel oxide.

Using nickel at greater than or equal to 33 at %, preferably greater than or equal to 60 at %, further preferably greater than or equal to 80 at % as the transition metal M contained in the positive electrode active material 100 is preferable because in that case, the cost of the raw materials might be lower than that in the case of using a large amount of cobalt and discharge capacity per weight might be increased.

As the additive element A contained in the positive electrode active material 100, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used. The total percentage of the transition metal among the additive elements A is preferably less than 25 at %, further preferably less than 10 at %, still further preferably less than 5 at %.

That is, the positive electrode active material 100 can contain lithium cobalt oxide to which magnesium and fluorine are added; lithium cobalt oxide to which magnesium, fluorine, and titanium are added; lithium cobalt oxide to which magnesium, fluorine, and aluminum are added; lithium cobalt oxide to which magnesium, fluorine, and nickel are added; lithium cobalt oxide to which magnesium, fluorine, nickel, and aluminum are added; or the like.

These additive elements A further stabilize the crystal structure of the positive electrode active material 100 as described later. In this specification and the like, the additive element A can be rephrased as part of a raw material or a mixture.

Note that as the added element A, magnesium, fluorine, nickel, aluminum, titanium, zirconium, vanadium, iron, manganese, chromium, niobium, arsenic, zinc, silicon, sulfur, phosphorus boron, bromine, or beryllium is not necessarily contained.

When the positive electrode active material 100 is substantially free from manganese, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example. The weight of manganese can be analyzed by GD-MS (Glow Discharge Mass Spectrometry), for example.

### {Crystal Structure}

<x in LiₓCoO₂ being 1>>

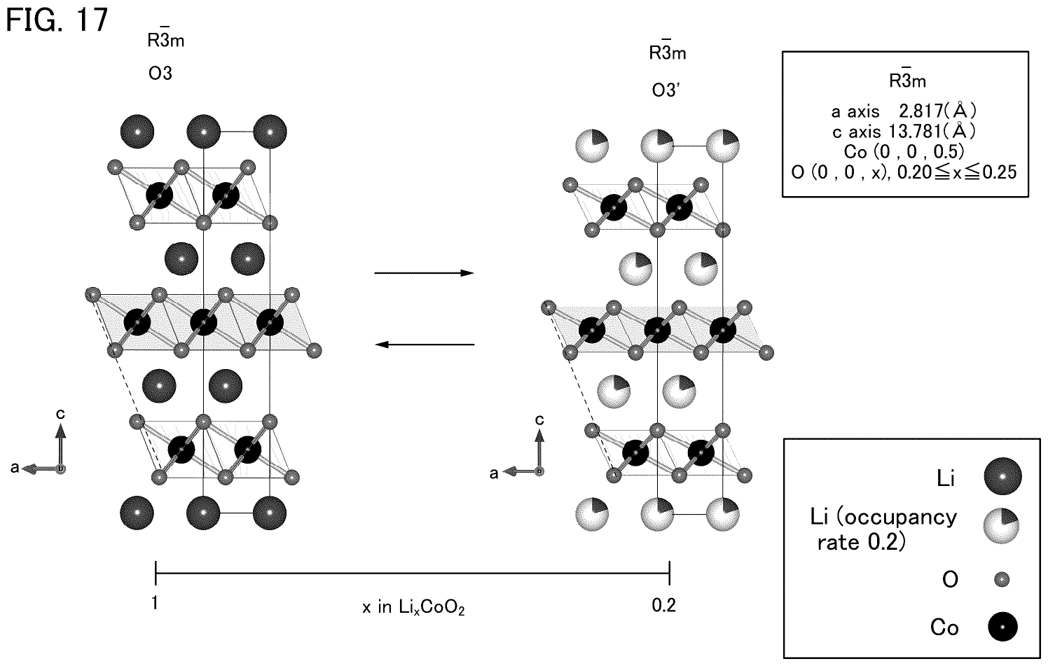

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt crystal structure excels as a positive electrode active material of a secondary battery because it has high discharge capacity and a two-dimensional diffusion path for lithium ions and is thus suitable for an insertion and extraction reaction of lithium ions. For this reason, it is particularly preferable that the bulk 100b, which accounts for the majority of the volume of the positive electrode active material 100, have a layered rock-salt crystal structure. In FIG. 17, the layered rock-salt crystal structure is denoted by R-3m O3.

Meanwhile, the surface portion 100a of the positive electrode active material 100 of one embodiment of the present invention preferably has a function of reinforcing the layered structure, which is formed of octahedrons of the transition metal M and oxygen, of the bulk 100b so that the layered structure does not break even when a large amount of lithium is extracted from the positive electrode active material 100 by charge. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means at least one of inhibition of a change in the structures of the surface portion 100a and the bulk 100b of the positive electrode active material 100 such as extraction of oxygen and inhibition of oxidative decomposition of an electrolyte on the surface of the positive electrode active material 100.

Accordingly, the surface portion 100a preferably has a composition and a crystal structure which are different from those of the bulk 100b. The surface portion 100a preferably has a more stable composition and a more stable crystal structure than those of the bulk 100b at room temperature (25° C.). For example, at least part of the surface portion 100a of the positive electrode active material 100 of one embodiment of the present invention preferably has the rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charge, and is a region that tends to have a lower concentration of lithium than the bulk 100b. Bonds between atoms are regarded as being partly cut on the surface of the positive electrode active material 100 included in the surface portion 100a. Thus, the surface portion 100a is regarded as a region that tends to be unstable and easily starts deterioration of the crystal structure. Meanwhile, when the surface portion 100a can be made sufficiently stable, the layered structure, which is formed of octahedrons of the transition metal M and oxygen, of the bulk 100b is unlikely to be broken even with small x in LiₓCoO₂, e.g., with x of less than or equal to 0.24. Furthermore, a shift in layers, which are formed of octahedrons of the transition metal M and oxygen, of the bulk 100b can be inhibited.

In order that the surface portion 100a can have a stable composition and a stable crystal structure, the surface portion 100a preferably contains the additive element A, further preferably contains a plurality of kinds of additive elements A. The surface portion 100a preferably has a higher concentration of one or more selected from the additive elements A than the bulk 100b. The one or more selected from the additive elements A contained in the positive electrode active material 100 preferably have a concentration gradient. In addition, it is further preferable that the additive elements A contained in the positive electrode active material 100 be differently distributed. For example, it is further preferable that the additive elements A exhibit concentration peaks at different depths from the surface. The concentration peak here refers to the local maximum value of the detected amount in the surface portion 100a or in a region from the surface to a depth of 50 nm or less.

For example, as illustrated in FIG. 14C by gradation, some of the additive elements A such as magnesium, fluorine, nickel, titanium, silicon, phosphorus, boron, and calcium preferably have a concentration gradient in which the concentration increases from the bulk 100b toward the surface. An element having such a concentration gradient is referred to as an additive element X.

Another additive element A such as aluminum or manganese preferably has a concentration gradient as illustrated in FIG. 14D by hatching density and exhibits a concentration peak in a deeper region than the additive element in FIG. 14C. The concentration peak may be located in the surface portion 100a or located deeper than the surface portion 100a. For example, the concentration peak is preferably located in a region of 5 nm to 30 nm inclusive in depth in a direction perpendicular or substantially perpendicular to the surface. An element having such a concentration gradient is referred to as an additive element Y.

A magnesium ion, which is one of the additive elements X, for example is divalent, and the magnesium ion is more stable in lithium sites than in transition metal M sites in the layered rock-salt crystal structure and thus is likely to enter the lithium sites. An appropriate concentration of magnesium in the lithium sites of the surface portion 100a can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high concentration of magnesium in the surface portion 100a probably increases the corrosion resistance to hydrofluoric acid generated by the decomposition of the electrolyte solution.

An appropriate concentration of magnesium can bring the above-described advantages without an adverse effect on insertion and extraction of lithium in charge and discharge. However, excess magnesium might adversely affect insertion and extraction of lithium. Furthermore, the effect of stabilizing the crystal structure might be reduced. This is probably because magnesium enters the transition metal M sites in addition to the lithium sites. Moreover, an undesired magnesium compound (e.g., an oxide or a fluoride) which is substituted for neither the lithium site nor the transition metal M site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100 preferably contains an appropriate amount of magnesium. For example, the proportion of magnesium to the sum of the transition metal M (Mg/Co) in the positive electrode active material 100 of one embodiment of the present invention is preferably higher than or equal to 0.25% and lower than or equal to 5%, further preferably higher than or equal to 0.5% and lower than or equal to 2%, still further preferably approximately 1%. The amount of magnesium contained in the entire positive electrode active material 100 here may be a value obtained by element analysis on the entire positive electrode active material 100 using GD-MS, ICP-MS (Inductively Coupled Plasma Mass Spectrometry), or the like, or may be a value based on the ratio of the raw materials mixed in the formation process of the positive electrode active material 100, for example.

Nickel, which is one of the additive elements X, can exist in both the transition metal M site and the lithium site. Nickel preferably exists in the transition metal M site because an oxidation-reduction potential can be is lower than the case of cobalt, leading to an increase in discharge capacity.

In addition, when nickel exists in the lithium site, a shift in the layer structure, which is formed of the transition metal M and octahedrons of oxygen, can be inhibited. Moreover, a change in volume in charge and discharge is inhibited. Furthermore, an elastic becomes large, i.e., hardness increases. This is probably because nickel in the lithium sites serves as a column supporting the CoO₂ layers. Thus, in particular, the crystal structure is expected to be more stable in a charged state at high temperatures, e.g., 45° C. or higher, which is preferable.

Meanwhile, excess nickel might increase the influence of distortion due to the Jahn-Teller effect. Moreover, excess nickel might adversely affect insertion and extraction of lithium.

Thus, the entire positive electrode active material 100 preferably contains an appropriate amount of nickel. For example, the number of nickel atoms contained in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the formation process of the positive electrode active material, for example.

Aluminum, which is one of additive elements Y, can exist in the transition metal M site in a layered rock-salt crystal structure. Since aluminum is a trivalent representative element and its valence does not change, lithium around aluminum is less likely to move even in charge and discharge. Thus, aluminum and lithium therearound serve as columns to inhibit a change in the crystal structure. Furthermore, aluminum has effects of inhibiting elution of the transition metal M around aluminum and improving continuous charge tolerance. Moreover, an Al—O bond is stronger than a Co—O bond; thus, extraction of oxygen around aluminum can be inhibited. These effects improve thermal safety. Hence, a secondary battery containing aluminum as the additive element Y can have improved stability. Furthermore, the positive electrode active material 100 can have a crystal structure that is less likely to be broken by repeated charge and discharge.

Meanwhile, excess aluminum might adversely affect insertion and extraction of lithium.

Thus, the entire positive electrode active material 100 preferably contains an appropriate amount of aluminum. For example, the number of aluminum atoms contained in the entire positive electrode active material 100 is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The amount contained in the entire positive electrode active material 100 here may be a value obtained by element analysis on the entire positive electrode active material 100 using GD-MS, ICP-MS, or the like, or may be a value based on the ratio of the raw materials mixed in the formation process of the positive electrode active material 100, for example.

Fluorine, which is one of the additive elements X, is a monovalent anion; when fluorine is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, the use of lithium cobalt oxide containing fluorine in a secondary battery can improve the charge and discharge characteristics, current characteristics, and the like. When fluorine exists in the surface portion 100a, which has a surface in contact with the electrolyte solution, the corrosion resistance to hydrofluoric acid can be effectively improved. When a fluoride such as lithium fluoride has a lower melting point than another additive element A source, the fluoride can serve as a fusing agent (also referred to as a flux) for lowering the melting point of the another additive element A source.

An oxide of titanium, which is one of the additive elements X, is known to have superhydrophilicity. Accordingly, the positive electrode active material 100 that contains titanium oxide in the surface portion 100a presumably has good wettability with respect to a high-polarity solvent. In a secondary battery formed using the positive electrode active material 100, the positive electrode active material 100 and a high-polarity electrolyte solution can have favorable contact at the interface therebetween, which may inhibit an internal resistance increase.

When the surface portion 100a contains phosphorus, which is one of the additive elements X, a short circuit can be inhibited while a state with small x in LiₓCoO₂ is maintained, in some cases, which is preferable. For example, a compound containing phosphorus and oxygen preferably exists in the surface portion 100a.

When the positive electrode active material 100 contains phosphorus, phosphorus may react with hydrogen fluoride generated by the decomposition of the electrolyte, which might be able to decrease the hydrogen fluoride concentration in the electrolyte and is preferable.

In the case where the electrolyte contains LiPF₆, hydrogen fluoride might be generated by hydrolysis. In addition, hydrogen fluoride might be generated by the reaction of polyvinylidene fluoride (PVDF) used as a component of the positive electrode and alkali. The decrease in the concentration of hydrogen fluoride in the electrolyte can inhibit at least one of corrosion of a current collector and/or separation of a coating film in some cases. Furthermore, a reduction in adhesion properties due to at least one of gelling and insolubilization of PVDF can be inhibited in some cases.

The positive electrode active material 100 preferably contains magnesium and phosphorus, in which case the stability in a state with small x in LiₓCoO₂ is extremely high. In the case where the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentrations of phosphorus and magnesium described here may each be a value obtained by element analysis on the entire positive electrode active material 100 by GD-MS, ICP-MS, or the like, or may be a value based on the ratio of the raw materials mixed in the formation process of the positive electrode active material 100, for example.

In the case where the positive electrode active material 100 has a crack, crack development can be inhibited by phosphorus, more specifically, a compound containing phosphorus and oxygen, for example, being near the center portion of the positive electrode active material having the crack on its surface, e.g., a filling portion 102.

When the surface portion 100a contains both magnesium and nickel, divalent magnesium might be able to be present more stably in the vicinity of divalent nickel. Thus, dissolution of magnesium might be inhibited even when x in LiₓCoO₂ is small. This can contribute to stabilization of the surface portion 100a.

Additive elements A that are differently distributed, such as the additive element X and the additive element Y, are preferably contained at a time, in which case the crystal structure of a wider region can be stabilized. For example, in the case where the positive electrode active material 100 contains magnesium and nickel, which are examples of the additive elements X, and contains aluminum, which is one of the additive elements Y, the crystal structure of a wider region can be stabilized as compared with the case where only the additive element X or the additive element Y is contained. In the case where the positive electrode active material 100 contains both the additive element X and the additive element Y as described above, the surface can be sufficiently stabilized by the additive element X such as magnesium and nickel; thus, the additive element Y such as aluminum is not necessary for the surface. It is preferable that aluminum be widely distributed in a deep region, i.e., for example, e.g., a region ranging from a depth from the surface of 5 nm to a depth from the surface of 50 nm., in which case the crystal structure of a wider region can be stabilized.

When a plurality of the additive elements A are contained as described above, the effects of the additive elements A contribute synergistically to further stabilization of the surface portion 100a. In particular, magnesium, nickel, and aluminum are preferably contained because a high effect of stabilizing the composition and the crystal structure can be obtained.

Note that it is not preferable that the surface portion 100a be occupied by only a compound of the additive element A and oxygen because it becomes difficult to insert and extract lithium. For example, it is not preferable that the surface portion 100a be occupied by only at least one of MgO, a structure in which MgO and NiO(II) form a solid solution, and a structure in which MgO and CoO(II) form a solid solution. Thus, the surface portion 100a needs to contain at least cobalt, and also contain lithium in a discharged state to have the path through which lithium is inserted and extracted.

To sufficiently ensure the path through which lithium is inserted and extracted, the concentration of cobalt is preferably higher than that of magnesium in the surface portion 100a. For example, an atomic ratio of the number of magnesium atoms Mg to the number of cobalt atoms Co, Mg/Co, is preferably less than or equal to 0.62. The concentration of cobalt is preferably higher than that of nickel in the surface portion 100a. The concentration of cobalt is preferably higher than that of aluminum in the surface portion 100a. The concentration of cobalt is preferably higher than that of fluorine in the surface portion 100a.

Moreover, excess nickel might hinder diffusion of lithium; thus, the concentration of magnesium is preferably higher than that of nickel in the surface portion 100a. For example, the number of nickel atoms is preferably ⅙ or less that of magnesium atoms.

It is preferable that some of the additive elements A, in particular, magnesium, nickel, and aluminum have higher concentrations in the surface portion 100a than in the bulk 100b and exist randomly also in the bulk 100b to have low concentrations. When magnesium and aluminum exist in the lithium sites of the bulk 100b at appropriate concentrations, an effect of facilitating maintenance of the layered rock-salt crystal structure is obtained in a manner similar to the above. When nickel is present in the bulk 100b at an appropriate concentration, a shift in the layer structure formed of octahedrons of the transition metal M and oxygen can be inhibited in a manner similar to the above. Also in the case where both magnesium and nickel are contained, a synergistic effect of inhibiting dissolution of magnesium can be brought since divalent magnesium can be present more stably in the vicinity of divalent nickel.

It is preferable that the crystal structure continuously change from the bulk 100b toward the surface owing to the above-described concentration gradient of the additive element A. Alternatively, it is preferable that the surface portion 100a and the bulk 100b have substantially the same crystal orientation.

For example, a crystal structure preferably changes continuously from the bulk 100b having a layered rock-salt crystal structure toward the surface and the surface portion 100a that have a rock-salt crystal structure or have the features of both a rock-salt crystal structure and a layered rock-salt crystal structure. Alternatively, the orientations of the surface portion 100a that has a rock-salt crystal structure or has the features of both a rock-salt crystal structure and a layered rock-salt crystal structure and the bulk 100b having a layered rock-salt crystal structure are preferably substantially aligned with each other.

In this specification and the like, a layered rock-salt crystal structure, which belongs to the space group R-3m, of a composite oxide containing lithium and the transition metal M such as cobalt refers to a crystal structure in which a rock-salt ion arrangement where cations and anions are alternately arranged is included and lithium and the transition metal M are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal structure is distorted in some cases.

A rock-salt crystal structure refers to a structure in which a cubic crystal structure with the space group Fm-3m or the like is included and cations and anions are alternately arranged. Note that a cation or anion vacancy may exist.

Having features of both a layered rock-salt crystal structure and a rock-salt crystal structure can be judged by an electron beam diffraction pattern, a TEM image, a cross-sectional STEM image, and the like.

Although there is no distinction among cation sites in a rock-salt crystal structure, a layered rock-salt crystal structure has two types of cation sites: one is mostly occupied by lithium, and the other is occupied by the transition metal M. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of MgO having a rock-salt crystal structure and LiCoO₂ having a layered rock-salt crystal structure are compared with each other, the bright spots on the (003) plane of LiCoO₂ are observed at a distance approximately half the distance between the bright spots on the (111) plane of MgO. Thus, when two phases of MgO having a rock-salt crystal structure and LiCoO₂ having a layered rock-salt crystal structure are included in a region to be analyzed, for example, a plane orientation in which bright spots with high luminance and bright spots with low luminance are alternately arranged exists in an electron diffraction pattern. A bright spot common between the rock-salt crystal structure and the layered rock-salt crystal structure has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like; furthermore, the layers with low luminance, i.e., a metal that has a larger atomic number than lithium exists in part of the lithium layers.

Anions of a layered rock-salt crystal structure and anions of a rock-salt crystal structure form a cubic close-packed structure (face-centered cubic lattice structure). Anions of an O3′ type crystal structure described later are presumed to form a cubic close-packed structure. Thus, when a layered rock-salt crystal structure and a rock-salt crystal structure are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111}plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that the space groups of the layered rock-salt crystal structure and the O3′ type crystal structure are R-3m, which is different from the space groups Fm-3m (the space group of a general rock-salt crystal structure) of rock-salt crystal structures; thus, the Miller index of the crystal plane satisfying the above conditions in the layered rock-salt crystal structure and the O3′ type crystal structure is different from that in the rock-salt crystal structure. In this specification and the like, a state where the orientations of the cubic close-packed structures composed of anions in the layered rock-salt crystal structure, the O3′ type crystal structure, and the rock-salt crystal structure are aligned with each other is sometimes referred to as a state where crystal orientations are substantially aligned with each other, topotaxy, or epitaxy.

Topotaxy refers to having similarity in a three-dimensional structure such that crystal orientations are substantially aligned with each other, or to having the same orientations crystallographically. Epitaxy refers to similarity in structures of two-dimensional interfaces.

The orientations of crystals in two regions being substantially aligned with each other can be determined, for example, from a TEM image, a STEM image, a HAADF-STEM (High-Angle Annular Dark-Field STEM) image, an ABF-STEM (Annular Bright-Field STEM) image, an eHCI-TEM (enhanced Hollow-Cone Illumination TEM) image, an FFT (Fast Fourier Transformation) pattern such as a TEM image or a STEM image, or the like. An XRD pattern, an electron diffraction pattern, a neutron diffraction pattern, and the like can also be used for the determination.

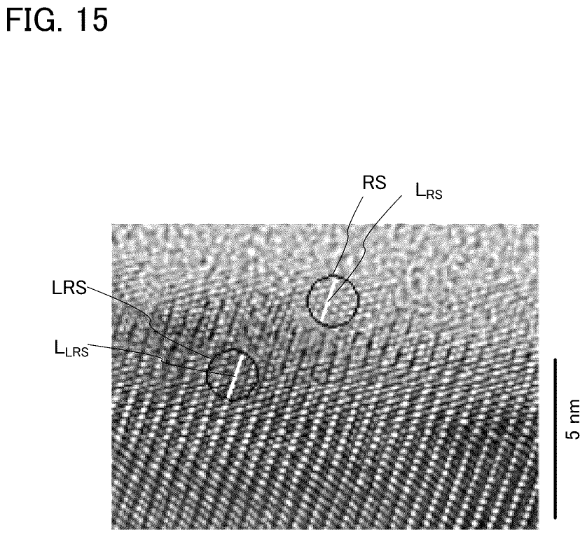

FIG. 15 shows an example of a TEM image in which orientations of a layered rock-salt crystal structure LRS and a rock-salt crystal structure RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident in the direction perpendicular to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} shown in FIG. 15) is greater than or equal to 0° and less than or equal to 5° or greater than or equal to 0° and less than or equal to 2.5° in the TEM image, it can be judged that the crystal planes are substantially aligned with each other, that is, the crystal orientations of are substantially aligned with each other. Similarly, when the angle between the dark lines is less than or equal to 5° or less than or equal to 2.5°, it can be judged that the crystal orientations are substantially aligned with each other. In general, it is difficult to clearly differentiate “perfectly aligned” from “substantially aligned”. In this specification and the like, the expression “aligned” includes both “perfectly aligned” (where the angle between bright lines is 0°, for example) and “substantially aligned”.

In a HAADF-STEM image, a contrast proportional to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are contained as the additive elements of the lithium cobalt oxide.

Consequently, in the case where repetition of bright lines and dark lines is observed in two regions having different crystal structures and the angle between the bright lines is less than or equal to 5° or less than or equal to 2.5° in a HAADF-STEM image, it can be judged that arrangements of the atoms are substantially aligned with each other, that is, the crystal orientations are substantially aligned with each other. Similarly, when the angle between the dark lines is less than or equal to 5° or less than or equal to 2.5°, it can be judged that orientations of the crystals are substantially aligned with each other.

With an ABF-STEM image, an element having a smaller atomic number is observed to be brighter, but a contrast corresponding to the atomic number is obtained as with a HAADF-STEM image; hence, in an ABF-STEM image, crystal orientations can be judged as in a HAADF-STEM image.

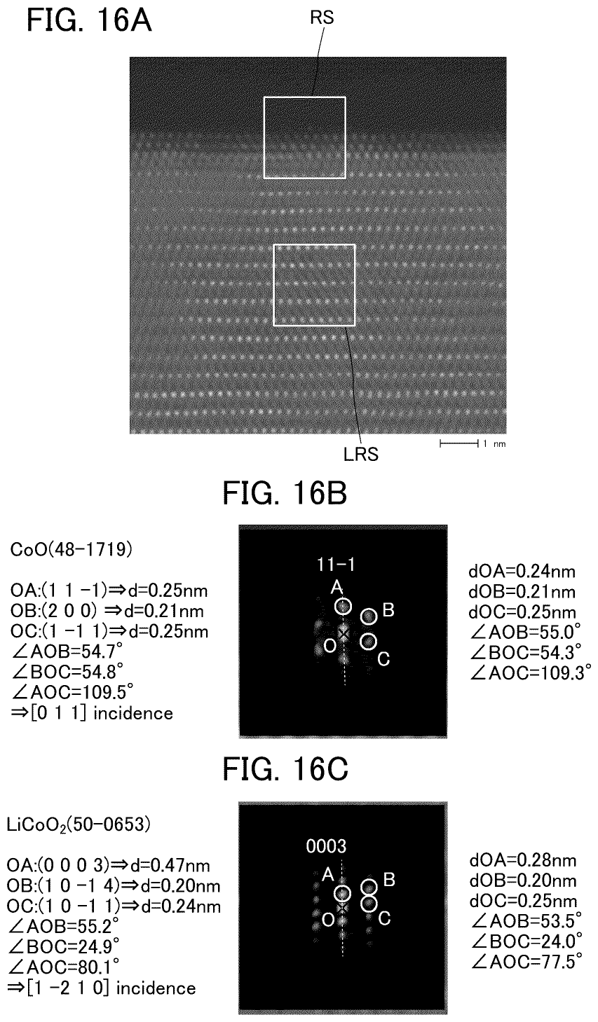

FIG. 16A shows an example of a STEM image in which orientations of the layered rock-salt crystal structure LRS and the rock-salt crystal structure RS are substantially aligned with each other. FIG. 16B shows an FFT pattern of a region of the rock-salt crystal structure RS, and FIG. 16C shows an FFT pattern of a region of the layered rock-salt crystal structure LRS. In FIG. 16B and FIG. 16C, the composition, the JCPDS (Joint Committee on Powder Diffraction Standard) card number, and d values and angles to be calculated are shown on the left. The measured values are shown on the right. A spot denoted by O is zero-order diffraction, and X denotes the center of the spot.

A spot denoted by A in FIG. 16B is derived from 11-1 reflection of a cubic structure. A spot denoted by A in FIG. 16C is derived from 0003 reflection of a layered rock-salt crystal structure. It is found from FIG. 16B and FIG. 16C that the direction of the 11-1 reflection of the cubic structure and the direction of the 0003 reflection of the layered rock-salt crystal structure are substantially aligned with each other. That is, a straight line passing through AO in FIG. 16B is substantially parallel to a straight line passing through AO in FIG. 16C. Here, the terms “substantially aligned” and “substantially parallel” mean that the angle is greater than or equal to 0° and less than or equal to 5° or greater than or equal to 0° and less than or equal to 2.5°.

When the orientations of the layered rock-salt crystal structure and the rock-salt crystal structure are substantially aligned with each other in the above manner in an FFT pattern and an electron diffraction pattern, the <0003> orientation of the layered rock-salt crystal structure and the <11-1> orientation of the rock-salt crystal structure may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 16C is derived from 10-14 reflection of the layered rock-salt crystal structure. This is sometimes observed at a position where the difference in orientation from the reciprocal lattice point derived from the 0003 reflection of the layered rock-salt crystal structure (A in FIG. 16C) is greater than or equal to 520 and less than or equal to 560 (i.e., ∠AOB is greater than or equal to 520 and less than or equal to 56°) and d is greater than or equal to 0.19 nm and less than or equal to 0.21 nm. Note that these indices are just examples, and the spot does not necessarily correspond with them. For example, the spot may be a reciprocal lattice point equivalent to the indices.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 16B is derived from 200 reflection of the cubic structure. The spot derived from 200 reflection of the cubic structure is sometimes observed at a position where the difference in orientation from the reciprocal lattice point derived from the 11-1 reflection of the cubic structure (A in FIG. 16B) is greater than or equal to 540 and less than or equal to 560 (i.e., ∠AOB is greater than or equal to 540 and less than or equal to 56°). Note that these indices are just examples, and the spot does not necessarily correspond with them. For example, the spot may be a reciprocal lattice point equivalent to the indices.

Note that to determine whether crystal orientations are aligned, a sample is preferably processed to be thin so that the (0003) plane of the layered rock-salt crystal structure is easily observed. Thus, for example, an observation sample is preferably processed to be thin using an FIB (Focused Ion Beam) or the like such that an electron beam of a TEM image or the like, for example, enters in [1-210]. It is known that in a layered rock-salt positive electrode active material, such as lithium cobalt oxide, the (0003) plane and a plane equivalent thereto and the (10-14) plane and a plane equivalent thereto are likely to be crystal planes. Thus, when the shape of the positive electrode active material is observed well with a SEM (Scanning Electron Microscope) image or the like, the observation sample can be thinned so that the (0003) plane is easily observed.

<State Where x in LiₓCoO₂ is Small>>

The crystal structure in a state where x in LiₓCoO₂ is small of the positive electrode active material 100 of one embodiment of the present invention is different from that of a conventional positive electrode active material because the positive electrode active material 100 has at least one of the above-described distribution and crystal structure of the additive element A in a discharged state. Here, “x is small” means 0.1<x≤0.24.

A conventional positive electrode active material and the positive electrode active material 100 of one embodiment of the present invention are compared and changes in crystal structures owing to a change in x in LiₓCoO₂ will be described with reference to FIG. 17 to FIG. 21.

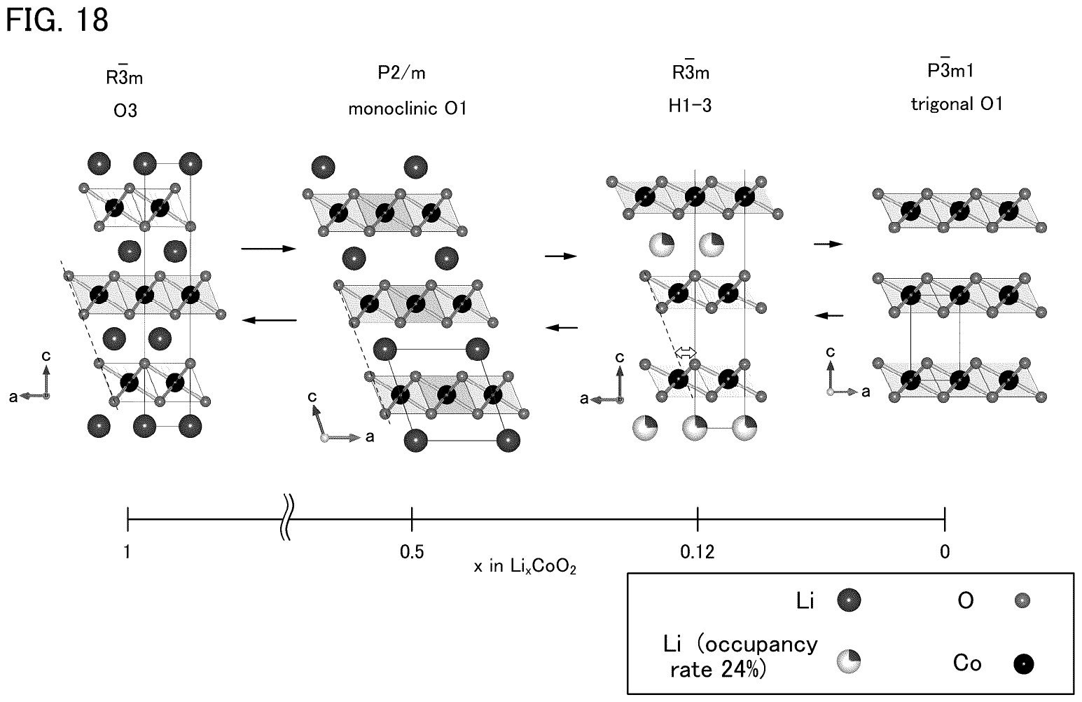

A change in crystal structure of the conventional positive electrode active material is illustrated in FIG. 18. The conventional positive electrode active material illustrated in FIG. 18 is lithium cobalt oxide (LiCoO₂) not containing the additive element A in particular. A change in crystal structure of lithium cobalt oxide containing no additive element A is described in Non-Patent Document 1 and Non-Patent Document 2 and the like.

In FIG. 18, the crystal structure of lithium cobalt oxide with x in LiₓCoO₂ of 1 is denoted by R-3m O3. In a unit cell of this crystal structure, three CoO₂ layers exist and lithium is positioned between the CoO₂ layers. Furthermore, lithium occupies octahedral sites with six coordinated oxygen. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen. The coordinates of lithium, cobalt, and oxygen in a unit cell of R-3m O3 can be represented by Li (0, 0, 0), Co (0, 0, 0.5), and O (0, 0, 0.23951).

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3m1 and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

When x is approximately 0.12, conventional lithium cobalt oxide has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25 in practice. The number of cobalt atoms per unit cell in the actual H1-3 type crystal structure is twice that in other structures. However, in this specification and the like, FIG. 18, and other drawings, the c-axis of the H1-3 type crystal structure is half that of the unit cell for easy comparison with the other crystal structures.

For the H1-3 type crystal structure, as disclosed in Non-Patent Document 2 the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in the positive electrode active material can be judged by the Rietveld analysis of XRD patterns, for example. In this case, a unit cell is selected such that the value of GOF (goodness of fit) is small.

When charge that makes x in LixCoO₂ be 0.24 or less and discharge are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrow in FIG. 18, the CoO₂ layer in the H1-3 type crystal structure largely shifts from R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charge that makes x be 0.24 or less and discharge are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

On the other hand, in the positive electrode active material 100 of one embodiment of the present invention illustrated in FIG. 17, a change in the crystal structure between a discharged state with x in LiₓCoO₂ of 1 and a state with x of 0.24 or less, with x of 0.2 is smaller than that in a conventional positive electrode active material. More specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charge that makes x be 0.24 or less and discharge are repeated, and enables excellent cycle performance. In addition, the positive electrode active material 100 of one embodiment of the present invention with x in LiₓCoO₂ of 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of the secondary battery is improved.

FIG. 17 illustrates crystal structures of the bulk 100b of the positive electrode active material 100 in a state where x in LiₓCoO₂ is 1 and in a state where x in LiₓCoO₂ is approximately 0.2. The bulk 100b, accounting for the majority of the volume of the positive electrode active material 100, greatly contributes to charge and discharge and is accordingly a portion where a shift in CoO₂ layers and a volume change matter most.

The positive electrode active material 100 with x of 1 has the R-3m O3 type crystal structure, which is the same as that of conventional lithium cobalt oxide.

However, the positive electrode active material 100 has a crystal structure different from the H1-3 type crystal structure in a state where x is 0.24 or less, e.g., approximately 0.2 or approximately 0.12, with which conventional lithium cobalt oxide has the H1-3 type crystal structure.

The positive electrode active material 100 of one embodiment of the present invention with x of approximately 0.2 has a trigonal crystal structure belonging to the space group R-3m. The symmetry of the CoO₂ layers of this structure is the same as that of O3. Thus, this crystal structure is referred to as an O3′ type crystal structure. In FIG. 17, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (Å), typically c=13.781 (Å).

In the O3′ type crystal structure, an ion of cobalt, nickel, magnesium, or the like occupies a site coordinated to six oxygen atoms. Note that a light element such as lithium sometimes occupies a site coordinated to four oxygen atoms.

As indicated by the dotted lines in FIG. 17, the CoO₂ layers hardly shift between the R-3m (O3) in a discharged state and the O3′ type crystal structure.

The R-3m (O3) type crystal structure in a discharged state and the O3′ type crystal structure which contain the same number of cobalt atoms have a difference in volume of 2.5% or less, specifically 2.2% or less, typically 1.8%.

As described above, in the positive electrode active material 100 of one embodiment of the present invention, a change in the crystal structure caused when x in LixCoO₂ is small, i.e., when a large amount of lithium is extracted, is smaller than that in a conventional positive electrode active material. In addition, a change in the volume per the same number of cobalt atoms is inhibited. Thus, the crystal structure of the positive electrode active material 100 is less likely to be broken even when charge that makes x be 0.24 or less and discharge are repeated. Therefore, the positive electrode active material 100 inhibits a decrease in discharge capacity in charge and discharge cycles. Furthermore, the positive electrode active material 100 can stably use a larger amount of lithium than a conventional positive electrode active material and thus enables high discharge capacity per weight and per volume. Thus, with use of the positive electrode active material 100, a secondary battery with high discharge capacity per weight and per volume can be fabricated.

Note that the positive electrode active material 100 is confirmed to have the O3′ type crystal structure in some cases when x in LixCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LixCoO₂ but also the number of charge and discharge cycles, a charge current and a discharge current, temperature, an electrolyte, and the like, so that the range of x is not limited to the above.

Hence, when x in LixCoO₂ in the positive electrode active material 100 is greater than 0.1 and less than or equal to 0.24, not all of the bulk 100b of the positive electrode active material 100 has to have the O3′ type crystal structure. The positive electrode active material 100 may have another crystal structure or may be partly amorphous.

In order to make x in LixCoO₂ small, charge with a high charge voltage is necessary in general. Therefore, the state where x in LixCoO₂ is small can be rephrased as a state where charge with a high charge voltage has been performed. For example, when CCCV charge is performed in an environment at 25° C. and 4.6 V or higher using the potential of a lithium metal as a reference, the H1-3 type crystal structure appears in a conventional positive electrode active material. Therefore, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, the positive electrode active material 100 of one embodiment of the present invention is preferable because the crystal structure with the symmetry of R-3m O3 can be maintained even when charge at a high charge voltage, e.g., a voltage higher than or equal to 4.6 V, is performed at 25° C. Moreover, the positive electrode active material 100 of one embodiment of the present invention is preferable because the O3′ type crystal structure can be obtained when charge with a higher charge voltage, e.g., a voltage higher than or equal to 4.65 V and lower than or equal to 4.7 V is performed at 25° C.

In the positive electrode active material 100, the H1-3 type crystal structure is eventually observed when the charge voltage is increased, in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a secondary battery, for example, the voltage of the secondary battery is lower than the above-mentioned voltage by the difference between the potential of graphite and the potential of a lithium metal. The potential of graphite is approximately 0.05 V to 0.2 V with reference to the potential of a lithium metal. Therefore, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ in FIG. 17, one embodiment of the present invention is not limited thereto. Lithium may exist unevenly in only some of the lithium sites; for example, lithium may symmetrically exist as in the monoclinic O1 (Li_{0.5}CoO₂) shown in FIG. 18. Distribution of lithium can be analyzed by a neutron diffraction pattern, for example.

The O3′ type crystal structure can be regarded as a crystal structure that contains lithium between layers randomly but is similar to a CdCl₂ type crystal structure. The crystal structure similar to the CdCl₂ crystal structure is close to a crystal structure of lithium nickel oxide when charged up to a charge depth of Li_{0.06}NiO₂; however, pure lithium cobalt oxide or a layered rock-salt positive electrode active material containing a large amount of cobalt is known not to have the CdCl₂ crystal structure in general.

The concentration gradient of the additive element A is preferably similar in a plurality of portions of the surface portion 100a of the positive electrode active material 100. In other words, it is preferable that the reinforcement derived from the additive element A uniformly occurs in the surface portion 100a. When only part of the surface portion 100a is reinforced, stress might be concentrated on parts that do not have reinforcement. The concentration of stress on part of the positive electrode active material 100 might cause defects such as cracks from that part, leading to breakage of the positive electrode active material and a decrease in charge and discharge capacity.

Note that the additive elements A do not necessarily have similar concentration gradients throughout the surface portion 100a of the positive electrode active material 100. FIG. 14E illustrates an example of distribution of the additive element X in the portion near the line C-D in FIG. 14A and FIG. 14F illustrates an example of distribution of the additive element Y in the portion near the line C-D.

Here, the portion near the line C-D has a layered rock-salt crystal structure belonging to R-3m and the surface of the portion has a (001) orientation. The distribution of the additive element A at the surface having a (001) orientation may be different from that at other surfaces. For example, the surface having a (001) orientation and the surface portion 100a thereof may have concentration distribution or a peak of one or two or more selected from the additive elements X and the additive elements Y in a shallow portion from the surface as compared to the case of a surface having another orientation. Alternatively, the surface with a (001) orientation and the surface portion 100a thereof may have a lower concentration of one or two or more selected from the additive elements X and the additive elements Y than a surface having another orientation. Further alternatively, at the surface with a (001) orientation and the surface portion 100a thereof, the concentration of one or two or more selected from the additive elements X and the additive element Y may be lower than or equal to the lower detection limit.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to the (001) plane.

Since a CoO₂ layer is relatively stable, the (001) plane where the CoO₂ layer exists in a surface is relatively stable. A main diffusion path of lithium ions in charge and discharge is not exposed at the (001) plane.

By contrast, a diffusion path of lithium ions is exposed at a surface having an orientation other than a (001) orientation. Thus, the surface with an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100 is maintained.

Accordingly, in the positive electrode active material 100 of another embodiment of the present invention, it is important that the plane other than (001) and the surface portion 100a thereof have distribution of the additive element A as illustrated in FIG. 14C or FIG. 14D. By contrast, in the (001) plane and the surface portion 100a thereof, the concentration of the additive element A may be low as described above or the additive element A may be absent.

By a formation method in which high-purity LiCoO₂ is formed, the additive element A is mixed afterwards, and heating is performed, the additive element A spreads mainly via a diffusion path of lithium ions. Thus, distribution of the additive element A at the plane other than (001) and the surface portion 100a thereof can easily fall within a preferred range.

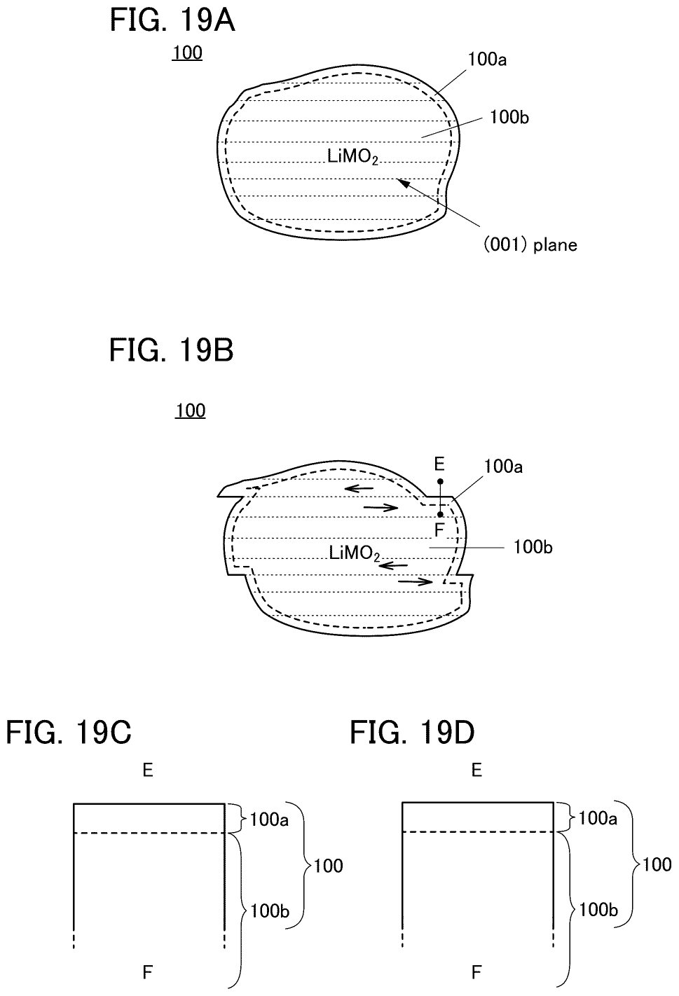

The positive electrode active material 100 preferably has a smooth surface with little unevenness; however, it is not necessary that the entire positive electrode active material 100 be in such a state. In a composite oxide having a layered rock-salt crystal structure belonging to R-3m, slipping easily occurs at a plane parallel to the (001) plane, e.g., a plane where lithium atoms are arranged. In the case where a (001) plane exists as illustrated in FIG. 19A, for example, steps such as pressing sometimes cause slipping in a direction parallel to the (001) plane as denoted by arrows in FIG. 19B, resulting in deformation.

In that case, at a surface newly formed as a result of slipping and the surface portion 100a thereof, the additive element A is not present or present at a concentration lower than or equal to the lower detection limit in some cases. The line E-F in FIG. 19B denotes examples of the surface newly formed as a result of slipping and the surface portion 100a thereof. FIG. 19C and FIG. 19D illustrate enlarged views of the vicinity of the line E-F. In FIG. 19C and FIG. 19D, unlike in FIG. 14C to FIG. 14F, there is neither distribution of the additive element X nor that of the additive element Y.

However, because slipping easily occurs parallel to the (001) plane, the newly formed surface and the surface portion 100a thereof easily have a (001) orientation. In that case, since a diffusion path of lithium ions is not exposed and is relatively stable, substantially no problem is caused even when the additive element A does not exist or the concentration is lower than or equal to the lower detection limit.

Note that as described above, in a composite oxide whose composition is LiCoO₂ and which has a layered rock-salt crystal structure belonging to R-3m, cobalt atoms are arranged parallel to the (001) plane. In a HAADF-STEM image, the luminance of cobalt, which has the largest atom number in LiCoO₂, is the highest. Thus, in a HAADF-STEM image, arrangement of atoms with high luminance can be regarded as arrangement of cobalt atoms. Repetition of such arrangement with high luminance can be rephrased as crystal fringes or lattice fringes.

### <Crystal Grain Boundary>>

It is further preferable that the additive element A contained in the positive electrode active material 100 of one embodiment of the present invention be distributed as described above and unevenly distributed at least partly at the crystal grain boundary 101 and the vicinity thereof.

Note that in this specification and the like, uneven distribution means that the concentration of an element in a certain region differs from that in another region. It can be rephrased as segregation, precipitation, unevenness, deviation, or a mixed area with a high concentration and a low concentration.

For example, the magnesium concentration in the crystal grain boundary 101 and its vicinity of the positive electrode active material 100 is preferably higher than that in the other regions in the bulk 100b. In addition, the fluorine concentration at the crystal grain boundary 101 and the vicinity thereof is preferably higher than that in the other regions in the bulk 100b. In addition, the nickel concentration at the crystal grain boundary 101 and the vicinity thereof is preferably higher than that in the other regions in the bulk 100b. In addition, the aluminum concentration at the crystal grain boundary 101 and the vicinity thereof is preferably higher than that in the other regions in the bulk 100b.

The crystal grain boundary 101 is a type of plane defect. Thus, the crystal grain boundary tends to be unstable and the crystal structure easily starts to change like the surface of the particle. Therefore, the higher the concentration of the additive element A in the crystal grain boundary 101 and its vicinity is, the more effectively the change in the crystal structure can be inhibited.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

### {Particle Diameter}

Too large a particle diameter of the positive electrode active material 100 of one embodiment of the present invention causes problems such as difficulty in lithium diffusion and too much surface roughness of an active material layer in coating to a current collector. By contrast, too small a particle diameter causes problems such as difficulty in loading of the active material layer in coating to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

### {Analysis Method}

Whether or not a given positive electrode active material is the positive electrode active material 100 of one embodiment of the present invention, which has the O3′ type crystal structure when x in LiₓCoO₂ is small, can be determined by analyzing a positive electrode including the positive electrode active material with small x in LiₓCoO₂ using an XRD pattern, an electron diffraction pattern, a neutron diffraction pattern, an ESR (Electron Spin Resonance) spectrum, an NMR (Nuclear Magnetic Resonance) spectrum, or the like.

An XRD pattern is particularly preferable because the symmetry of the transition metal M such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example. A diffraction peak reflecting the crystal structure of the bulk 100b of the positive electrode active material 100, which accounts for the majority of the volume of the positive electrode active material 100, is obtained through an XRD pattern, in particular, a powder XRD pattern.

As described above, the positive electrode active material 100 of one embodiment of the present invention has a feature of a small change in the crystal structure between when x in LiₓCoO₂ is 1 and when x is less than or equal to 0.24. In the case where the material whose crystal structure largely changes occupies 50% or more when high-voltage charge is performed, the material is not preferable because the positive electrode active material cannot withstand high-voltage charge and discharge.

It should be noted that the O3′ type crystal structure is not obtained in some cases only by addition of the additive element A. For example, when x in LiₓCoO₂ is less than or equal to 0.24, lithium cobalt oxide containing magnesium and fluorine or lithium cobalt oxide containing magnesium and aluminum has the O3′ type crystal structure at 50% or more in some cases, and has the H1-3 type crystal structure at 50% or more in other cases, depending on the concentration and distribution of the additive element A.

In addition, in the case where x is too small, e.g., 0.1 or less, or under the condition where charge voltage is higher than 4.9 V, the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure such as XRD pattern analysis and data such as charge capacity (quantity of electricity charged) or charge voltage.

A positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

Whether the distribution of the additive element A contained in a given positive electrode active material is in the above-described state can be determined by, for example, analysis using XPS, energy dispersive X-ray spectroscopy (EDX), EPMA (Electron Probe Microan Alysis), or the like.

The crystal structure of the surface portion 100a, the crystal grain boundary 101, or the like can be analyzed by an electron diffraction pattern of a cross section of the positive electrode active material 100, for example.

### <Charging Method>>

Whether or not a certain composite oxide is the positive electrode active material 100 of one embodiment of the present invention can be determined by high-voltage charge. For example, the high-voltage charge is performed on a coin cell (CR2032 type with a diameter of 20 mm and a height of 3.2 mm) formed using the composite oxide for a positive electrode and a lithium counter electrode for a negative electrode.

More specifically, a positive electrode can be formed by application of slurry in which the positive electrode active material, a conductive material, and a binder are mixed into a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is subjected to constant current charge at a current value of 10 mA/g to a freely selected voltage (e.g., 4.5 V, 4.55 V, 4.6 V, 4.65 V, 4.7 V, 4.75 V, or 4.8 V). To observe a phase change of the positive electrode active material, charge with such a small current value is desirably performed. The temperature is set to 25° C. or 45° C. After the charge is performed in this manner, the coin cell is disassembled in a glove box with an argon atmosphere to take out the positive electrode, whereby the positive electrode active material in a given charged state can be obtained. In order to inhibit a reaction with components in the external environment, the positive electrode is preferably enclosed in an argon atmosphere in performing various analyses later. For example, XRD pattern measurement can be performed on the positive electrode active material enclosed in an airtight container with an argon atmosphere. After charge is completed, the positive electrode is preferably taken out immediately and subjected to the analysis. Specifically, the positive electrode is subjected to the analysis preferably within an hour, further preferably within 30 minutes after the completion of charge.

In the case where the crystal structure in a charged state after charge and discharge are performed multiple times is analyzed, the conditions of the charge and discharge which are performed multiple times may be different from the above-described charge conditions. For example, as the charge, constant current charge to a freely selected voltage (e.g., 4.6 V, 4.65 V, 4.7 V, 4.75 V, or 4.8 V) at a current value of 100 mA/g can be performed and then constant voltage charge can be performed until the current value becomes 10 mA/g, and as the discharge, constant current discharge can be performed at 2.5 V and 100 mA/g.

Also in the case where the crystal structure in a discharged state after charge and discharge are performed multiple times is analyzed, constant current discharge can be performed at 2.5 V and a current value of 100 mA/g, for example.

### <XRD>>

The apparatus and conditions for measuring the XRD pattern are not particularly limited as long as appropriate adjustment and calibration are performed. The measurement can be performed with the apparatus and conditions as described below, for example.
XRD apparatus: D8 ADVANCE produced by Bruker AXS
X-ray source: Cu
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm
   As a standard sample used for the adjustment and calibration, NIST (a standard sintered alumina plate SRM 1976 from National Institute of Standards and Technology) can be used, for example.

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

Characteristic X-rays may be monochromatized with the use of a filter or the like or may be monochromatized with XRD data analysis software after an XRD diffraction pattern is obtained. For example, a peak due to CuKa₂ radiation can be eliminated and only a peak due to CuKa₁ radiation can be extracted by using DEFFRAC.EVA (XRD data analysis software produced by Bruker Corporation). This software can also be used to eliminate the background, for example.

In this specification and the like, the value of 20 of a diffraction peak refers to the value of 20 that appears at the peak top of the diffraction peak in the XRD pattern after the calculation model is fitted. There is no particular limitation on the crystal structure analysis software used for the fitting; for example, it is possible to use TOPAS ver. 3 (crystal structure analysis software produced by Bruker Corporation).

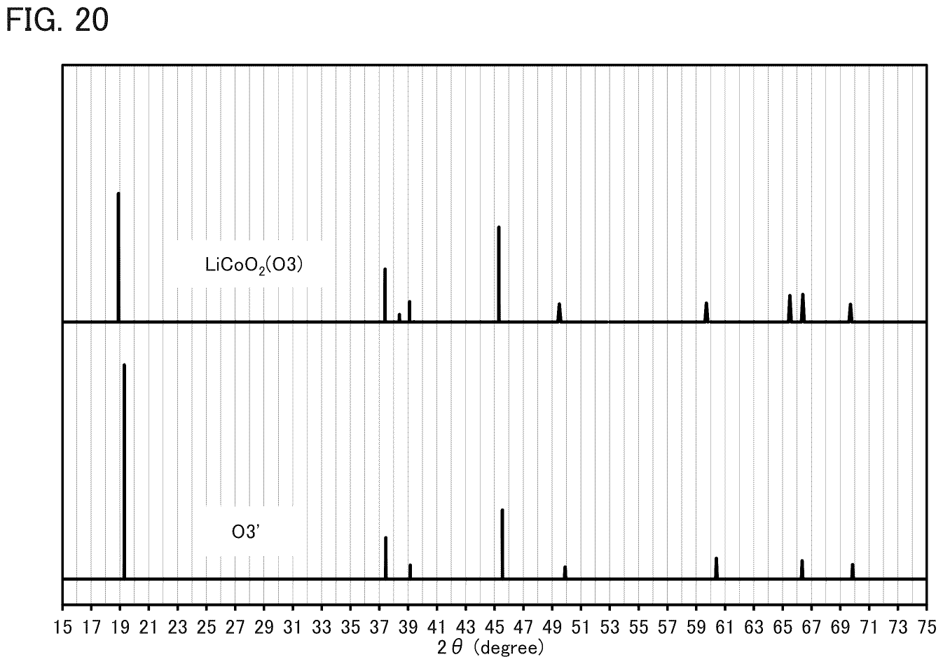

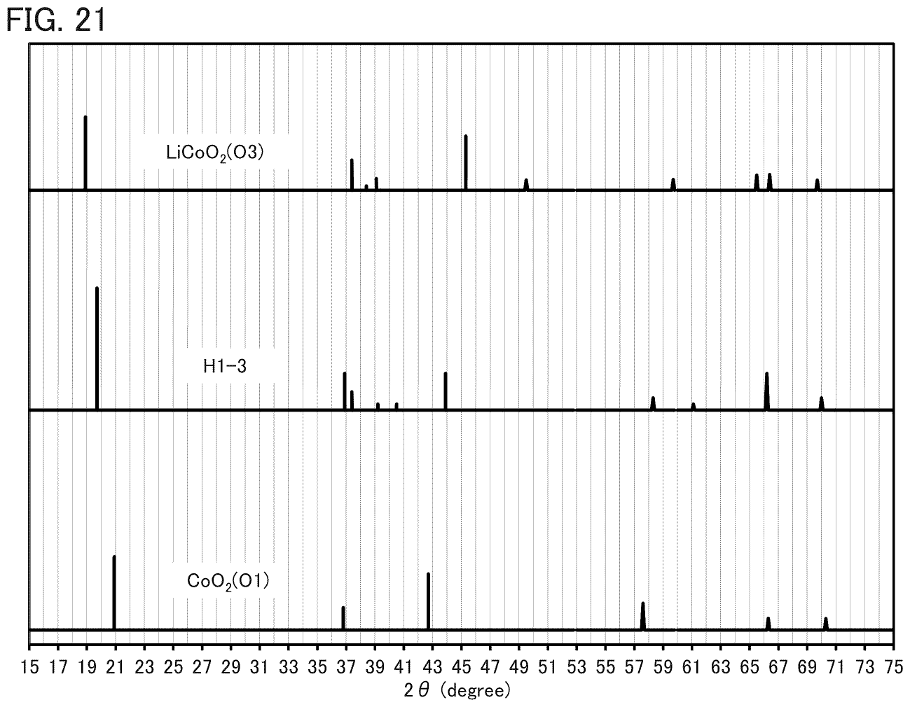

FIG. 20 and FIG. 21 show ideal powder XRD patterns with CuKα1 radiation that are calculated from models of the O3′ type crystal structure and the H1-3 type crystal structure. For comparison, ideal XRD patterns calculated from the crystal structure of LiCoO₂ O3 with x in LixCoO₂ of 1, the crystal structure of the H1-3 type, and the crystal structure of the trigonal O1 with x of 0 are also shown. Note that the patterns of LiCoO₂ (O3) and CoO₂ (O1) are made from crystal structure data obtained from the ICSD (Inorganic Crystal Structure Database) (see Non-Patent Document 3) with Reflex Powder Diffraction, which is a module of Materials Studio (BIOVIA). The range of 2θ is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 2. The O3′ type crystal structure is estimated from the XRD pattern of the positive electrode active material of one embodiment of the present invention, the crystal structure is fitted with TOPAS Ver. 3, and the XRD pattern of the O3′ type crystal structure is made in a manner similar to that for other structures.

As shown in FIG. 20, the O3′ type crystal structure exhibits diffraction peaks at 2θ of 19.25±0.12° (greater than or equal to 19.13° and less than 19.37°) and 2θ of 45.47±0.10° (greater than or equal to 45.37° and less than 45.57°).

However, as shown in FIG. 21, the H1-3 type crystal structure and the trigonal O1 do not exhibit peaks at these positions. Thus, the peaks at 2θ of 19.25±0.12° (greater than or equal to 19.13° and less than 19.37°) and 2θ of 45.47±0.10° (greater than or equal to 45.37° and less than 45.57°) exhibited in a state where x in LixCoO₂ is small can be the features of the positive electrode active material 100 of one embodiment of the present invention.

It can be said that the positions of the XRD pattern diffraction peaks exhibited by the crystal structure with x being 1 and the crystal structure with x being 0.24 or less are close to each other. More specifically, it can be said that a difference in 2θ between the main diffraction peak exhibited by the crystal structure with x being 1 and the main diffraction peak exhibited by the crystal structure with x being 0.24 or less, which are exhibited at 2θ of greater than or equal to 42° and less than or equal to 46°, is 0.7° or less, preferably 0.5° or less.

Although the positive electrode active material 100 of one embodiment of the present invention has the O3′ type crystal structure when x in LixCoO₂ is small, not all the positive electrode active material 100 necessarily have the O3′ type crystal structure. The positive electrode active material 100 may have another crystal structure or may be partly amorphous. Note that when the XRD patterns are subjected to the Rietveld analysis, the O3′ type crystal structure preferably accounts for greater than or equal to 50%, further preferably greater than or equal to 60%, still further preferably greater than or equal to 66%. The positive electrode active material in which the O3′ type crystal structure accounts for greater than or equal to 50%, preferably greater than or equal to 60%, further preferably greater than or equal to 66% enables sufficiently good cycle performance.

Furthermore, even after 100 or more cycles of charge and discharge after the measurement starts, the O3′ type crystal structure preferably accounts for more than or equal to 35%, further preferably more than or equal to 40%, still further preferably more than or equal to 43% when the Rietveld analysis is performed.

For Rietveld analysis, the analysis program RIETAN-FP (see Non-Patent Document 4) can be used, for example.

Sharpness of a diffraction peak in an XRD pattern indicates the degree of crystallinity. It is thus preferable that the diffraction peaks after charge be sharp, in other words, have a small half width. Even peaks that are derived from the same crystal phase have different half widths depending on the XRD pattern measurement conditions or the 2θ value. In the case of the above-described measurement conditions, the peak observed at 2θ of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. Such high crystallinity sufficiently contributes to stability of the crystal structure after charge.

The crystallite size of the O3′ type crystal structure included in the positive electrode active material 100 does not decrease to less than approximately 1/20 that of LiCoO₂ (O3) in a discharged state. Thus, a clear peak of the O3′ type crystal structure can be observed when x in LiₓCoO₂ is small, even under the same XRD pattern measurement conditions as those of a positive electrode before the charge and discharge. By contrast, conventional LiCoO₂ has a small crystallite size and a broad and small peak even when it can have a structure part of which is similar to the O3′ type crystal structure. The crystallite size can be calculated from the half width of the XRD pattern peak.

### <<XPS>>

In an inorganic oxide, a region ranging from the surface to a depth of approximately 2 nm to 8 nm (typified by less than or equal to 5 nm) can be analyzed by XPS using monochromatic aluminum Kα radiation as an X-ray source; thus, the concentrations of elements in a region ranging to approximately half the depth of the surface portion 100a can be quantitatively analyzed. The bonding states of the elements can be analyzed by narrow scanning. Note that the quantitative accuracy of XPS is approximately ±1 atomic % in many cases, and the lower detection limit is approximately 1 atomic % but depends on the element.

In the positive electrode active material 100 of one embodiment of the present invention, the concentration of one or two or more selected from the additive elements A is preferably higher in the surface portion 100a than in the bulk 100b. This means that the concentration of one or two or more selected from the additive elements A included in the surface portion 100a is preferably higher than the average concentration of the selected element(s) in the entire positive electrode active material 100. For this reason, for example, it can be said that the concentration of one or more additive elements A selected from the surface portion 100a, which is measured by XPS or the like, is preferably higher than the average concentration of the additive element(s) A in the entire positive electrode active material 100, which is measured by ICP-MS, GD-MS, or the like. For example, the concentration of magnesium of at least part of the surface portion 100a, which is measured by XPS or the like, is preferably higher than the concentration of magnesium in the entire positive electrode active material 100. The concentration of nickel of at least part of the surface portion 100a is preferably higher than the average concentration of nickel of the entire positive electrode active material 100. The concentration of aluminum of at least part of the surface portion 100a is preferably higher than the average concentration of aluminum of the entire positive electrode active material 100. The concentration of fluorine of at least part of the surface portion 100a is preferably higher than the average concentration of fluorine of the entire positive electrode active material 100.

Note that the surface and the surface portion 100a of the positive electrode active material 100 of one embodiment of the present invention do not contain carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element A is not easily dissolved even in that case; thus, the atomic ratio of the additive element A is not affected.

The concentration of the additive element A may be compared using the ratio of the additive element A to cobalt. The use of the ratio of the additive element A to cobalt is preferable because it enables comparison while reducing the influence of a carbonate or the like which is chemically adsorbed after formation of the positive electrode active material. For example, in the XPS analysis, the atomic ratio of magnesium to cobalt (Mg/Co) is preferably greater than or equal to 0.4 and less than or equal to 1.5. In the ICP-MS analysis, Mg/Co is preferably greater than or equal to 0.001 and less than or equal to 0.06.

Similarly, in the surface portion 100a of the positive electrode active material 100, the concentrations of lithium and cobalt are preferably higher than that of the additive elements A so that sufficient paths through lithium is inserted and extracted are ensured. It can be said that the concentrations of lithium and cobalt in the surface portion 100a are preferably higher than the concentration of one or two or more additive elements A selected from the additive elements A contained in the surface portion 100a, which is measured by XPS or the like. For example, the concentration of cobalt in at least part of the surface portion 100a measured by XPS or the like is preferably higher than the concentration of magnesium in at least part of the surface portion 100a measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than that of aluminum. Similarly, the concentration of lithium is preferably higher than the concentration of aluminum. The concentration of cobalt is preferably higher than that of fluorine. Similarly, the concentration of lithium is preferably higher than that of fluorine.

It is further preferable that the additive element Y such as aluminum be widely distributed in a deep region, e.g., a region ranging from a depth from the surface of 5 nm to a depth from the surface of 50 nm. Therefore, the additive element Y such as aluminum is preferably detected by analysis on the entire positive electrode active material 100 by ICP-MS, GD-MS, or the like, but the concentration is preferably lower than or equal to the lower detection limit in XPS or the like.

When XPS analysis is performed on the positive electrode active material 100 of one embodiment of the present invention, the number of magnesium atoms is preferably 0.4 times or more and 1.2 times or less, further preferably 0.65 times or more and 1.0 times or less the number of cobalt atoms. The number of nickel atoms is preferably 0.15 times or less, further preferably 0.03 times or more and 0.13 times or less the number of cobalt atoms. The number of aluminum atoms is preferably 0.12 times or less, further preferably 0.09 times or less the number of cobalt atoms. The number of fluorine atoms is preferably 0.3 times or more and 0.9 times or less, further preferably 0.1 times or more and 1.1 times or less the number of cobalt atoms.

In the XPS analysis, monochromatic aluminum Kα radiation can be used as an X-ray source, for example. An extraction angle is, for example, 45°. For example, the measurement can be performed using the following apparatus and conditions.
Measurement device: Quantera II produced by PHI, Inc.
X-ray source: monochromatic Al Kα (1486.6 eV)
Detection area: 100 μmϕ
Detection depth: approximately 4-5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably at approximately 684.3 eV. The above value is different from 685 eV, which is the bonding energy of lithium fluoride, and 686 eV, which is the bonding energy of magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to a value of the bonding energy of magnesium oxide.

### <<EDX>>

The one or more selected from the additive elements A contained in the positive electrode active material 100 preferably have a concentration gradient. It is further preferable that the additive elements A contained in the positive electrode active material 100 exhibit concentration peaks at different depths from the surface. The concentration gradient of the additive element A can be evaluated by exposing a cross section of the positive electrode active material 100 using an FIB or the like and analyzing the cross section using EDX, EPMA, or the like.

In the EDX measurement, to measure a region while scanning is performed and evaluate the region two-dimensionally is referred to as EDX analysis. The measurement by line scan, which is performed to evaluate the atomic concentration distribution in a positive electrode active material, is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element A in the surface portion 100a, the bulk 100b, the vicinity of the crystal grain boundary 101, and the like of the positive electrode active material 100 can be semi-quantitatively analyzed. By EDX line analysis, the concentration distribution and the highest concentration of the additive element A can be analyzed. An analysis method using a thinned sample, such as STEM-EDX, is preferred because the method makes it possible to analyze the concentration distribution in the depth direction from the surface toward the center in a specific region of a positive electrode active material without effect of the distribution in the front-back direction.

EDX area analysis or EDX point analysis of the positive electrode active material 100 of one embodiment of the present invention preferably reveals that the concentration of each additive element A, in particular, the additive element X in the surface portion 100a is higher than that in the bulk 100b.

For example, when EDX area analysis or EDX point analysis of the positive electrode active material 100 containing magnesium as the additive element X is conducted, the magnesium concentration in the surface portion 100a is preferably higher than the magnesium concentration in the bulk 100b. Furthermore, when EDX linear analysis is conducted, a peak of the magnesium concentration in the surface portion 100a preferably exists in a region from the surface of the positive electrode active material 100 to a depth of 3 nm toward the center, further preferably to a depth of 1 nm, and still further preferably to a depth of 0.5 nm. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a “peak of concentration” refers to the local maximum value of concentration.

In the positive electrode active material 100 containing magnesium and fluorine as the additive elements X, the distribution of fluorine preferably overlaps with the distribution of magnesium. For example, a difference in the depth direction between a peak of the fluorine concentration and a peak of the magnesium concentration is preferably within 10 nm, further preferably within 3 nm, still further preferably within 1 nm.

Thus, in the EDX line analysis, a peak of the fluorine concentration in the surface portion 100a preferably appears in a region from the surface of the positive electrode active material 100 to a depth of 3 nm, further preferably to a depth of 1 nm, still further preferably to a depth of 0.5 nm toward the center. It is further preferable that a peak of the fluorine concentration be exhibited slightly closer to the surface than a peak of the magnesium concentration is, which increases resistance to hydrofluoric acid. For example, it is preferable that a peak of the fluorine concentration be exhibited slightly closer to the surface than a peak of the magnesium concentration is by 0.5 nm or more, further preferably 1.5 nm or more.

In the positive electrode active material 100 containing nickel as the additive element X, a peak of the nickel concentration in the surface portion 100a preferably appears in a region from the surface of the positive electrode active material 100 to a depth of 3 nm, further preferably to a depth of 1 nm, still further preferably to a depth of 0.5 nm toward the center. When the positive electrode active material 100 contains magnesium and nickel, the distribution of nickel preferably overlaps with the distribution of magnesium. For example, a difference in the depth direction between a peak of the nickel concentration and a peak of the magnesium concentration is preferably within 10 nm, further preferably within 3 nm, still further preferably within 1 nm.

In the case where the positive electrode active material 100 contains aluminum as the additive element Y, the peak of the magnesium concentration, the nickel concentration, or the fluorine concentration is preferably closer to the surface than the peak of the aluminum concentration in the surface portion 100a in the EDX line analysis. For example, the peak of the aluminum concentration preferably appears in a region ranging, toward the center of the positive electrode active material 100, from a depth from the surface of 0.5 nm to a depth from the surface of 50 nm, further preferably from a depth from the surface of 5 nm to a depth from the surface of 50 nm.

EDX line, area, or point analysis of the positive electrode active material 100 preferably reveals that the atomic ratio of magnesium Mg to cobalt Co (Mg/Co) at a peak of the magnesium concentration is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the aluminum concentration is preferably greater than or equal to 0.05 and less than or equal to 0.6, further preferably greater than or equal to 0.1 and less than or equal to 0.45. The atomic ratio of nickel Ni to cobalt Co (Ni/Co) at a peak of the nickel concentration is preferably greater than or equal to 0 and less than or equal to 0.2, further preferably greater than or equal to 0.01 and less than or equal to 0.1. The atomic ratio of fluorine F to cobalt Co (F/Co) at a peak of the fluorine concentration is preferably greater than or equal to 0 and less than or equal to 1.6, further preferably greater than or equal to 0.1 and less than or equal to 1.4.

According to results of the EDX line analysis, where the surface of the positive electrode active material 100 is can be estimated in the following manner, for example. A point where the detected amount of an element which uniformly exists in the bulk 100b of the positive electrode active material 100, e.g., oxygen or cobalt, is ½ of the detected amount thereof in the bulk 100b is assumed to be the surface.

Since the positive electrode active material 100 is a composite oxide, the detected amount of oxygen can be used to estimate where the surface is. Specifically, an average value Oₐᵥₑ of the oxygen concentration in a region of the bulk 100b where the detected amount of oxygen is stable is calculated first. At this time, in the case where oxygen O_{background} which is probably led from chemical adsorption or the background is detected in a region that is obviously outside the surface, O_{background} can be subtracted from the measurement value to obtain the average value Oₐᵥₑ of the oxygen concentration. The measurement point where the measurement value which is closest to ½ of the average value Oₐᵥₑ, i.e., ½Oₐᵥₑ, is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is less likely to be affected by chemical adsorption and is thus suitable for estimating where the surface is.

When the line analysis or the area analysis is performed on the positive electrode active material 100, the atomic ratio of the additive element A to cobalt Co (A/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the linear analysis or area planar analysis is performed on the positive electrode active material 100 containing magnesium as the additive element X, the atomic ratio of magnesium to cobalt (Mg/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

### <<EPMA>>

Quantitative analysis of elements can be conducted also by EPMA. In area analysis, distribution of each element can be analyzed.

EPMA area analysis of a cross section of the positive electrode active material 100 of one embodiment of the present invention preferably reveals that one or two or more selected from the additive elements A have a concentration gradient, as in the EDX analysis results. For example, it is further preferable that the additive elements A exhibit concentration peaks at different depths from a surface. The preferred ranges of the concentration peaks of the additive elements A are the same as those of the case of EDX.

Note that in EPMA, a region from a surface to a depth of approximately 1 μm is analyzed. Thus, the quantitative value of each element is sometimes different from measurement results obtained by other analysis methods. For example, when area analysis is performed by EPMA on the positive electrode active material 100, the concentrations of the additive elements A present in the surface portion 100a might be lower than the results obtained in XPS.

<Charge Curve and dQ/dV Curve>>

The positive electrode active material 100 of one embodiment of the present invention sometimes shows a characteristic voltage change along with charge. A voltage change can be read from a dQ/dV curve, which can be obtained by differentiating capacitance (Q) in a charge curve with voltage (V) (dQ/dV). There should be an unbalanced phase change and a significant change in the crystal structure between before and after a peak in the dQ/dV curve. Note that in this specification and the like, an unbalanced phase change refers to a phenomenon that causes a nonlinear change in physical quantity.

The positive electrode active material 100 of one embodiment of the present invention sometimes shows a broad peak at around 4.55 V in a dQ/dV curve. The peak at around 4.55 V reflects a change in voltage at the time of the phase change from the O3 type structure to the O3′ type structure. This means that when this peak is broad, a change in the energy necessary for extraction of lithium is smaller or in other words, a change in the crystal structure is smaller, than when the peak is sharp. These changes are preferably small, in which case the influence of a shift in CoO₂ layers and that of a change in volume are little.

Specifically, when the maximum value appearing at greater than or equal to 4.5 V and less than or equal to 4.6 V in a dQ/dV curve of a charge curve is a first peak, the first peak preferably has a full width at half maximum of greater than or equal to 0.10 V to be sufficiently broad. In this specification and the like, the half width of the first peak refers to the difference between HWHM₁ and HWHM₂, where HWHM₁ is an average value of the first peak and a first minimum value, which is the minimum dQ/dV value appearing at greater than or equal to 4.3 V and less than or equal to 4.5 V, and HWHM₂ is an average value of the first peak and a second minimum value, which is the minimum dQ/dV value appearing at greater than or equal to 4.6 V and less than or equal to 4.8 V.

The charge at the time of obtaining a dQ/dV curve can be, for example, constant current charge to 4.9 V at 10 mA/g. In obtaining a dQ/dV value of the initial charge, the above charge is preferably started after discharge to 2.5 V at 100 mA/g before measurement.

Data acquisition at the time of charge can be performed in the following manner, for example: a voltage and a current are acquired at intervals of 1 second or at every 1-mV voltage change. The value obtained by adding the current value and time is charge capacity (quantity of electricity charged).

The difference between the n-th data and the n+1-th data of the above charge capacity (quantity of electricity charged) is the n-th value of a capacity change dQ. Similarly, the difference between the n-th data and the n+1-th data of the above voltage is the n-th value of a voltage change dV.

Note that minute noise has considerable influence when the above data is used; thus, the dQ/dV value may be calculated from the moving average for a certain number of class intervals of the differences in the voltage and the moving average for a certain number of class intervals of the differences in the charge capacity (quantity of electricity charged). The number of class intervals can be 500, for example.

Specifically, the average value of the n-th to n+500-th dQ values is calculated and in a similar manner, the average value of the n-th to n+500-th dV values is calculated. The dQ/dV value can be dQ (the average of 500 dQ values)/dV (the average of 500 dV values). In a similar manner, the moving average value of the 500 class intervals can be used for the voltage on the horizontal axis of a dQ/dV graph. In the case where the above-described moving average value of the 500 class intervals is used, the 501^{st} data from the last to the last data are largely influenced by noise and thus are not preferably used for the dQ/dV graph.

In the case where a dQ/dV curve after charge and discharge are performed multiple times is analyzed, the conditions of the charge and discharge performed multiple times may be different from the above-described charge conditions. For example, the charge can be performed in the following manner: constant current charge is performed at 100 mA/g to a freely selected voltage (e.g., 4.6 V, 4.65 V, 4.7 V, 4.75 V, or 4.8 V) and then, constant voltage charge is performed until the current value becomes 10 mA/g. As the discharge, constant current discharge can be performed at 2.5 V and 100 mA/g.

Note that the O3 type structure at the time of the phase change to the O3′ type structure at around 4.55 V has x in LixCoO₂ of approximately 0.3. This O3 type structure has the same symmetry as the O3 type structure with x of 1 illustrated in FIG. 17, but is slightly different in the distance between the CoO₂ layers. In this specification and the like, when O3 type structures with different x are distinguished from each other, the O3 type structure with x of 1 is referred to as O3 (2θ=18.85) and the O3 type structure with x of approximately 0.3 is referred to as O3 (2θ=18.57). This is because the position of the peak appearing at 2θ of approximately 19° in XRD pattern measurement corresponds to the distance between the CoO₂ layers.

<Discharge Curve and dQ/dV Curve>>

Moreover, when the positive electrode active material 100 of one embodiment of the present invention is discharged at a low current of, for example, 40 mA/g or lower after high-voltage charge, a characteristic change in voltage appears just before the end of discharge, in some cases. This change can be clearly observed by the fact that at least one peak appears within the range to 3.5 V at a voltage lower than that of a peak which appears around 3.9 V in dQ/dV calculated from a discharge curve.

### <<ESR>>

The positive electrode active material 100 of one embodiment of the present invention preferably contains cobalt, and nickel and magnesium as the additive elements A. It is preferable that Ni³⁺ be substituted for part of Co³⁺ and Mg²⁺ be substituted for part of Li⁺ accordingly. Accompanying the substitution of Mg²⁺ for Li⁺, the Ni³⁺ might be reduced to be Ni²⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material 100 of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material 100 is preferably greater than or equal to 2.0×10¹⁷ spins/g and less than or equal to 1.0×10²¹ spins/g. The positive electrode active material 100 preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of the positive electrode active material can be analyzed using an ESR spectrum or the like, for example.

### <<Surface Roughness and Specific Surface Area>>

The positive electrode active material 100 of one embodiment of the present invention preferably has a smooth surface with little unevenness. A smooth surface with little unevenness indicates that a fusing agent described later adequately functions and the surfaces of the additive element A source and the composite oxide melt. Thus, it is one indication for favorable distribution of the additive element A in the surface portion 100a. Favorable distribution means that the concentration distribution of the additive element A is uniform in the surface portion 100a, for example.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface (RMS) roughness is obtained by calculating standard deviation. This surface roughness refers to the surface roughness of part of the particle periphery (at least 400 nm) of the positive electrode active material.

On the surface of the particle of the positive electrode active material 100 described in this embodiment, root-mean-square (RMS) surface roughness, which is an index of roughness, is preferably root-mean-square surface (RMS) roughness less than 3 nm, further preferably less than 1 nm, still further preferably less than 0.5 nm.

Note that the image processing software used for the noise processing, the interface extraction, or the like is not particularly limited, and for example, “ImageJ” described in Non-Patent Document 5 to Non-Patent Document 7 can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area SR measured by a constant-volume gas adsorption method to an ideal specific surface area Sᵢ.

The ideal specific surface area Sᵢ is calculated on the assumption that all the positive electrode active materials have the same diameter as the median diameter (D50), have the same weight, and have ideal spherical shapes.

The median diameter (D50) can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area SR to the ideal specific surface area Sᵢ obtained from the median diameter (D50), S_{R}/Sᵢ, is preferably less than or equal to 2.1.

The level of the surface smoothness of the positive electrode active material 100 can be quantified from its cross-sectional SEM image by the following method, for example.

First, a surface SEM image of the positive electrode active material 100 is taken. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., “ImageJ”). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The value is referred to as a grayscale value. By obtaining such a grayscale value, the unevenness of the positive electrode active material can be evaluated quantitatively.

In addition, a variation in luminance in a target region can also be represented with a histogram. Here, a histogram is a graph showing frequency distribution of luminance in a target region and is also referred to as a luminance histogram. A luminance histogram enables visually easy-to-understand evaluation of unevenness of the positive electrode active material.

In the positive electrode active material 100 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <Current-Rest-Method>>

The distribution of the additive element A contained in the surface portion of the positive electrode active material 100 of one embodiment of the present invention, such as magnesium, sometimes slightly changes during repeated charge and discharge. For example, in some cases, the distribution of the additive element A becomes more favorable, so that the electric resistance decreases. Thus, in some cases, the electric resistance, i.e., a resistance component R (0.1 s) with a high response speed measured by a current-rest-method, decreases at the initial stage of the charge and discharge cycles.

For example, when the n-th (n is an integer greater than or equal to 2) charge and the n+1-th charge are compared, the resistance component R (0.1 s) with a high response speed measured by a current-rest-method is lower in the n+1-th charge than in the n-th charge. Accordingly, the n+1-th discharge capacity is higher than the n-th discharge capacity in some cases. Also in the case of a positive electrode active material that does not contain any additive element, the second discharge capacity can be higher when the second charge and the initial charge are compared, i.e., n=1; thus, n is preferably greater than or equal to 2 and less than or equal to 10, for example. However, n is not limited to the above for the initial stage of the charge and discharge cycles. The stage where the discharge capacity is substantially the same as the rated capacity or is greater than or equal to 97% of the rated capacity can be regarded as the initial stage of the charge and discharge cycles.

### {Other Features}

The other features of the positive electrode active material of one embodiment of the present invention will be described.

The positive electrode active material 100 may include a coating portion. The coating portion does not necessarily cover the entire positive electrode active material. The coating portion is an inorganic compound formed at the time of forming the positive electrode active material in some cases, or is formed by deposition of a decomposition product of an electrolyte and an organic electrolyte solution due to charge and discharge in other cases.

In the case where the coating portion contains the decomposition product of the electrolyte and the organic electrolyte solution, the coating portion preferably contains carbon, oxygen, and fluorine. The coating film can have high quality easily when part of the electrolyte solution contains at least one of LiBOB and SUN (suberonitrile), for example. Accordingly, the coating portion containing one or two or more selected from boron, nitrogen, sulfur, and fluorine is preferable because it can be a high-quality coating film in some cases.

The positive electrode active material 100 has a depression, a crack, a concave, a V-shaped cross section, or the like in some cases. These are examples of defects, and when charge and discharge are repeated, dissolution of the transition metal M, breakage of a crystal structure, cracking of the positive electrode active material 100, extraction of oxygen, or the like might be derived from these defects. However, when there is the filling portion 102 illustrated in FIG. 14B that fills such defects, dissolution of the transition metal M or the like can be inhibited. Thus, the positive electrode active material 100 can have high reliability and enables excellent cycle performance.

The positive electrode active material 100 may include the projection 103 as illustrated in FIG. 14B, which is a region where the additive element A is unevenly distributed.

As described above, an excessive amount of the additive element A contained in the positive electrode active material 100 might adversely affect insertion and extraction of lithium. The use of such a positive electrode active material 100 for a secondary battery might cause an internal resistance increase, a discharge capacity decrease, and the like. Meanwhile, when the amount of the additive element A is insufficient, the additive element A is not distributed throughout the surface portion 100a, which might diminish the effect of inhibiting degradation of a crystal structure. The additive element A is thus required to be contained in the positive electrode active material 100 at an appropriate concentration; however, the adjustment of the concentration is not easy.

For this reason, when the positive electrode active material 100 includes the region where the additive element A is unevenly distributed, part of the excess additive element A is removed from the bulk 100b of the positive electrode active material 100, so that the concentration of the additive element A can be appropriate in the bulk 100b. This can inhibit an internal resistance increase, a discharge capacity decrease, and the like when a secondary battery is fabricated. A feature of inhibiting an internal resistance increase in a secondary battery is extremely preferable especially in charge and discharge with a large amount of current such as charge and discharge at 400 mA/g or more.

In the positive electrode active material 100 including the region where the additive element A is unevenly distributed, addition of the excess additive element A to some extent in the formation process is acceptable. This is preferable because the margin of production can be increased.

When a positive electrode active material undergoes charge and discharge under conditions, including charge at 4.5 V or more, or at a high temperature, e.g., 45° C. or higher, a progressive defect that progresses deeply from the surface toward the inner portion might be generated. Progress of a defect in a positive electrode active material to form a hole can be referred to as pitting corrosion, and the hole generated by this phenomenon is also referred to as a pit in this specification and the like.

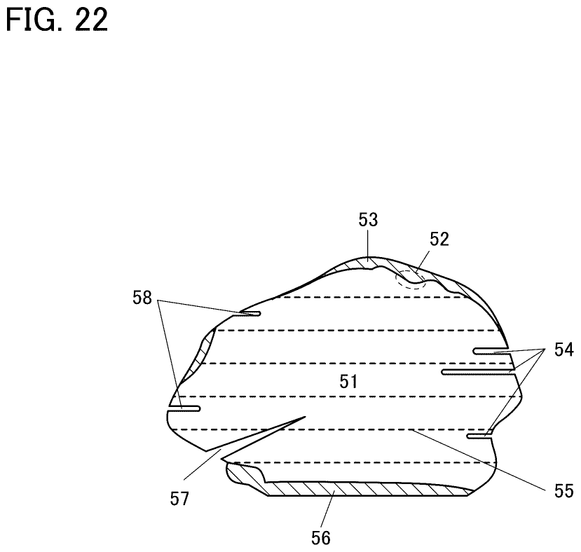

FIG. 22 is a cross-sectional schematic view of a positive electrode active material 51 including pits. A crystal plane 55 parallel to the arrangement of cations is also illustrated. Although a pit 54 and a pit 58 are illustrated as holes since FIG. 22 is a cross-sectional view, their opening shapes are not circular but a wide groove-like shape. Unlike a depression 52, the pit 54 and the pit 58 are likely to be generated parallel to the arrangement of lithium ions as illustrated in the drawing.

In the positive electrode active material 51, surface portions where the additive elements A exist are denoted by reference numerals 53 and 56. A surface portion where the pit is generated contains a smaller amount of the additive element than the surface portions 53 and 56 or contains the additive element A at a concentration lower than or equal to the lower detection limit, and thus probably has a poor function of a barrier film. Presumably, the crystal structure of a composite oxide in the vicinity of a portion where a pit is formed is broken and differs from a layered rock-salt crystal structure. The breakage of the crystal structure might inhibit diffusion and release of lithium ions that are carrier ions; thus, a pit is probably a cause of deterioration of cycle performance.

A source of a pit can be a point defect. It is considered that a pit is generated when a point defect included in a positive electrode active material changes due to repetitive charge and discharge, and the positive electrode active material undergoes chemical or electrochemical erosion or degradation due to the electrolyte or the like surrounding the positive electrode active material. This degradation does not occur uniformly in the surface of the positive electrode active material but occurs locally in a concentrated manner.

In addition, like the crack 57 illustrated in FIG. 22, a defect such as a crack (also referred to as crevice) is sometimes generated by expansion and contraction of the positive electrode active material due to charge and discharge. In this specification and the like, a crack and a pit are different from each other. Immediately after formation of a positive electrode active material, a crack can exist but a pit does not exist. A pit can also be regarded as a hole formed by extraction of some layers of the transition metal M and oxygen due to charge and discharge under high-voltage conditions at 4.5 V or more, or at a high temperature (45° C. or higher), i.e., a portion from which the transition metal M has been eluted. A crack refers to, for example, a surface newly generated by application of physical pressure or a crevice generated because of the crystal grain boundary 101. A crack might be caused by expansion and contraction of a positive electrode active material due to charge and discharge. A pit might be generated from at least one of a void inside a positive electrode active material and a crack.

### [Formation Method of Positive Electrode Active Material]

A way of adding the additive element A is important in forming the positive electrode active material 100 having at least one of the distribution of the additive element A, the composition, and the crystal structure described above. Favorable crystallinity of the bulk 100b is important as well.

Thus, in the formation process of the positive electrode active material 100, it is preferable that a composite oxide containing lithium and a transition metal be synthesized first, and then the additive element A source be mixed and heat treatment be performed.

In a method of synthesizing a composite oxide containing the additive element A, lithium, and the transition metal M by mixing the additive element A source concurrently with the transition metal M source and a lithium source, it is sometimes difficult to increase the concentration of the additive element A in the surface portion 100a. In addition, after a composite oxide containing lithium and the transition metal M is synthesized, only mixing the additive element A source without performing heating causes the additive element A to be just attached to, not dissolved in, the composite oxide containing lithium and the transition metal M. It is difficult to distribute the additive element A favorably without sufficient heating. Therefore, it is preferable that lithium cobalt oxide be synthesized, and then the additive element A source be mixed and heat treatment be performed. The heat treatment after mixing of the additive element A source may be referred to as annealing.

However, annealing at an excessively high temperature may cause cation mixing, which increases the possibility of entry of the additive element A such as magnesium into the transition metal M sites. Magnesium that exists at the transition metal M sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element A source. The material can be regarded as functioning as a fusing agent when having a melting point lower than that of the composite oxide containing lithium and the transition metal M. For example, a fluorine compound such as lithium fluoride is preferably used. Adding the fusing agent decreases the melting points of the additive element A source and the composite oxide containing lithium and the transition metal M. The decrease in the melting point makes it easier to favorably distribute the additive element A at a temperature where the cation mixing is less likely to occur.

It is further preferable that heat treatment be performed between the synthesis of the composite oxide containing lithium and the transition metal M and the mixing of the additive element A. This heating is referred to as initial heating in some cases.

Owing to influence of lithium extraction from part of the surface portion 100a of the composite oxide containing lithium and the transition metal M by the initial heating, the distribution of the additive element A becomes more favorable.

Specifically, the distributions of the additive elements A can be easily made different from each other by the initial heating in the following mechanism. First, lithium is extracted from part of the surface portion 100a by the initial heating. Next, the additive element A sources such as a nickel source, an aluminum source, and a magnesium source and the composite oxide containing lithium and the transition metal M including the surface portion 100a that is deficient in lithium are mixed and heated. Among the additive elements A, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed.

Among the additive elements A, nickel is likely to form a solid solution and is diffused to the bulk 100b in the case where the surface portion 100a is a composite oxide containing lithium and the transition metal M and having a layered rock-salt crystal structure, but nickel is likely to remain in the surface portion 100a in the case where part of the surface portion 100a has a rock-salt crystal structure.

Furthermore, in such a rock-salt crystal structure, the bond distance between a metal Me and oxygen (Me-O distance) tends to be longer than that in a layered rock-salt crystal structure.

For example, Me-O distance in Ni_{0.5}Mg_{0.5}O having a rock-salt crystal structure is 2.09 Å and Me-O distance in MgO having a rock-salt crystal structure is 2.11 Å. Even when a spinel phase is formed in part of the surface portion 100a, Me-O distance in NiAl₂O₄ having a spinel structure is 2.0125 Å and Me-O distance in MgAl₂O₄ having a spinel structure is 2.02 Å. In each case, Me-O distance is longer than 2 Å. Note that 1 Å=10⁻¹⁰ m.

Meanwhile, in a layered rock-salt crystal structure, the bond distance between oxygen and a metal other than lithium is shorter than the above-described distance. For example, Al—O distance in LiAlO₂ having a layered rock-salt crystal structure is 1.905 Å (Li—O distance is 2.11 Å). In addition, Co—O distance in LiCoO₂ having a layered rock-salt crystal structure is 1.9224 A (Li—O distance is 2.0916 Å).

According to the ionic radius of Shannon (Shannon, R. D. Acta Crystallogr. 1976, A 32, 751.), the ion radius of hexacoordinated aluminum is 0.535 Å and the ion radius of hexacoordinated oxygen is 1.4 Å, and the sum of those values is 1.935 Å.

From the above, aluminum may exist at sites other than lithium sites more stably in a layered rock-salt crystal structure than in a rock-salt crystal structure. Thus, in the surface portion 100a, aluminum is more likely to be distributed in either one or both of a region having a layered rock-salt phase at a larger depth and the bulk 100b than in a region having a rock-salt phase that is close to the surface.

Moreover, the initial heating may increase the crystallinity of the layered rock-salt crystal structure of the bulk 100b.

However, the initial heating is not necessarily performed. In some cases, by controlling atmosphere, temperature, time, or the like in another heating step, e.g., annealing, the positive electrode active material 100 having the O3′ type structure when x in LiₓCoO₂ is small can be fabricated.

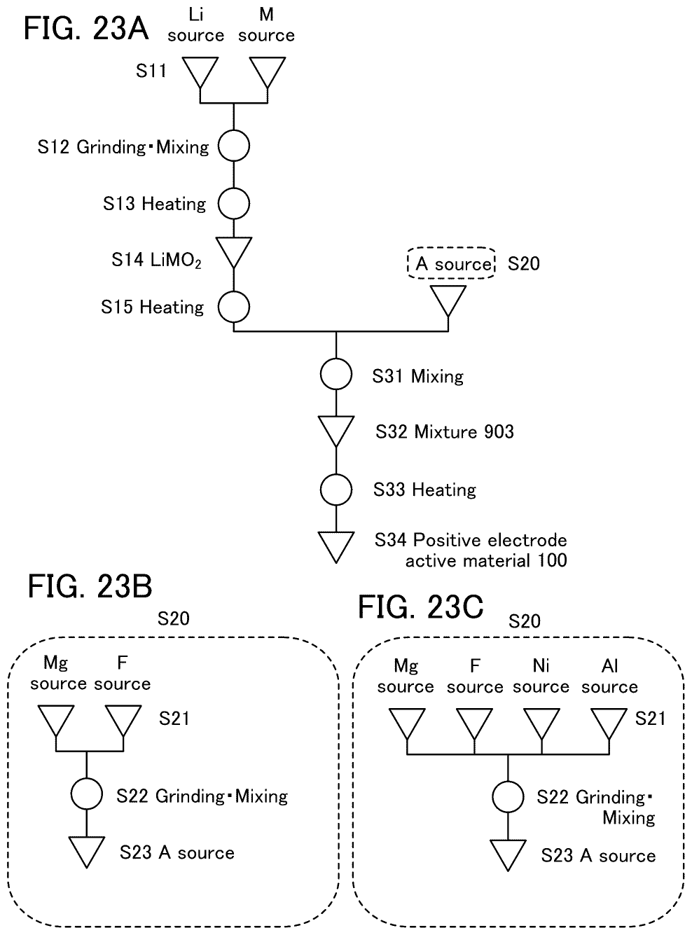

An example of a formation flow of the positive electrode active material 100, in which annealing and the initial heating are performed, will be described with reference to FIG. 23A to FIG. 23C.

### {Step S11}

In Step S11 shown in FIG. 23A, a lithium source (Li source) and a transition metal M source (M source) are prepared as materials for lithium and the transition metal M which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

The transition metal M can be selected from the elements belonging to Group 4 to Group 13 of the periodic table and for example, at least one of manganese, cobalt, and nickel is used. As the transition metal M, for example, cobalt alone; nickel alone; two metals of cobalt and manganese; two metals of cobalt and nickel; or three metals of cobalt, manganese, and nickel may be used. In the case where cobalt alone is used, the positive electrode active material to be obtained contains lithium cobalt oxide (LCO); in the case where three metals of cobalt, manganese, and nickel are used, the positive electrode active material to be obtained contains lithium nickel cobalt manganese oxide (NCM).

As the transition metal M source, a compound containing the above transition metal M is preferably used and for example, an oxide, a hydroxide, or the like of any of the metals given as examples of the transition metal M can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal M source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, the discharge capacity of the secondary battery is increased. Furthermore, the reliability of the secondary battery is improved.

Furthermore, the transition metal M source preferably has high crystallinity, and preferably includes single crystal particles, for example. To evaluate the crystallinity of the transition metal M source, the crystallinity can be judged by a TEM image, a STEM image, a HAADF-STEM image, an ABF-STEM image, or the like, or can be judged by an XRD pattern, an electron diffraction pattern, a neutron diffraction pattern, or the like. Note that the above methods for evaluating crystallinity can also be employed to evaluate the crystallinity of other materials in addition to the transition metal M source.

In the case of using two or more transition metal M sources, the two or more transition metal M sources are preferably prepared to have proportions (mixing ratio) such that a layered rock-salt crystal structure would be obtained.

### {Step S12}

Next, in Step S12 shown in FIG. 23A, the lithium source and the transition metal M source are ground and mixed to form a mixed material (mixture). The grinding and mixing can be performed by a dry method or a wet method. A wet method is preferable because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal M source be mixed into dehydrated acetone whose moisture content is less than or equal to 10 ppm and which has a purity higher than or equal to 99.5% in the crushing and mixing. With the use of dehydrated acetone with the above-described purity, impurities that might be mixed can be reduced.

A ball mill, a bead mill, or the like can be used for the mixing and the like. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### {Step S13}

Next, in Step S13 shown in FIG. 23A, the above mixed material is heated. The heating temperature is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the transition metal M source. An excessively high temperature might lead to a defect due to evaporation of lithium from the lithium source or excessive reduction of the metal used as the transition metal M source, for example. The defect is, for example, an oxygen defect which could be induced by a change of trivalent cobalt into divalent cobalt due to excessive reduction, in the case where cobalt is used as the transition metal M.

When the heating time is too short, LiMO₂ is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible or a saggar used at the time of the heating is preferably made of alumina (aluminum oxide), mullite cordierite, magnesia, or zirconia, i.e., preferably contains a highly heat resistant material. Since aluminum oxide is a material which impurities are less likely to enter, the purity of a crucible or a saggar made of alumina is higher than or equal to 99%, preferably higher than or equal to 99.5%. In this embodiment, a crucible made of aluminum oxide with a purity of 99.9% is used. The heating is preferably performed with the crucible or the saggar covered with a lid. This can prevent volatilization of a material.

The heated material is ground as needed and may be made to pass through a sieve. Before collection of the heated material, the material may be moved from the crucible to a mortar. As the mortar, a mortar made of aluminum oxide is suitably used. A mortar made of aluminum has a material property that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### {Step S14}

Through the above steps, a composite oxide containing the transition metal M(LiMO₂) can be obtained in Step S14 shown in FIG. 23A. The composite oxide needs to have a crystal structure of a lithium composite oxide represented by LiMO₂, but the composition is not strictly limited to Li:M:O=1:1:2. In the case where cobalt is used as the transition metal M, the composite oxide is referred to as a composite oxide containing cobalt and is represented by LiCoO₂. The composition is not strictly limited to Li:Co:O=1:1:2.

Although the example is described in which the composite oxide is formed by a solid phase method as in Step S11 to Step S14, the composite oxide may be formed by a coprecipitation method. Alternatively, the composite oxide may be formed by a hydrothermal method.

### {Step S15}

Next, in Step S15 shown in FIG. 23A, the above composite oxide is heated. The heating in Step S15 is the heating performed on the composite oxide, and thus is sometimes referred to as the initial heating. The heating is performed before Step S20 described below, and thus is sometimes referred to as preheating or pretreatment.

By the initial heating, lithium is extracted from part of a surface portion of the composite oxide as described above. In addition, the initial heating might have an effect of increasing the crystallinity of the bulk. The lithium source and/or transition metal M prepared in Step S11 and the like might contain impurities. The initial heating can reduce impurities in the composite oxide completed in Step S14.

Through the initial heating, an effect of smoothing the surface of the composite oxide is obtained. Having a smooth surface refers to a state where the composite oxide has little unevenness and is rounded as a whole and its corner portion is rounded. A smooth surface also refers to a surface to which few foreign matters are attached. Foreign matters might cause unevenness and are preferably not attached to a surface.

For the initial heating, there is no need to prepare a lithium compound source. Alternatively, there is no need to prepare the additive element A source. Alternatively, there is no need to prepare a material functioning as a fusing agent.

When the heating time in this step is too short, a sufficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the bulk is, for example, an effect of reducing distortion, a shift, or the like derived from differential shrinkage or the like of the composite oxide formed in Step S13.

The heating in Step S13 might cause a temperature difference between the surface and a bulk of the above composite oxide. The temperature difference sometimes induces differential shrinkage. It can also be deemed that the temperature difference leads to a fluidity difference between the surface and the bulk, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth through Step S15. This is also rephrased as modification of the surface. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 reduces the shift in a crystal or the like which is caused in the composite oxide to make the surface of the composite oxide smooth.

In a secondary battery including a composite oxide with a smooth surface as a positive electrode active material, deterioration by charge and discharge is suppressed and a crack in the positive electrode active material can be prevented.

It can be said that when surface unevenness information in one cross section of a composite oxide is quantified with measurement data, a smooth surface of the composite oxide has a surface roughness at least less than or equal to 10 nm. The one cross section of the composite oxide is, for example, a cross section obtained in STEM observation.

Note that in Step S14, a composite oxide containing lithium, the transition metal M, and oxygen, synthesized in advance may be used. In this case, Step S11 to Step S13 can be omitted. When Step S15 is performed on the pre-synthesized composite oxide, a composite oxide with a smooth surface can be obtained.

The initial heating might reduce lithium in the composite oxide. The additive element A described for Step S20 or the like below might easily enter the composite oxide owing to the reduction in lithium.

### {Step S20}

The additive element A may be added to the composite oxide having a smooth surface as long as a layered rock-salt crystal structure can be obtained. When the additive element A is added to the composite oxide having a smooth surface, the additive element A can be uniformly added. It is thus preferable that the initial heating precede the addition of the additive element A. The step of adding the additive element A is described with reference to FIG. 23B and FIG. 23C.

### {Step S21}

In Step S21 shown in FIG. 23B, the additive element A sources (A sources) to be added to the composite oxide are prepared. A lithium source may be prepared together with the additive element A sources.

As the additive element A, one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or two or more selected from bromine and beryllium can also be used. Note that the additive elements given earlier are more suitably used since bromine and beryllium are elements having toxicity to living things.

When magnesium is selected as the additive element A, the additive element A source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element A, the additive element A source can be referred to as a fluorine source. As the fluorine source, for example, lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride, sodium aluminum hexafluoride, or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used as the lithium source. Another example of the lithium source that can be used in Step S21 is lithium carbonate.

The fluorine source may be a gas, and fluorine, carbon fluoride, sulfur fluoride, oxygen fluoride, or the like may be used and mixed in the atmosphere in a heating step described later. Two or more of these fluorine sources may be used.

In this embodiment, lithium fluoride is prepared as the fluorine source, and magnesium fluoride is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or the neighborhood thereof). Note that in this specification and the like, the neighborhood means a value greater than 0.9 times and less than 1.1 times a given value.

Magnesium is preferably added at greater than 0.1 at % and less than or equal to 3 at %, further preferably greater than or equal to 0.5 at % and less than or equal to 2 at %, still further preferably greater than or equal to 0.5 at % and less than or equal to 1 at %, relative to LiCoO₂. When magnesium is added at less than or equal to 0.1 at %, the initial discharge capacity is high but repeated charge and discharge with a large charge depth rapidly lowers the discharge capacity. In the case where magnesium is added at greater than 0.1 at % and less than or equal to 3 at %, both the initial discharge characteristics and charge and discharge cycle performance are excellent even when charge and discharge with a large charge depth are repeated. By contrast, in the case where magnesium is added at greater than 3 at %, both the initial discharge capacity and the charge and discharge cycle performance tend to gradually degrade.

### {Step S22}

Next, in Step S22 shown in FIG. 23B, the magnesium source and the fluorine source are ground and mixed. Any of the conditions for the grinding and mixing that are described for Step S12 can be selected to perform this step.

A heating step may be performed after Step S22 as needed. Any of the heating conditions described for Step S13 can be selected to perform the heating step. The heating time is preferably longer than or equal to 2 hours and the heating temperature is preferably higher than or equal to 800° C. and lower than or equal to 1100° C.

### {Step S23}

Next, in Step S23 shown in FIG. 23B, the materials ground and mixed in the above step are collected to give the additive element A source (A source). Note that the additive element A source shown in Step S23 contains a plurality of starting materials and can be referred to as a mixture.

As for the particle diameter of the mixture, the median diameter (D50) is preferably greater than or equal to 600 nm and less than or equal to 20 μm, further preferably greater than or equal to 1 μm and less than or equal to 10 μm. Also when one kind of material is used as the additive element A source, the median diameter (D50) is preferably greater than or equal to 600 nm and less than or equal to 20 μm, further preferably greater than or equal to 1 μm and less than or equal to 10 μm.

Such a pulverized mixture (which may contain only one kind of the additive element A) is easily attached to the surface of a composite oxide uniformly in a later step of mixing with the composite oxide. The mixture is preferably attached uniformly to the surface of the composite oxide, in which case fluorine and magnesium are easily distributed or dispersed uniformly in a surface portion of the composite oxide after heating. The region where fluorine and magnesium are distributed can be referred to as a surface portion. When there is a region containing neither fluorine nor magnesium in the surface portion, the above-described O3′ type crystal structure might be unlikely to be obtained in a charged state. Note that although fluorine is used in the above description, chlorine may be used instead of fluorine, and a general term “halogen” for these elements can replace “fluorine”.

### {Another Example of Step S20 (Step S21 to Step S23)}

A process different from that in FIG. 23B is described with reference to FIG. 23C. In Step S23 shown in FIG. 23C, four kinds of additive element A sources to be added to the composite oxide are prepared. In other words, FIG. 23C is different from FIG. 23B in the kinds of the additive element A sources. A lithium source may be prepared together with the additive element A sources.

As the four kinds of additive element A sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 23B. As a nickel source, nickel oxide, nickel hydroxide, or the like can be used. As an aluminum source, aluminum oxide, aluminum hydroxide, or the like can be used.

Next, Step S22 and Step S23 shown in FIG. 23C are similar to the steps described with reference to FIG. 23B.

### {Step S31}

Next, in Step S31 shown in FIG. 23A, the composite oxide and the additive element A source (A source) are mixed. The ratio of the number A_{M} of the transition metal atoms in the composite oxide containing lithium, the transition metal A_{M}, and oxygen to the number AM_{g} of magnesium atoms contained in the additive element A is preferably A_{M}:A_{Mg}=100:y (0.1≤y≤6), further preferably A_{M}:A_{Mg}=100:y (0.3≤y≤3).

The conditions of the mixing in Step S31 are preferably milder than those of the mixing in Step S12 in order not to damage the composite oxide. For example, conditions with a lower rotation frequency or shorter time than those for the mixing in Step S12 are preferable. In addition, it can be said that a dry method has a milder condition than a wet method. For example, a ball mill or a bead mill can be used for the mixing. When the ball mill is used, a ball made of zirconium oxide is preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### {Step S32}

Next, in Step S32 in FIG. 23A, the materials mixed in the above step are collected, whereby a mixture 903 is obtained. At the time of the collection, the materials may be crushed as needed and made to pass through a sieve.

Note that in this embodiment, the method is described in which lithium fluoride as the fluorine source and magnesium fluoride as the magnesium source are added afterward to the composite oxide that has been subjected to the initial heating. However, one embodiment of the present invention is not limited to the above method. The magnesium source, the fluorine source, and the like can be added to the lithium source and the transition metal M source in Step S11, i.e., at the stage of the starting materials of the composite oxide. Then, the heating in Step S13 is performed, so that LiMO₂ to which magnesium and fluorine are added can be obtained. In this case, there is no need to separately perform Step S11 to Step S14 and Step S21 to Step S23. This method can be regarded as being simple and highly productive.

Alternatively, a composite oxide to which magnesium and fluorine are added in advance may be used. When a composite oxide to which magnesium and fluorine are added is used, Step S11 to Step S32 and Step S20 can be skipped. This method can be regarded as being simple and highly productive.

Alternatively, to the composite oxide to which magnesium and fluorine are added in advance, a magnesium source and a fluorine source, or a magnesium source, a fluorine source, a nickel source, and an aluminum source may be further added as in Step S20.

### {Step S33}

Then, in Step S33 shown in FIG. 23A, the mixture 903 is heated. Any of the heating conditions described for Step S13 can be selected to perform this step. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element A source proceeds. The temperature at which the reaction proceeds is the temperature at which interdiffusion of the elements contained in LiMO₂ and the additive element A source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably lower than that in Step S13.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a flux in some cases. Owing to this function, the heating temperature can be lower than the decomposition temperature of the composite oxide (LiMO₂), e.g., a temperature higher than or equal to 742° C. and lower than or equal to 950° C., which allows distribution of the additive element A such as magnesium in the surface portion and fabrication of the positive electrode active material having favorable characteristics.

However, since LiF in a gas phase has a specific gravity less than that of oxygen, heating might volatilize or sublimate LiF and in that case, LiF in the mixture 903 decreases. As a result, the function of a fusing agent deteriorates. Therefore, heating needs to be performed while volatilization or sublimation of LiF is inhibited. Note that even when LiF is not used as the fluorine source or the like, Li at the surface of LiMO₂ and F of the fluorine source might react to produce LiF, which might be volatilized or sublimated. Therefore, such inhibition of volatilization or sublimation is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization or sublimation of LiF in the mixture 903.

The heating in this step is preferably performed such that the mixtures 903 are not adhered to each other. Adhesion of the particles of the mixture 903 during the heating might decrease the area of contact with oxygen in the atmosphere and inhibit a path of diffusion of the additive element A (e.g., fluorine), thereby hindering distribution of the additive element A (e.g., magnesium and fluorine) in the surface portion.

Uniform distribution of the additive element A (e.g., fluorine) in the surface portion probably leads to a smooth positive electrode active material with little unevenness. Thus, it is preferable that the mixtures 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions such as the heating temperature and the size and composition of LiMO₂ in Step S14. In the case where LiMO₂ is small, the heating is preferably performed at a lower temperature or for a shorter time than annealing in the case where LiMO₂ is large, in some cases.

When the median diameter (D50) of the composite oxide (LiMO₂) in Step S14 in FIG. 23A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than tor equal to 10 hours and shorter than or equal to 50 hours.

When the median diameter (D50) of the composite oxide (LiMO₂) in Step S14 is approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 23A, in which crushing is performed as needed; thus, the positive electrode active material 100 is obtained. Here, the collected positive electrode active material 100 is preferably made to pass through a sieve. Through the above steps, the positive electrode active material 100 of one embodiment of the present invention can be fabricated. The positive electrode active material 100 of one embodiment of the present invention has a smooth surface.

### <Negative Electrode>

A negative electrode of one embodiment of the present invention includes a negative electrode active material.

As the negative electrode active material, a material that can react with carrier ions of a secondary battery, a material into and from which carrier ions can be inserted and extracted, a material that enables an alloying reaction with a metal serving as a carrier ion, a material that enables melting and precipitation of a metal serving as a carrier ion, or the like is preferably used.

Carbon materials such as graphite, graphitizing carbon, non-graphitizing carbon, carbon nanotube, carbon black, and graphene can be used as the negative electrode active material, for example.

In addition, a material containing one or more elements selected from silicon, tin, gallium, aluminum, germanium, lead, antimony, bismuth, silver, zinc, cadmium, and indium can be used as the negative electrode active material, for example.

An impurity element such as phosphorus, arsenic, boron, aluminum, or gallium may be added to silicon so that silicon is lowered in resistance.

As a material containing silicon, a material represented by SiOₓ (x is preferably less than 2, further preferably greater than or equal to 0.5 and less than or equal to 1.6) can be used, for example.

A material containing silicon, which has a plurality of crystal grains in a single particle, for example, can be used. For example, a configuration where a single particle includes one or more silicon crystal grains can be used. The single particle may also include silicon oxide around the silicon crystal grain(s). The silicon oxide may be amorphous.

As a compound containing silicon, Li₂SiO₃ and Li₄SiO₄ can be used, for example. Each of Li₂SiO₃ and Li₄SiO₄ may have crystallinity, or may be amorphous.

The analysis of the compound containing silicon can be performed by an NMR spectrum, an XRD pattern, a Raman spectroscopy spectrum, or the like.

Furthermore, an oxide containing one or more elements selected from titanium, niobium, tungsten, and molybdenum can be used as a material that can be used for the negative electrode active material, for example.

As the negative electrode active material, it is possible to use a combination of two or more of the aforementioned metals, materials, compounds, and the like.

The negative electrode active material of one embodiment of the present invention may contain halogen in a surface portion. When the negative electrode active material contains halogen in its surface portion, a decrease in charge and discharge efficiency can be inhibited. Moreover, a reaction with an electrolyte at a surface of the active material may be inhibited. In addition, at least part of the surface of the negative electrode active material of one embodiment of the present invention is covered with a region containing halogen in some cases. The region may have a film shape, for example. Fluorine is particularly preferable as halogen.

### <Electrolyte>

The electrolyte preferably contains a solvent and a metal salt serving as a carrier ion. As the solvent of the electrolyte, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are less likely to burn and volatize as the solvent of the electrolyte can prevent a secondary battery from exploding and igniting even when the secondary battery causes an internal short circuit or the temperature of the internal region increases owing to overcharge or the like. An ionic liquid contains a cation and an anion, specifically, an organic cation and an anion. Examples of the organic cation used for the electrolyte include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As a salt dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination at an appropriate ratio.

The electrolyte used for a secondary battery is preferably a highly purified electrolyte solution that contains few dust particles and elements other than the constituent elements of the electrolyte (hereinafter, also simply referred to as impurities). Specifically, the weight ratio of impurities to the electrolyte is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte. The concentration of the material to be added in the whole solvent is, for example, higher than or equal to 0.1 wt % and lower than or equal to 5 wt %. It is particularly preferable to use VC or LiBOB because it facilitates film formation.

A solution containing a solvent and a salt serving as a carrier ion is referred to as an electrolyte solution in some cases.

A polymer gel electrolyte obtained in a manner in which a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO), PVDF, polyacrylonitrile, and a copolymer containing any of them. For example, PVDF-HFP, which is a copolymer of PVDF and hexafluoropropylene (HFP), can be used. The formed polymer may be porous.

As the electrolyte, a solid electrolyte including an inorganic material can be used. For example, a sulfide-based solid electrolyte, an oxide-based solid electrolyte, a halide-based solid electrolyte, or the like can be used. Alternatively, a solid electrolyte containing a high-molecular material such as a PEO (polyethylene oxide)-based high-molecular material can be used. When the solid electrolyte is used, a separator and/or a spacer is/are not necessary. Furthermore, the battery can be entirely solidified; therefore, there is no possibility of liquid leakage and thus the safety of the battery is dramatically improved.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

Examples of the oxide-based solid electrolyte include a material having a perovskite crystal structure (e.g., La_{2/3-x}Li₃ₓTiO₃), a material having a NASICON crystal structure (e.g., Li₁₊ₓAlₓTi₂₋ₓ(PO₄)₃), a material having a garnet crystal structure (e.g., Li₇La₃Zr₂O₁₂), a material having a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can also be used as the solid electrolyte.

Alternatively, different solid electrolytes may be mixed and used.

In particular, Li₁₊ₓAlₓTi₂₋ₓ(PO₄)₃ (0≤x≤1) having a NASICON crystal structure (hereinafter, LATP) is preferable because LATP contains aluminum and titanium, each of which is the element the positive electrode active material used in the secondary battery of one embodiment of the present invention is allowed to contain, and thus a synergistic effect of improving the cycle performance is expected. Furthermore, higher productivity due to a reduction in the number of steps might be achieved. Note that in this specification and the like, a material having a NASICON crystal structure refers to a compound that is represented by M₂(AO₄)₃ (M; transition metal; A: S, P, As, Mo, W, or the like) and has a structure in which MO₆ octahedra and AO₄ tetrahedra that share common corners are arranged three-dimensionally.

### <Voltage of Secondary Battery>

When the secondary battery includes a compound represented by the chemical formula LiCoO₂ as a positive electrode active material, and graphite at 70 or higher percent by weight as a negative electrode active material, the upper limit voltage of charge of the secondary battery is preferably higher than 4.2 V, further preferably higher than 4.3 V. In addition, the upper limit voltage of charge of the secondary battery is 4.8 V or lower, 4.7 V or lower, or 4.65 V or lower, for example.

When the secondary battery includes a compound represented by the chemical formula LiMO₂ where 40 or higher mole percent of M is nickel, as a positive electrode active material, and graphite at 70 or higher percent by weight as a negative electrode active material, the upper limit voltage of charge of the secondary battery is preferably 4.1 v or higher, further preferably 4.2 V or higher. In addition, the upper limit voltage of charge of the secondary battery is 4.8 V or lower, 4.7 V or lower, or 4.65 V or lower, for example.

### <Capacity of Secondary Battery>

In charge with use of the charging unit of one embodiment of the present invention, the charge capacity (quantity of electricity charged) is preferably higher than or equal to 200 mAh/g, further preferably higher than or equal to 210 mAh/g, still further preferably higher than or equal to 215 mAh/g (at 45° C., the charge rate of 0.5 C) per weight of the positive electrode active material.

This embodiment can be combined with the description of the other embodiments or the like as appropriate.

### Embodiment 3

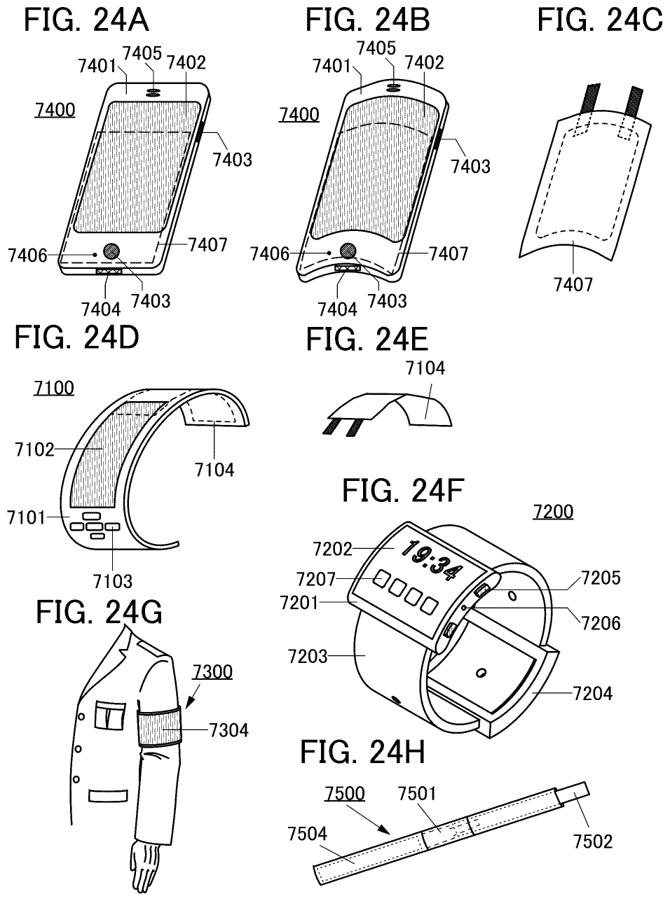

In this embodiment, examples of electronic devices each including the secondary battery of one embodiment of the present invention will be described with reference to FIG. 24A to FIG. 26C.

FIG. 24A to FIG. 24G illustrate examples of electronic devices each including the secondary battery containing the positive electrode active material described of one embodiment of the present invention. Examples of electronic devices each including a secondary battery include television devices (also referred to as televisions or television receivers), monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

Furthermore, a flexible secondary battery can be incorporated along a curved inside/outside wall surface of a house, a building, or the like or a curved interior/exterior surface of an automobile, for example.

FIG. 24A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided.

FIG. 24B illustrates the state where the mobile phone 7400 is bent. When the whole mobile phone 7400 is bent by the external force, the secondary battery 7407 included in the mobile phone 7400 is also bent. FIG. 24C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved, and the secondary battery 7407 can have high reliability even in a state of being bent.

FIG. 24D illustrates an example of a bangle display apparatus. A portable display apparatus 7100 includes a housing 7101, a display portion 7102, operation buttons 7103, and a secondary battery 7104. FIG. 24E illustrates the bent secondary battery 7104. When the display apparatus is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display apparatus with a long lifetime can be provided.

FIG. 24F illustrates an example of a watch-type portable information terminal. A portable information terminal 7200 includes a housing 7201, a display portion 7202, a band 7203, a buckle 7204, an operation button 7205, an input/output terminal 7206, and the like. The portable information terminal 7200 includes a secondary battery (not illustrated).

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. For example, mutual communication with a headset capable of wireless communication enables hands-free calling.

Moreover, the portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

When the secondary battery of one embodiment of the present invention is used as the secondary battery included in the portable information terminal 7200, a lightweight portable information terminal with a long lifetime can be provided. For example, the secondary battery 7104 illustrated in FIG. 24E can be provided in the housing 7201 while being curved, or can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 24G illustrates an example of an armband display apparatus. The display apparatus 7300 includes a display portion 7304. The display apparatus 7300 includes a secondary battery (not illustrated). The display apparatus 7300 can include a touch sensor in the display portion 7304 and can serve as a portable information terminal.

The display surface of the display portion 7304 is curved, and images can be displayed on the curved display surface. A display state of the display apparatus 7300 can be changed by, for example, near field communication that is standardized communication.

The display apparatus 7300 includes an input/output terminal, and data can be directly transmitted to and received from another information terminal via a connector. In addition, charge via the input/output terminal is possible. Note that the charging operation may be performed by wireless power feeding without using the input/output terminal.

When the secondary battery of one embodiment of the present invention is used as the secondary battery included in the display apparatus 7300, a lightweight display apparatus with a long lifetime can be provided.

Examples of electronic devices each including the secondary battery of one embodiment of the present invention with excellent cycle performance are described with reference to FIG. 24H to FIG. 26C.

When the secondary battery of one embodiment of the present invention is used as a secondary battery of a daily electronic device, a lightweight product with a long lifetime can be provided. Examples of the daily electronic device include an electric toothbrush, an electric shaver, and electric beauty equipment. As secondary batteries of these products, small and lightweight stick type secondary batteries with high discharge capacity are desired in consideration of handling ease for users.

FIG. 24H is a perspective view of a device called a cigarette smoking device (electronic cigarette). In FIG. 24H, an electronic cigarette 7500 includes an atomizer 7501 including a heating element, a secondary battery 7504 that supplies power to the atomizer, and a cartridge 7502 including a liquid supply bottle, a sensor, and the like. The secondary battery of one embodiment of the present invention can be used as the secondary battery 7504. To improve safety, a protection circuit that prevents at least one of overcharge and overdischarge of the secondary battery 7504 may be electrically connected to the secondary battery 7504. The secondary battery 7504 illustrated in FIG. 24H includes an external terminal for connection to a charger. When the electronic cigarette 7500 is held, the secondary battery 7504 is a tip portion; thus, it is preferable that the secondary battery 7504 have a short total length and be lightweight. With the secondary battery of one embodiment of the present invention, which has high discharge capacity and excellent cycle performance, the small and lightweight electronic cigarette 7500 that can be used for a long time over a long period can be provided.

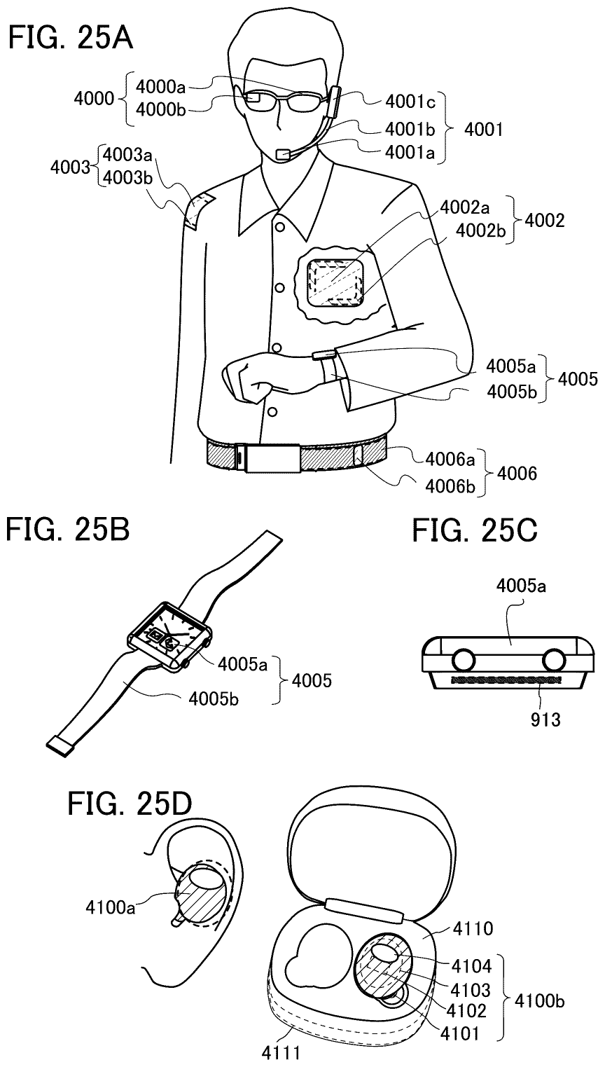

FIG. 25A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 25A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in at least one of the flexible pipe 4001b and the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 25B illustrates a perspective view of the watch-type device 4005 that is detached from an arm.

FIG. 25C is a side view. FIG. 25C illustrates a state where the secondary battery 913 is incorporated in the inner portion. The secondary battery 913 is the secondary battery of one embodiment of the present invention. The secondary battery 913, which is small and lightweight, is provided at a position overlapping with the display portion 4005a.

FIG. 25D illustrates an example of wireless earphones. The wireless earphones illustrated here consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charge, and the like are preferably included. Furthermore, a microphone may be included.

A case 4110 includes a secondary battery 4111. Moreover, a substrate where a circuit such as a wireless IC or a charge control IC is provided, and a terminal for charge are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, a coin-type secondary battery, a cylindrical secondary battery, or the like each including the secondary battery of one embodiment of the present invention can be used. A secondary battery using the positive electrode active material of one embodiment of the present invention for a positive electrode has a high energy density, and thus can achieve, when used as the secondary battery 4103 and the secondary battery 4111, a structure that accommodates space saving required with downsizing of the wireless earphones.

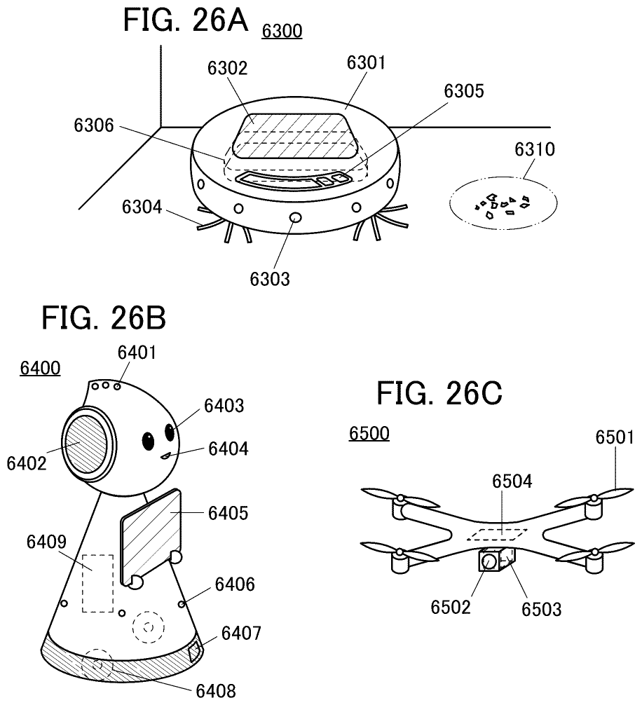

FIG. 26A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes a secondary battery 6306 of one embodiment of the present invention and a semiconductor device or an electronic component. The cleaning robot 6300 including the secondary battery of one embodiment of the present invention can be a highly reliable electronic device that can operate for a long time.

FIG. 26B illustrates an example of a robot. A robot 6400 illustrated in FIG. 26B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 26C illustrates an example of a flying object. A flying object 6500 illustrated in FIG. 26C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with the other embodiments or the like.

### Embodiment 4

In this embodiment, examples of vehicles each including the secondary battery containing a positive electrode active material of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

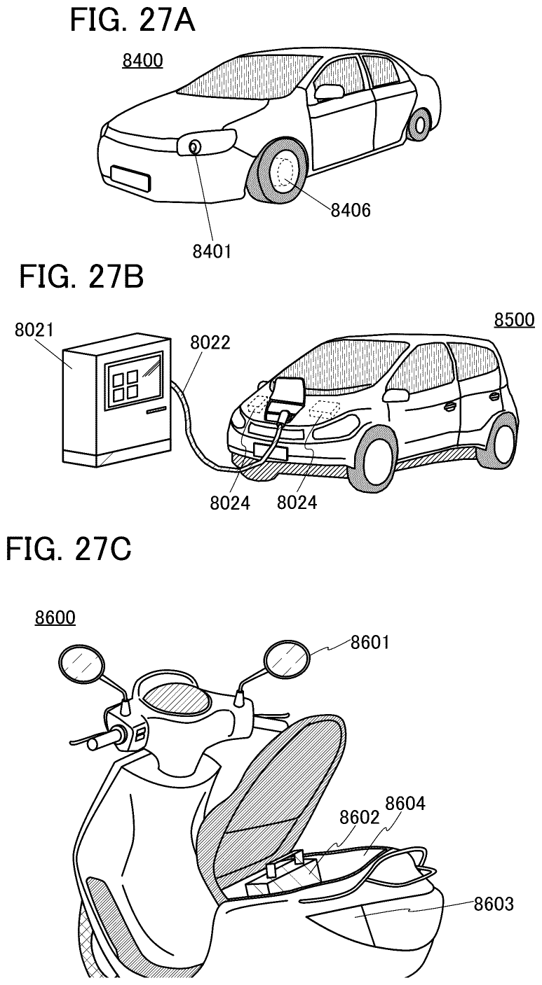

FIG. 27A to FIG. 27C illustrate examples of vehicles each including the secondary battery of one embodiment of the present invention. An automobile 8400 illustrated in FIG. 27A is an electric vehicle that runs on the power of an electric motor. Alternatively, the automobile 8400 is a hybrid electric vehicle capable of driving using either an electric motor or an engine as appropriate. The automobile 8400 includes the secondary battery (not illustrated). For example, the modules of the secondary battery can be arranged in a floor portion in the automobile to be used. The secondary battery can be used not only for driving an electric motor 8406, but also for supplying electric power to a light-emitting device such as a headlight 8401 and a room light (not illustrated). The use of the secondary battery of one embodiment of the present invention as the secondary battery included in the automobile 8400 can achieve a high-mileage vehicle.

The secondary battery can also supply power to a display apparatus included in the automobile 8400, such as a speedometer or a tachometer. Furthermore, the secondary battery can supply power to a semiconductor device included in the automobile 8400, such as a navigation system.

An automobile 8500 illustrated in FIG. 27B includes a secondary battery 8024. The secondary battery of one embodiment of the present invention can be used as the secondary battery 8024. The secondary battery 8024 included in the automobile 8500 can be charged when the secondary battery is supplied with electric power through external charge equipment by a plug-in system, a contactless power feeding system, or the like. FIG. 27B illustrates a state where a secondary battery 8024 included in the automobile 8500 is charged with the use of a ground-based charging apparatus 8021 through a cable 8022. In charge, a given method such as CHAdeMO (registered trademark) or Combined Charging System may be employed as a charging method, the standard of a connector, and the like as appropriate. The charging apparatus 8021 may be a charging station provided in a commerce facility or a power source in a house. For example, with the use of a plug-in technique, the secondary battery 8024 provided in the automobile 8500 can be charged by being supplied with power from outside. Charge can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road, an exterior wall, or the like, for example, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves, for example. To supply electric power in such a contactless manner, an electromagnetic induction method, a magnetic resonance method, or the like can be used.

FIG. 27C is an example of a motorcycle using the secondary battery of one embodiment of the present invention. A motor scooter 8600 illustrated in FIG. 27C includes a secondary battery 8602, side mirrors 8601, and direction indicators 8603. The secondary battery 8602 can supply electricity to the direction indicators 8603. The secondary battery of one embodiment of the present invention can be used as the secondary battery 8602.

In the motor scooter 8600 illustrated in FIG. 27C, the secondary battery 8602 can be held in an under-seat storage 8604. The secondary battery 8602 can be stored in the under-seat storage 8604 even when the under-seat storage 8604 is small. The secondary battery 8602 is detachable; thus, the secondary battery 8602 is carried indoors when charged, and is stored before the motor scooter is driven.

According to the secondary battery of one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power supply source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

This embodiment can be implemented in appropriate combination with the other embodiments or the like.

### Example 1

In this example, a secondary battery was fabricated and its characteristics were evaluated.

### <Formation of Positive Electrode Active Material>

A positive electrode active material was formed.

A commercial lithium cobalt oxide (Cellseed C-10N produced by Nippon Chemical Industrial Co., Ltd.) was prepared as lithium cobalt oxide. Next, the prepared lithium cobalt oxide was heated at 850° C. in an oxygen atmosphere for two hours.

Lithium fluoride and magnesium fluoride were weighed at the molar ratio of 1:3 and mixed to obtain a magnesium source. The magnesium source was weighed so that magnesium in the magnesium source can be 1 at % of cobalt in the lithium cobalt oxide, and was mixed with the heated lithium cobalt oxide to give a mixture A1.

Then, the mixture A1 was heated at 900° C. in an oxygen atmosphere for 20 hours to give a composite oxide B1.

Next, nickel hydroxide was prepared as a nickel source, and aluminum hydroxide was prepared as an aluminum source. The nickel source and the aluminum source were weighed so that nickel in the nickel hydroxide and aluminum in the aluminum hydroxide can each be 0.5 at % of cobalt in the composite oxide B1, and were mixed with the composite oxide B1 to give a mixture C1.

Then, the mixture C1 was heated at 850° C. in an oxygen atmosphere for 10 hours, and Sample Sa1 was fabricated.

### <Fabrication of Positive Electrode>

Sample Sa1, acetylene black (AB), polyvinylidene fluoride (PVDF), and NMP were mixed to form a slurry. The ratio of Sample Sa1, AB, and PVDF was 95:3:2 (weight ratio).

The obtained slurry was applied to one surface of an aluminum foil. After that, heat treatment was performed at 80° C., so that the NMP was volatilized. Pressing was performed after the heat treatment, so that a positive electrode was obtained.

### <Fabrication of Negative Electrode>

Graphite, VGCF (registered trademark), carboxymethyl cellulose sodium salt (CMC-Na), styrene butadiene rubber (SBR), and water were mixed to form a slurry. The ratio of graphite, VGCF (registered trademark), CMC-Na, and SBR was 96:1:1:2 (weight ratio).

The obtained slurry was applied to one surface of a copper foil. After that, heating was performed at 50° C., so that a negative electrode was obtained.

### <Fabrication of Secondary Battery>

A secondary battery was fabricated using the positive electrode and the negative electrode formed through the above steps. As a solvent of an electrolyte solution, a mixture of ethylene carbonate (EC) and diethyl carbonate (DEC) at EC:DEC=3:7 (volume ratio) was used. As a lithium salt, lithium hexafluorophosphate (LiPF₆) was used. The concentration of the lithium salt in the electrolyte solution was 1.00 mol/L. For the separator, polypropylene was used. As a film to be the exterior body, a film in which a polypropylene layer, an acid modified polypropylene layer, an aluminum layer, and a nylon layer were stacked in this order was used. First, one negative electrode having a negative electrode active material layer on one surface and one positive electrode having a positive electrode active material layer on one surface were prepared, and the negative electrode active material layer and the positive electrode active material layer were placed so as to face each other with a separator interposed therebetween.

Through the above steps, a secondary battery was fabricated.

<dQ/dV-V Curve>

A charge-discharge cycle test of the fabricated secondary battery was performed. The ambient temperature in the measurement was set to 45° C., the charge conditions were a constant current charge at 0.5 C and the upper limit voltage of 4.55 V. The discharge conditions were a constant current discharge at 0.5 C and the lower limit voltage of 3.0 V.

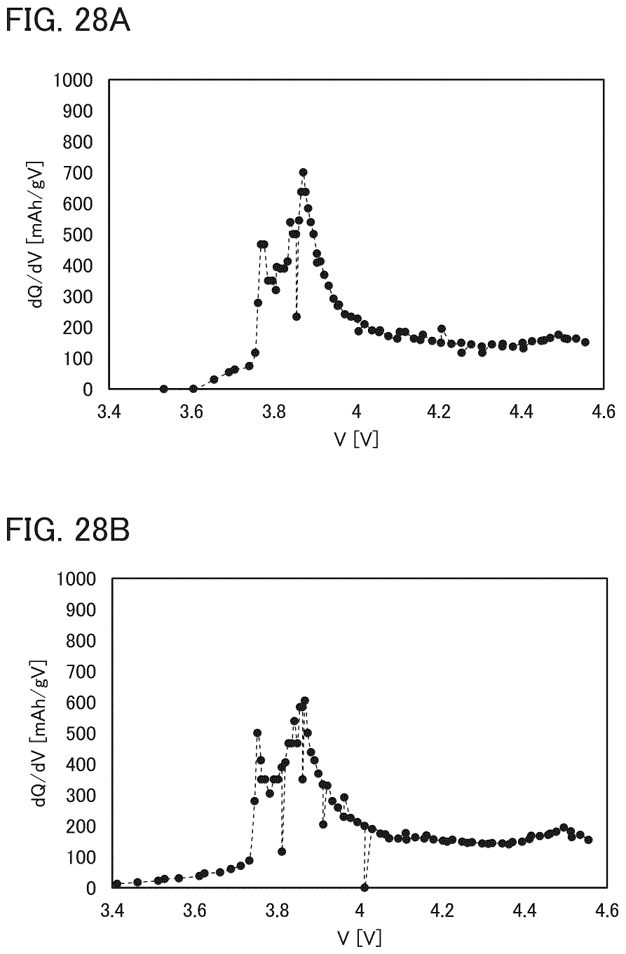

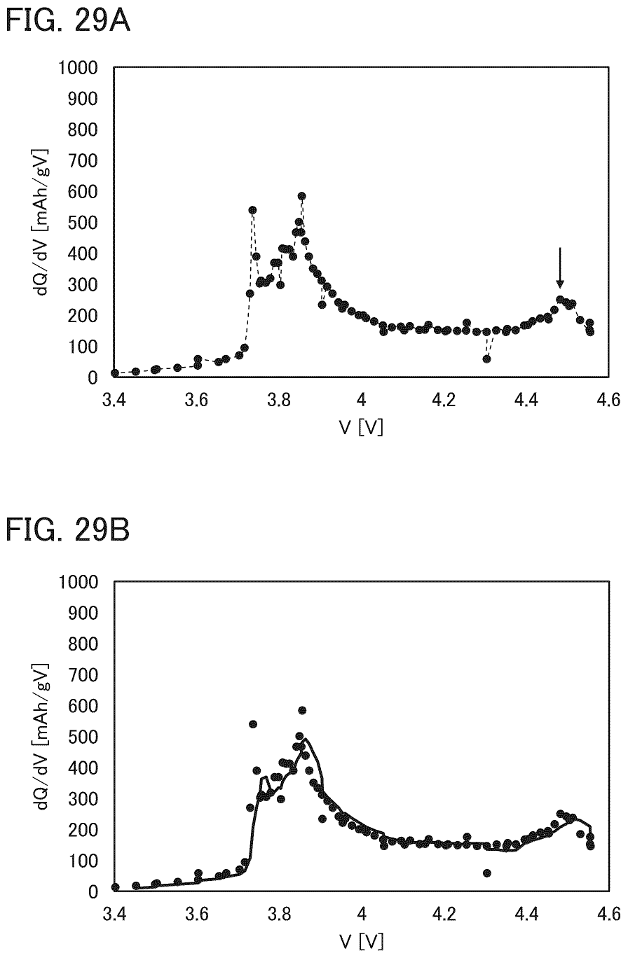

FIG. 28A shows a dQ/dV-V curve in the 1st cycle, FIG. 28B shows a dQ/dV-V curve in the 3rd cycle, and FIG. 29A shows a dQ/dV-V curve in the 40th cycle. In addition, FIG. 29B shows a curve of five-point moving average of data in FIG. 29A. Note that data acquisition interval was approximately two minutes in charge.

In the charging unit of one embodiment of the present invention, the point indicated by the arrow in FIG. 29A can be determined to the local maximum.

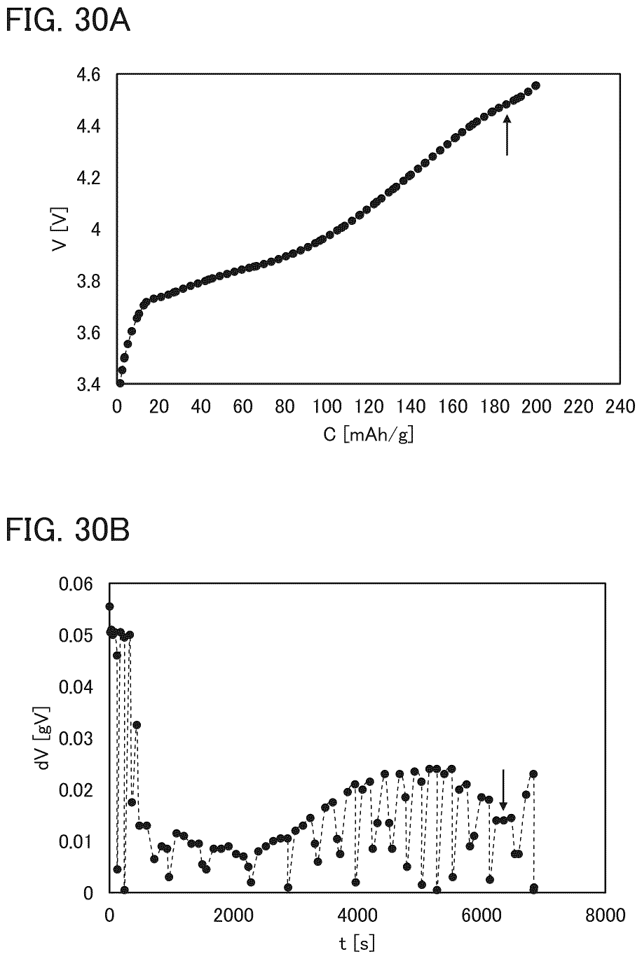

FIG. 30A shows a voltage V-capacitance C curve in charge of the 40th cycle and FIG. 30B shows a voltage change over time (ΔV−t curve) in the charge of the 40th cycle. The vertical axis represents ΔV and the horizontal axis represents a time from the start of charge. The ΔV was a difference from the previous voltage. The point corresponding to the point indicated by the arrow in FIG. 29A is indicated by arrows in FIG. 30A and FIG. 30B.

### Example 2

In this example, the secondary battery was charged using the charging unit of one embodiment of the present invention, and the characteristics of the secondary battery were evaluated.

### <Formation of Positive Electrode Active Material>

A positive electrode active material was formed.

Lithium cobalt oxide was heated at 850° C. in an oxygen atmosphere for two hours.

Lithium fluoride and magnesium fluoride were weighed at the molar ratio of 1:3 and mixed to obtain a magnesium source. The magnesium source was weighed so that magnesium in the magnesium source can be 1 at % of cobalt in the lithium cobalt oxide, and was mixed with the heated lithium cobalt oxide to give a mixture A3.

Then, the mixture A3 was heated at 900° C. in an oxygen atmosphere for 20 hours to give a composite oxide B3.

Next, nickel hydroxide was prepared as a nickel source, and aluminum hydroxide was prepared as an aluminum source. The nickel source was weighted such that nickel in the nickel hydroxide becomes 0.5 at % of cobalt in the composite oxide B3 and the aluminum source was weighted such that aluminum in the aluminum hydroxide becomes 0.5 at % of cobalt in the composite oxide A, and they were mixed with the composite oxide B3 to give a mixture C3.

Then, the mixture C3 was heated at 850° C. in an oxygen atmosphere for 10 hours, and Sample Sa3 was fabricated.

### <Fabrication of Positive Electrode>

Sample Sa3, acetylene black (AB), polyvinylidene fluoride (PVDF), and NMP were mixed to form a slurry. The ratio of Sample Sa3, AB, and PVDF was 95:3:2 (weight ratio).

The obtained slurry was applied to one surface of an aluminum foil. After that, heat treatment was performed at 80° C., so that the NMP was volatilized. Pressing was performed after the heat treatment, so that a positive electrode was obtained.

### <Fabrication of Negative Electrode>

Graphite, VGCF (registered trademark), carboxymethyl cellulose sodium salt (CMC-Na), styrene butadiene rubber (SBR), and water were mixed to form a slurry. The ratio of graphite, VGCF (registered trademark), CMC-Na, and SBR was 96:1:1:2 (weight ratio).

The obtained slurry was applied to one surface of a copper foil. After that, heating was performed at 50° C., so that a negative electrode was obtained.

### <Fabrication of Secondary Battery>

A secondary battery was fabricated using the positive electrode and the negative electrode formed through the above steps. As a solvent of an electrolyte solution, a mixture of ethylene carbonate (EC) and diethyl carbonate (DEC) at EC:DEC=3:7 (volume ratio) was used. As a lithium salt, lithium hexafluorophosphate (LiPF₆) was used. The concentration of the lithium salt in the electrolyte solution was 1.00 mol/L. For the separator, polypropylene was used. As a film to be the exterior body, a film in which a polypropylene layer, an acid modified polypropylene layer, an aluminum layer, and a nylon layer were stacked in this order was used. First, one negative electrode having a negative electrode active material layer on one surface and one positive electrode having a positive electrode active material layer on one surface were prepared, and the negative electrode active material layer and the positive electrode active material layer were placed so as to face each other with a separator interposed therebetween.

The area of the positive electrode active material layer was 20.493 cm², and the weight of the positive electrode active material layer was 0.11995 g. The area of the negative electrode active material layer was 23.841 cm², and the positive electrode and the negative electrode were placed such that an area in which the positive electrode active material layer and the negative electrode active material layer did not overlap with each other was as little as possible. The loading amount of the positive electrode active material layer was approximately 10.6 mg/cm², and the thickness thereof was greater than or equal to 54 μm and less than or equal to 56 μm. The loading amount of the negative electrode active material layer is greater than or equal to 7.8 mg/cm² and less than or equal to 7.9 mg/cm², and the thickness thereof was greater than or equal to 83 μm and less than or equal to 85 μm.

Through the above steps, the secondary battery was fabricated. Note that four secondary batteries were fabricated through the above steps.

### <Charging Method of Secondary Battery>

Charge of the secondary battery was performed with the charging unit of one embodiment of the present invention in accordance with a flowchart in FIG. 7.

First, a process started in Step S200.

Next, in Step S201, constant current charge of the secondary battery was started. The current value of charge was 20 mA.

Next, in Step S202, a voltage of the secondary battery was measured by a voltage measurement circuit. The voltage value was measured with an interval of 100 [ms]. The measured voltage was converted into 16-bit digital values by an analog-digital conversion circuit and was supplied to a control circuit. An MCU (Micro Controller unit) was used as the control circuit.

Next, in Step S203, the control circuit compared the voltage measured by the voltage measurement circuit with a predetermined voltage (here, 4.4 V).

On the basis of the result of comparison in Step S203, when the measured voltage was lower than 4.4 V, the process returned to Step S202, or when the measured voltage was higher than or equal to 4.4 V, the process proceeded to the next step (Step S204).

A dt/dV value was obtained in Step S204. Here, the time required for a voltage change by 1 mV was calculated as the value corresponding to the dt/dV. The moving average of measured dt/dV and a value obtained by multiplying the maximum of dt/dV, which was measured from the start of charge in Step S201 until the start time in Step S204, by a constant (here, 0.8) were calculated. The moving average was calculated from the total three points of a measurement point for the calculation, the previous measurement point, and the measurement point before the previous measurement point.

In Step S205, the moving average of dt/dV and the value that is 0.8 times the maximum value of dt/dV were compared.

When the moving average of dt/dV was greater than or equal to 0.8 times the maximum value of dt/dV, Step S204 to Step S205 were repeated.

At a time when the moving average of dt/dV was smaller than 0.8 times the maximum value of dt/dV, the process proceeded to Step S206 and charge was stopped.

Next, the charge was stopped in Step S299.

The charge conditions described above are referred to as charge conditions Ch-1.

### <Cycle Performance>

Under the above-described charge conditions (charge conditions Ch-1) and constant current charge conditions with the upper limit voltage of 4.6 V (hereinafter referred to as charge conditions Ch-2), cycle performances were evaluated. In each of the charge conditions, the charge current was 20 mA. The discharge conditions were constant current discharge, the lower limit voltage of discharge was 3.0 V, and the discharge current was 20 mA. The number, n, of the secondary batteries evaluated under the charge conditions Ch-1 was 2 (two secondary batteries were evaluated under each of the charge conditions), which are shown by Ch-1(1) and Ch-1(2) in the graph. Furthermore, the number, n, of the secondary battery evaluated under the charge condition Ch-2 was 1.

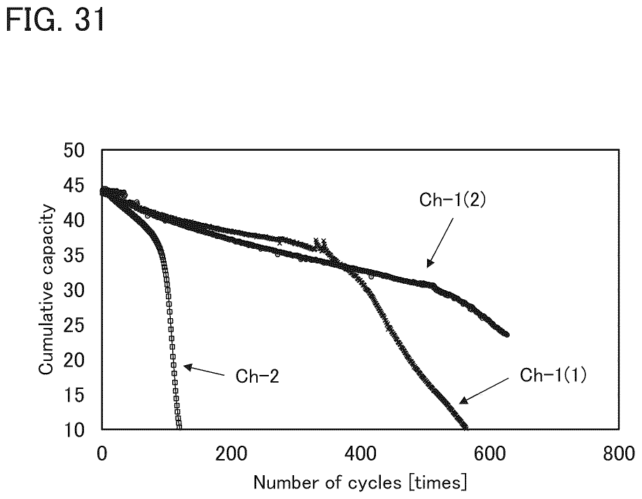

FIG. 31 shows the results of the cycle performance. The horizontal axis represents the number of charge-discharge cycles, and the vertical axis represents discharge capacity. From the results in FIG. 31, in the secondary batteries charged under the charge condition Ch-1 by using the charging unit of one embodiment of the present invention, a decrease in discharge capacity due to the cycle is reduced and the cycle performance is improved remarkably. In addition, in the secondary batteries charged under the charge condition Ch-1, while a decrease in discharge capacity is observed when the number of cycles exceeds 300, the rate of this decrease is more gradual than that observed under the charge condition Ch-2.

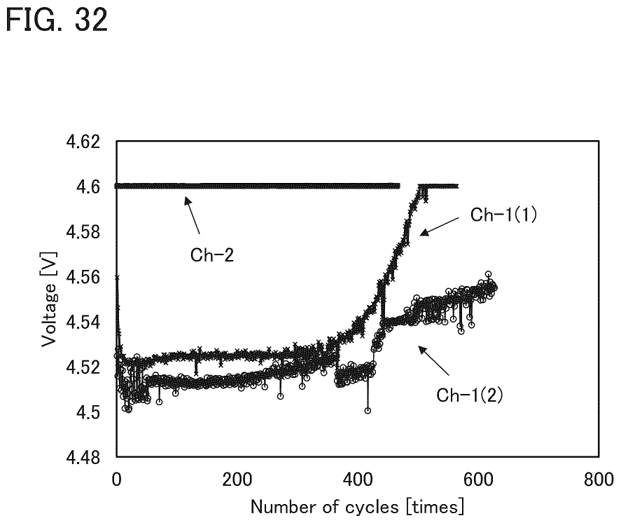

FIG. 32 shows a relation between the charge termination voltage and the charge-discharge cycle of the secondary battery. The horizontal axis represents the number of charge-discharge cycles and the vertical axis represents the charge termination voltage. According to the results in FIG. 32, the charge termination voltage of the secondary battery charged under the charge condition Ch-1 can be kept low. This suggests that the cycle performance is improved.

In addition, FIG. 32 shows a tendency that the end voltage of charge is high at the initial cycles and is gradually decreased in the secondary battery charged under the charge conditions Ch-1. When the end voltage of charge is changed, the internal resistance of the secondary battery is likely to be unstable. In the case where charge is performed using the charging unit of one embodiment of the present invention, the charge can be performed sufficiently in such an unstable state. In addition, since the charge can be performed without increasing the end voltage of charge than necessary, the secondary battery can have both a high capacity and a long lifetime.

In charge using the charging unit of one embodiment of the present invention, even when a variation occurs in internal resistance between a plurality of secondary batteries due to the fabricating process or the like of the secondary batteries, the reliability of the secondary batteries is not damaged and can have sufficient discharge capacity.

In consideration of the results in FIG. 31 and FIG. 32 in combination, in the case of the charge conditions Ch-1, a correlation between the discharge capacity and the end voltage of charge is seen after the number of cycles, e.g., after 350 or more cycles, where the decrease of the discharge capacity due to the increased number of cycles is noticeable. This shows a possibility that the full discharge capacity of the secondary battery (the dischargeable capacity of the secondary battery) can be estimated with the end voltage of charge.

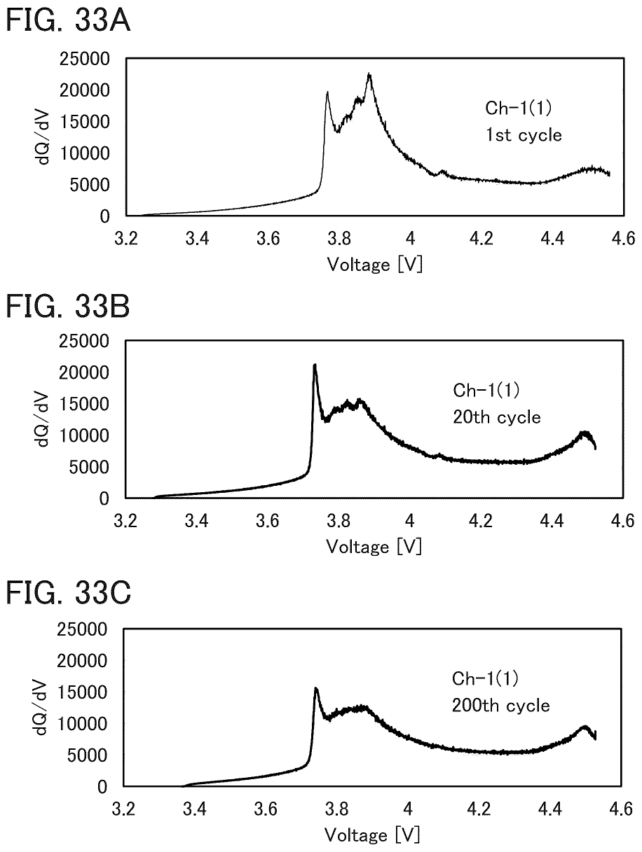

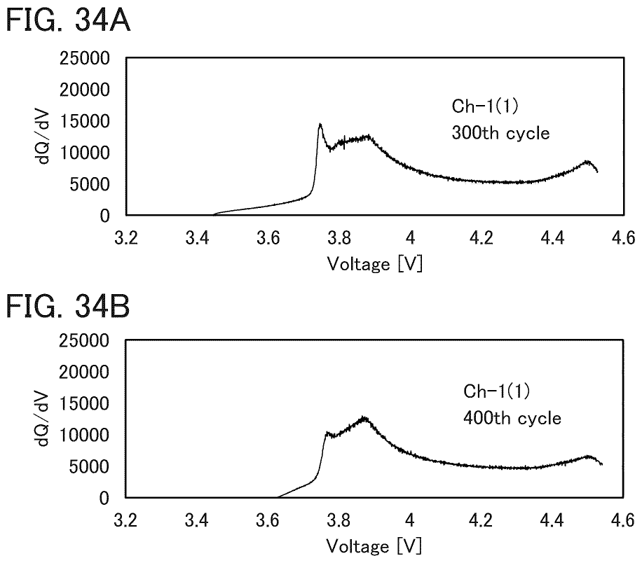

FIG. 33A to FIG. 34B show dQ/dV-V curves of the secondary battery charged under the first charge conditions. FIG. 33A shows data of the 1st cycle, FIG. 33B shows data of the 20th cycle, FIG. 33C shows data of the 200th cycle, FIG. 34A shows data of the 300th cycle, and FIG. 34B shows data of the 400th cycle. After 20 or more cycles, the height (level) of the local maximum value in the vicinity of 4.5 V is decreased as the cycle number is increased. In addition, the voltage of the local maximum value in the vicinity of 4.5 V is increased (becomes high).

The height of the local maximum value in the dQ/dV-V curve may decrease because a phase change corresponding to the local maximum value is unlikely to occur in the positive electrode active material. Detecting the height of the local maximum value can estimate the SOH of the secondary battery.

(Notes on Description of this Specification and the Like)

The following are notes on the description of the foregoing embodiments and the structures in the embodiments.

In the case where there is description “X and Y are connected” in this specification and the like, the case where X and Y are electrically connected, the case where X and Y are functionally connected, and the case where X and Y are directly connected are regarded as being disclosed in this specification and the like. Accordingly, without being limited to a predetermined connection relationship, e.g., a connection relationship shown in drawings or texts, a connection relationship other than one shown in drawings or texts is regarded as being disclosed in the drawings or the texts. Each of X and Y denotes an object (e.g., a device, an element, a circuit, a wiring, an electrode, a terminal, a conductive film, or a layer).

Here, the expression “X and Y are electrically connected” means the case where electric signals can be transmitted and received between X and Y when an object having any electric action is present between X and Y. For example, in the case where X and Y are electrically connected, one or more elements that allow electrical connection between X and Y (e.g., a switch, a transistor, a capacitor, an inductor, a resistor, a diode, a display device, a light-emitting device, or a load) can be connected between X and Y.

For example, in the case where X and Y are functionally connected, one or more circuits that allow functional connection between X and Y (e.g., a logic circuit (e.g., an inverter, a NAND circuit, or a NOR circuit); a signal converter circuit (e.g., a digital-analog converter circuit, an analog-digital converter circuit, or a gamma correction circuit); a potential level converter circuit (e.g., a power supply circuit (e.g., a step-up circuit and a step-down circuit) or a level shifter circuit for changing the potential level of a signal); a voltage source; a current source; a switch circuit; an amplifier circuit (e.g., a circuit that can increase signal amplitude, the current amount, or the like, an operational amplifier, a differential amplifier circuit, a source follower circuit, or a buffer circuit); a signal generation circuit; a memory circuit; or a control circuit) can be connected between X and Y. For instance, even if another circuit is interposed between X and Y, X and Y are regarded as being functionally connected when a signal output from X is transmitted to Y.

Note that an explicit description that X and Y are electrically connected includes the case where X and Y are electrically connected (i.e., the case where X and Y are connected with another element or another circuit interposed therebetween) and the case where X and Y are directly connected (i.e., the case where X and Y are connected without another element or another circuit interposed therebetween).

It can be expressed as, for example, “X, Y, a source (sometimes called one of a first terminal and a second terminal in this specification and the like) of a transistor, and a drain (sometimes called the other of the first terminal and the second terminal in this specification and the like) of the transistor are electrically connected to each other, and X, the source of the transistor, the drain of the transistor, and Y are electrically connected to each other in this order”. Alternatively, it can be expressed as “a source of a transistor is electrically connected to X; a drain of the transistor is electrically connected to Y; and X, the source of the transistor, the drain of the transistor, and Y are electrically connected to each other in this order”. Alternatively, it can be expressed as “X is electrically connected to Y through a source and a drain of a transistor, and X, the source of the transistor, the drain of the transistor, and Y are provided in this connection order”. When the connection order in a circuit structure is defined by an expression like the above examples, a source and a drain of a transistor can be distinguished from each other to specify the technical scope. Note that these expressions are non-limiting examples. Here, X and Y each denote an object (e.g., a device, an element, a circuit, a wiring, an electrode, a terminal, a conductive film, or a layer).

Even when independent components are electrically connected to each other in a circuit diagram, one component has functions of a plurality of components in some cases. For example, when part of a wiring also functions as an electrode, one conductive film has functions of both components: the wiring and the electrode. Thus, electrical connection in this specification and the like includes, in its category, such a case where one conductive film has functions of a plurality of components.

In this specification and the like, as a “resistor”, a circuit element, a wiring, or the like having a resistance value higher than 0Ω can be used, for example. Accordingly, in this specification and the like, examples of the “resistor” include a wiring having a resistance value, a transistor in which a current flows between its source and drain, a diode, and a coil. Thus, the term “resistor” can be replaced with the term “resistance”, “load”, “region having a resistance value”, or the like. Conversely, the terms “resistance”, “load”, and “region having a resistance value” can be replaced with the term “resistor”, or the like. The resistance value can be, for example, preferably higher than or equal to 1 mΩ and lower than or equal to 10Ω, further preferably higher than or equal to 5 mΩ and lower than or equal to 5Ω, still further preferably higher than or equal to 10 mΩ and lower than or equal to 1Ω. As another example, the resistance value may be higher than or equal to 1Ω and lower than or equal to 1×10⁹Ω.

In the case where a wiring is used as a resistor, the resistance value of the resistor is sometimes determined depending on the length of the wiring. Alternatively, a conductor with resistivity different from that of a conductor used as a wiring is sometimes used as a resistor. Alternatively, in the case where a semiconductor is used as a resistor, the resistance value of the resistor is sometimes determined by doping a semiconductor with an impurity.

In this specification and the like, a “capacitor” can be, for example, a circuit element having an electrostatic capacitance value higher than 0 F, a region of a wiring having an electrostatic capacitance value higher than 0 F, parasitic capacitance, or gate capacitance of a transistor. Thus, in this specification and the like, a “capacitor” is not limited to only a circuit element that has a pair of electrodes and a dielectric between the electrodes. A “capacitor” includes, for example, parasitic capacitance generated between wirings, gate capacitance generated between a gate and one of a source and a drain of a transistor, and the like. The term “capacitor”, “parasitic capacitance”, “gate capacitance”, or the like can be replaced with the term “capacitance” and the like, for example. Conversely, the term “capacitance” can be replaced with the term “capacitor”, “parasitic capacitance”, “gate capacitance”, or the like, for example. The term “a pair of electrodes” of a “capacitor” can be replaced with “a pair of conductors”, “a pair of conductive regions”, “a pair of regions”, or the like, for example. Note that the electrostatic capacitance value can be higher than or equal to 0.05 fF and lower than or equal to 10 pF, for example. As another example, the electrostatic capacitance value may be higher than or equal to 1 pF and lower than or equal to 10 μF.

A transistor in this specification and the like has three terminals called a gate (also referred to as a gate terminal, a gate region, or a gate electrode), a source (also referred to as a source terminal, a source region, or a source electrode), and a drain (also referred to as a drain terminal, a drain region, or a drain electrode). The transistor has a region where a channel is formed (also referred to as a channel formation region) between the drain and the source. In the transistor, a current can flow through the channel formation region between the source and the drain. The channel formation region refers to a region through which a current mainly flows. The gate is a control terminal for controlling the amount of current flowing through the channel formation region between the source and the drain. Two terminals functioning as the source and the drain are input/output terminals of the transistor.

In this specification and the like, a gate refers to part or the whole of a gate electrode and a gate wiring. A gate wiring refers to a wiring for electrically connecting a gate electrode of at least one transistor to another electrode or another wiring.

In this specification and the like, a source refers to part or the whole of a source region, a source electrode, and a source wiring. A source region refers to a region in a semiconductor layer where the resistivity is lower than or equal to a given value. A source electrode refers to part of a conductive layer connected to a source region. A source wiring refers to a wiring for electrically connecting a source electrode of at least one transistor to another electrode or another wiring.

In this specification and the like, a drain refers to part or the whole of a drain region, a drain electrode, and a drain wiring. A drain region refers to a region in a semiconductor layer where the resistivity is lower than or equal to a given value. A drain electrode refers to part of a conductive layer connected to a drain region. A drain wiring refers to a wiring for electrically connecting a drain electrode of at least one transistor to another electrode or another wiring.

Note that one of the two input/output terminals serves as the source and the other serves as the drain depending on the conductivity type (n-channel type or p-channel type) of the transistor and the levels of potentials supplied to the three terminals of the transistor. In some cases, functions of the source and the drain are replaced with each other when the direction of current flow is changed in circuit operation, for example. Thus, the terms “source” and “drain” can be replaced with each other in this specification and the like. Furthermore, in this specification and the like, expressions “one of a source and a drain” (or a first electrode or a first terminal) and “the other of the source and the drain” (or a second electrode or a second terminal) are used in the description of the connection relationship of a transistor.

Depending on the structure, a transistor may include a back gate in addition to the above three terminals. In that case, in this specification and the like, one of the gate and the back gate of the transistor may be referred to as a first gate and the other of the gate and the back gate of the transistor may be referred to as a second gate. Moreover, the terms “gate” and “back gate” can be replaced with each other in one transistor in some cases. In the case where a transistor includes three or more gates, each of the gates may be referred to as a first gate, a second gate, or a third gate, for example, in this specification and the like.

In this specification and the like, for example, a transistor with a multi-gate structure having two or more gate electrodes can be used as the transistor. In a transistor having the multi-gate structure, channel formation regions are connected in series; accordingly, a plurality of transistors are connected in series. Thus, in the transistor having the multi-gate structure, the amount of off-state current can be reduced, and the withstand voltage of the transistor can be increased (the reliability can be improved). Alternatively, in the transistor having the multi-gate structure, a drain-source current does not change very much even if a drain-source voltage changes at the time of operation in a saturation region, so that a flat slope of voltage-current characteristics can be obtained. The transistor having the flat slope of the voltage-current characteristics enables an ideal current source circuit or an active load having an extremely high resistance value. As a result, the transistor having the flat slope of the voltage-current characteristics enables, for example, a differential circuit, a current mirror circuit, or the like having high characteristics.

In this specification and the like, the case where a single circuit element is illustrated in a circuit diagram may indicate a case where the circuit element includes a plurality of circuit elements. For example, the case where a single resistor is illustrated in a circuit diagram may indicate a case where two or more resistors are electrically connected to each other in series. As another example, the case where a single capacitor is illustrated in a circuit diagram may indicate a case where two or more capacitors are electrically connected to each other in parallel. As another example, the case where a single transistor is illustrated in a circuit diagram may indicate a case where two or more transistors are electrically connected to each other in series and their gates are electrically connected to each other. Similarly, as another example, the case where a single switch is illustrated in a circuit diagram may indicate a case where the switch includes two or more transistors which are electrically connected to each other in series or in parallel and whose gates are electrically connected to each other.

In this specification and the like, “voltage” and “potential” can be replaced with each other as appropriate. The term “voltage” refers to a potential difference from a reference potential. When the reference potential is a ground potential, for example, “voltage” can be replaced with “potential”. Note that the ground potential does not necessarily mean 0 V. Moreover, potentials are relative values. That is, a potential supplied to a wiring, a potential applied to a circuit and the like, or a potential output from a circuit and the like, are changed with a change of the reference potential.

In this specification and the like, the terms “high-level potential” (also referred to as “H potential” or “H”) and “low-level potential” (also referred to as “L potential” or “L”) do not mean a particular potential. For example, in the case where two wirings are both described as “functioning as a wiring for supplying a high-level potential”, the levels of the high-level potentials supplied from the wirings are not necessarily equal to each other. Similarly, in the case where two wirings are both described as “functioning as a wiring for supplying a low-level potential”, the levels of the low-level potentials supplied from the wirings are not necessarily equal to each other.

In this specification and the like, a high power supply potential VDD (also simply referred to as “VDD” or an “H potential”) is a power supply potential higher than a low power supply potential VSS unless otherwise specified. The low power supply potential VSS (also simply referred to as “VSS” or an “L potential”) is a power supply potential lower than the high power supply potential VDD unless otherwise specified. Note that a potential difference (voltage) between VDD and VSS is preferably higher than the threshold voltage of the transistor, for example. In addition, a ground potential can be used as VDD or VSS. For example, in the case where VDD is a ground potential, VSS is a potential lower than the ground potential. Alternatively, for example, in the case where VSS is the ground potential, VDD is a potential higher than the ground potential.

In this specification and the like, “current” means a charge transfer (electrical conduction). For example, the description “electrical conduction of positively charged particles occurs” can be rephrased as “electrical conduction of negatively charged particles occurs in the opposite direction”. Thus, unless otherwise specified, “current” in this specification and the like refers to a charge transfer phenomenon (electrical conduction) accompanied by carrier movement. Examples of a carrier here include an electron, a hole, an anion, a cation, and a complex ion. The type of carrier differs depending on current-flowing systems (e.g., a semiconductor, a metal, an electrolyte solution, or a vacuum). For example, the “direction of current” in a wiring or the like refers to the direction in which a positive carrier moves, and the amount of current is expressed as a positive value. In other words, the direction in which a negative carrier moves is opposite to the direction of current, and the amount of current is expressed as a negative value. Thus, in the case where the polarity of current (or the direction of current) is not specified in this specification and the like, the description “current flows from element A to element B” can be rephrased as “current flows from element B to element A” and the like, for example. The description “current is input to element A” and the like can be rephrased as “current is output from element A” and the like, for example.

In this specification and the like, a “semiconductor” has characteristics of an “insulator” in some cases when the conductivity is sufficiently low, for example. Thus, a “semiconductor” can be replaced with an “insulator” in some cases. In this case, a “semiconductor” and an “insulator” cannot be strictly distinguished from each other because a border therebetween is not clear. Accordingly, a “semiconductor” and an “insulator” in this specification and the like can be replaced with each other in some cases.

In this specification and the like, a “semiconductor” has characteristics of a “conductor” in some cases when the conductivity is sufficiently high, for example. Thus, a “semiconductor” can be replaced with a “conductor” in some cases. In this case, a “semiconductor” and a “conductor” cannot be strictly distinguished from each other because a border therebetween is not clear. Accordingly, a “semiconductor” and a “conductor” in this specification and the like can be replaced with each other in some cases.

In this specification and the like, the term “film”, “layer”, or the like can be, for example, interchanged with each other depending on the situation, in some cases. For example, the term “conductive layer” can be changed into the term “conductive film” in some cases. For another example, the term “insulating film” can be changed into the term “insulating layer” in some cases. Alternatively, for example, the term “film”, “layer”, or the like is not used and can be interchanged with another term depending on the situation, in some cases. For example, the term “conductive layer” or “conductive film” can be changed into the term “conductor” in some cases. Furthermore, the term “conductor” can be changed into the term “conductive layer” or “conductive film” in some cases. For example, the term “insulating layer” or “insulating film” can be changed into the term “insulator” in some cases. Furthermore, the term “insulator” can be changed into the term “insulating layer” or “insulating film” in some cases.

In this specification and the like, a “node” can be referred to as a “terminal”, a “wiring”, an “electrode”, a “conductive layer”, a “conductor”, an “impurity region”, or the like depending on the circuit structure, the device structure, or the like, for example. Furthermore, a “terminal”, a “wiring”, or the like can be referred to as a “node”, for example.

In addition, in this specification and the like, for example, the term such as “electrode”, “wiring”, or “terminal” does not limit the function of a component. For example, an “electrode” is used as part of a wiring in some cases, and vice versa. Furthermore, the term “electrode” or “wiring” also includes, for example, the case where a plurality of “electrodes” or “wirings” are formed in an integrated manner. For example, a “terminal” is used as part of a “wiring” or an “electrode” in some cases, and vice versa. Furthermore, the term “terminal” also includes the case where a plurality of “electrodes”, “wirings”, “terminals”, or the like are formed in an integrated manner, for example. Thus, for example, an “electrode” can be part of a “wiring” or a “terminal”. Furthermore, a “terminal” can be part of a “wiring” or an “electrode”. Moreover, the term “electrode”, “wiring”, “terminal”, or the like is sometimes replaced with the term “region”, for example.

In addition, in this specification and the like, for example, the terms such as “wiring”, “signal line”, and “power supply line” can be interchanged with each other depending on the situation, in some cases. For example, the term “wiring” can be changed into the term “signal line” in some cases. For another example, the term “wiring” can be changed into the term “power supply line” or the like in some cases. Conversely, for example, the term “signal line”, “power supply line”, or the like can be changed into the term “wiring” in some cases. Furthermore, for example, the term “power supply line” or the like can be changed into the term “signal line” or the like in some cases. Conversely, for example, the term “signal line” or the like can be changed into the term “power supply line” or the like in some cases. Moreover, the term “potential” that is applied to a wiring can be changed into the term “signal” or the like depending on the situation, for example. Conversely, for example, the term “signal” or the like can be changed into the term “potential” in some cases.

In this specification and the like, a “switch” includes a plurality of terminals and has a function of switching (selecting) electrical continuity and discontinuity between the terminals. For example, in the case where a switch includes two terminals and electrical continuity is established between the two terminals, the switch is in a “conduction state” or an “on state”. In the case where electrical continuity is not established between the two terminals, the switch is in a “non-conduction state” or an “off state”. Note that switching to one of a conduction state and a non-conduction state or maintaining one of a conduction state and a non-conduction state is sometimes referred to as “controlling a conduction state”.

That is, a switch has a function of controlling whether a current flows therethrough or not. Alternatively, a switch has a function of selecting and changing a current path. For example, an electrical switch or a mechanical switch can be used as the switch. That is, a switch can be any element capable of controlling a current, and is not limited to a particular element.

Note that as a kind of a switch, there is a switch which is normally in a non-conduction state and brought into a conduction state by controlling a conduction state; such a switch is referred to as an “A contact” in some cases. Furthermore, as another kind of a switch, there is a switch which is normally in a conduction state and brought into a non-conduction state by controlling a conduction state; such a switch is referred to as a “B contact” in some cases.

Examples of an electrical switch include a transistor (e.g., a bipolar transistor or a MOS transistor), a diode (e.g., a PN diode, a PIN diode, a Schottky diode, a MIM (Metal Insulator Metal) diode, a MIS (Metal Insulator Semiconductor) diode, or a diode-connected transistor), and a logic circuit in which such elements are combined. Note that in the case where a transistor operates just as a switch, there is no particular limitation on the polarity (conductivity type) of the transistor.

An example of a mechanical switch is a switch using a MEMS (micro electro mechanical systems) technology. Such a switch includes an electrode that can be moved mechanically, and selects a conduction or non-conduction state with the movement of the electrode.

In this specification and the like, the “channel length” of the transistor refers to, for example, the distance between a source and a drain in a region where a semiconductor (or a portion where current flows in a semiconductor when a transistor is in an on state) and a gate overlap with each other or the distance between the source and the drain of a region where a channel is formed in a top view of the transistor.

In this specification and the like, the “channel width” of the transistor refers to, for example, the length of a portion where a source and a drain face each other in a region where a semiconductor (or a portion where current flows in a semiconductor when a transistor is an on state) and a gate overlap with each other or the length of a portion where a source and a drain face each other in a region where a channel is formed in a top view of the transistor.

In this specification and the like, for example, the terms such as “substrate”, “wafer”, and “die” do not functionally limit these components. For example, the terms such as “substrate,” “wafer,” and “die” can be interchanged with each other depending on the situation in some cases.

Ordinal numbers such as “first”, “second”, and “third” in this specification and the like are used to avoid confusion among components. Thus, the ordinal numbers do not limit the number of components. In addition, the ordinal numbers do not limit the order of components. For example, a “first” component in one embodiment in this specification and the like can be referred to as a “second” component in other embodiments, the scope of claims, or the like. Furthermore, for example, a “first” component in one embodiment in this specification and the like can be omitted in other embodiments, the scope of claims, or the like.

In this specification and the like, for example, terms for describing arrangement, such as “over”, “under”, “above”, and “below” are sometimes used for convenience to describe the positional relationship between components with reference to drawings. The positional relationship between components is changed as appropriate in accordance with a direction in which each component is described. Thus, the terms for describing arrangement in this specification and the like are not limited to those and can be replaced with another term as appropriate depending on the situation. For example, the expression “an insulator positioned over (on) a top surface of a conductor” can be replaced with the expression “an insulator positioned under (on) a bottom surface of a conductor” when the direction of a drawing illustrating these components is rotated by 180 degrees. Moreover, the expression “an insulator located over (on) a top surface of a conductor” can be replaced with the expression “an insulator located on a left surface (or a right surface) of a conductor” when the direction of a drawing illustrating these components is rotated by 90 degrees.

The term “over” or “under” does not necessarily mean that a component is placed directly over or directly under and directly in contact with another component. For example, the expression “electrode B over insulating layer A” does not necessarily mean that the electrode B is formed over and in direct contact with the insulating layer A, and does not exclude the case where another component is provided between the insulating layer A and the electrode B.

In this specification and the like, components arranged in a matrix and their positional relationship are sometimes described using a term such as “row” or “column”, for example. The positional relationship between components is changed as appropriate in accordance with a direction in which each component is described. Thus, for example, the terms such as “row” and “column” are not limited to those described in this specification and the like and can be replaced with another term as appropriate depending on the situation. For example, the term “row direction” can be replaced with the term “column direction” when the direction of the diagram is rotated by 90 degrees.

Furthermore, the term “overlap”, for example, in this specification and the like does not limit a state such as the stacking order of components. For example, the expression “electrode B overlapping with insulating layer A” does not necessarily mean the state where the electrode B is formed over the insulating layer A. The expression “electrode B overlapping with insulating layer A”, for example, does not exclude the state where the electrode B is formed under the insulating layer A and the state where the electrode B is formed on the right side (or the left side) of the insulating layer A.

The term “adjacent” or “proximity” in this specification and the like does not necessarily mean that a component is directly in contact with another component. For example, the expression “electrode B adjacent to insulating layer A” does not necessarily mean that the electrode B is formed in direct contact with the insulating layer A and does not exclude the case where another component is placed between the insulating layer A and the electrode B.

In this specification and the like, “parallel” indicates a state where two straight lines are placed at an angle greater than or equal to −10° and less than or equal to 10°. Thus, the case where the angle is greater than or equal to −5° and less than or equal to 5° is also included. In addition, “approximately parallel” or “substantially parallel” indicates a state where two straight lines are placed at an angle greater than or equal to −30° and less than or equal to 30°. Moreover, “perpendicular” indicates a state where two straight lines are placed at an angle greater than or equal to 800 and less than or equal to 100°. Thus, the case where the angle is greater than or equal to 850 and less than or equal to 950 is also included. Furthermore, “approximately perpendicular” or “substantially perpendicular” indicates a state where two straight lines are placed at an angle greater than or equal to 600 and less than or equal to 120°.

Note that in this specification and the like, the expression “level or substantially level” indicates having the same level from a reference surface (e.g., a flat surface such as a substrate surface) in a cross-sectional view. For example, in a manufacturing process of the semiconductor device, planarization treatment causes exposure of the surface(s) of a single layer or a plurality of layers in some cases. In this case, the surfaces on which the CMP treatment has been performed are at the same level as a reference surface. Note that a plurality of layers having the surfaces on which the planarization treatment has been performed are not level with each other in the strict sense in some cases, depending on a treatment apparatus, a treatment method, or a material of the treated surfaces on which the planarization treatment is performed. This case is also regarded as being “level or substantially level” in this specification and the like. For example, the expression “level or substantially level” also includes the case where two layers (here, given as a first layer and a second layer) whose levels with respect to the reference surface are different from each other are provided to have a difference between the top-surface level of the first layer and the top-surface level of the second layer of less than or equal to 20 nm.

Note that in this specification and the like, the expression “end portions are aligned or substantially aligned” means that at least outlines of stacked layers partly overlap with each other in a top view. For example, the case of processing the upper layer and the lower layer with use of the same mask pattern or mask patterns that are partly the same in a manufacturing process of a semiconductor device is included. However, in some cases, the outlines do not exactly overlap with each other and the outline of the upper layer is located inside the outline of the lower layer or the outline of the upper layer is located outside the outline of the lower layer; such a case is also represented by the expression “end portions are aligned or substantially aligned” in this specification and the like.

Note that in this specification and the like, for example, the terms “identical”, “the same”, “equal”, “uniform”, and the like (including synonyms of these words) used in describing calculation values and measurement values or in describing objects, methods, events, and the like that can be converted into calculation values or measurement values, allow for a margin of error of ±20% unless otherwise specified.

In the drawings and the like in this specification, arrows indicating the X direction, the Y direction, and the Z direction are illustrated in some cases. In this specification and the like, the “X direction” is a direction along the X-axis, and the forward direction and the reverse direction are not distinguished in some cases, unless otherwise specified. The same applies to the “Y direction” and the “Z direction”. The X direction, the Y direction, and the Z direction are directions intersecting with each other. More specifically, the X direction, the Y direction, and the Z direction are directions orthogonal to each other. In this specification and the like, one of the X direction, the Y direction, and the Z direction is referred to as a “first direction” in some cases. Another one of the directions is referred to as a “second direction” in some cases. The remaining one of the directions is referred to as a “third direction” in some cases.

In this specification and the like, an impurity in a semiconductor refers to, for example, an element other than a main component of a semiconductor layer. For example, an element with a concentration of lower than 0.1 atomic % is an impurity. When an impurity is contained in a semiconductor, for example, the density of defect states in a semiconductor is increased, carrier mobility is decreased, or crystallinity is decreased in some cases. In the case where the semiconductor is an oxide semiconductor, examples of an impurity that changes the characteristics of the semiconductor include Group 1 elements, Group 2 elements, Group 13 elements, Group 14 elements, Group 15 elements, or transition metals other than the main components of the oxide semiconductor. Specific examples include hydrogen (included also in water), lithium, sodium, silicon, boron, phosphorus, carbon, and nitrogen. In addition, oxygen vacancies (also referred to as V_{O}) are formed in an oxide semiconductor in some cases by entry of impurities, for example.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like, for example. For example, in the case where a metal oxide is used in a semiconductor layer of a transistor, the metal oxide is referred to as an oxide semiconductor in some cases. That is, when a metal oxide is used as a material that can be used for a channel formation region of a transistor that has at least one of an amplifying function, a rectifying function, and a switching function, the metal oxide can be referred to as a metal oxide semiconductor. In addition, the term “OS transistor” can also be referred to as a transistor containing a metal oxide or an oxide semiconductor.

In this specification and the like, a metal oxide containing nitrogen is also collectively referred to as a metal oxide in some cases. A metal oxide containing nitrogen may be referred to as a metal oxynitride.

### REFERENCE NUMERALS

200: power storage system, 201: charging unit, 121: secondary battery, 151: voltage measuring circuit, 152: current measuring circuit, 153: control circuit, TS: temperature sensor, 185: detection circuit, 186: detection circuit, SD: short-circuit detection circuit, MSD: micro short-circuit detection circuit, 140: transistor, 150: transistor, 152a: resistor, 152b: circuit, 157: DC-DC converter, 158: circuit, 159: diode, Vb1: voltage, Vb2: voltage, Vb3: voltage, 122: resistor, 123: resistor, S100: step, S101: step, S102: step, S103: step, S104: step, S105: step, S106: step, S107: step, S199: step, tp: time, t1: time, t2: time, V2: voltage, S000: step, S001: step, S002: step, S003: step, S004: step, S005: step, S006: step, S007: step, S099: step, tq: time, t3: time, t4: time, V1: voltage, S200: step, S201: step, S202: step, S203: step, S204: step, S205: step, S206: step, S299: step, V3: voltage, 151A: voltage measuring circuit, 162: S/H, 171: comparator, 172: DAC, 173: control portion, 173a: signal processing circuit, 173b: timing circuit, 173c: register, 174: S/H, SMP1: signal, SMP2: signal, STUP: signal, WKUP: signal, SLEP: signal, OUTV: data, OUTt: data, Vbp: voltage, Vin: voltage, Vref voltage, S300: step, S301: step, S302: step, S3021: step, S3022: step, S303: step, S304: step, S311: step, S312: step, S313: step, S314: step, S399: step, 151B: voltage measuring circuit, 175: integrator circuit, 175a: operational amplifier, 175r: resistor, 175c: capacitance, 176: selection circuit, 173d: oscillator, 173e: AND circuit, 173f: counter, SEL: signal, CCK: signal, CRE: signal, OUTC: data, Vin2: voltage, Vref2: voltage, tta: period, ttb: period, ttb1: period, ttb2: period, ttb3: period, S400: step, S401: step, S402: step, S411: step, S412: step, S413: step, S414: step, S499: step, 124: terminal, 125: terminal, 7407: secondary battery, 7104: secondary battery, 7504: secondary battery, 4002b: secondary battery, 4003b: secondary battery, 913: secondary battery, 4103: secondary battery, 4111: secondary battery, 6306: secondary battery, 6409: secondary battery, 6503: secondary battery, 8024: secondary battery, 8602: secondary battery

1. A power storage system comprising:
a secondary battery; and
a subtractor,
wherein the subtractor comprises a register,
wherein the subtractor is configured to convert a first voltage of the secondary battery into first voltage data by analog-digital conversion,
wherein the subtractor is configured to measure time required for the first voltage to change only by a first voltage value,
wherein the register is configured to store second voltage data that is higher than the first voltage data by a data value corresponding to the first voltage value, and
wherein the subtractor is configured to stop supply of power to the register until the first voltage changes by the first voltage value.

2. The power storage system according to claim 1,
wherein the subtractor comprises a digital-analog converter circuit,
wherein the digital-analog converter circuit is configured to output a second voltage on the basis of the second voltage data, and
wherein the subtractor is configured to stop supply of power to the digital-analog converter circuit until the first voltage changes only by the first voltage value.

3. The power storage system according to claim 1,
wherein the subtractor comprises a transistor comprising an oxide semiconductor in a channel formation region.

4. The power storage system according to claim 2,
wherein the subtractor comprises a transistor comprising an oxide semiconductor in a channel formation region.

5. The power storage system according to claim 1,
wherein the secondary battery comprises a positive electrode,
wherein the positive electrode comprises a lithium cobalt oxide, and
wherein a crystal structure identified by X-ray diffraction is a crystal structure represented by the space group R-3m.

6. The power storage system according to claim 5,
wherein the lithium cobalt oxide comprises magnesium in a surface portion.
